(19) United States
(12) Patent Application Publication
(10) Pub. No.: US 2026/0210560 A1
(43) Pub. Date: Jul. 23, 2026

(54) COOKING APPLIANCE

(71) Applicant: LG ELECTRONICS INC., Seoul (KR)

(72) Inventors: Haemin KIM, Seoul (KR); Wontae KIM, Seoul (KR); Jaewon BYUN, Seoul (KR); Ugjin KIM, Seoul (KR); Taeyoon YOON, Seoul (KR); Jaeho LEE, Seoul (KR); Seongsoon AHN, Seoul (KR)

(21) Appl. No.: 19/135,886

(22) PCT Filed: Dec. 6, 2023
(86) PCT No.: PCT/KR2023/020038

§ 371 Date: Jun. 5, 2025

(30) Foreign Application Priority Data
Dec. 6, 2022 (KR) 10-2022-0168537
Mar. 6, 2023 (KR) 10-2023-0029323

(51) Int. Cl. F24C 15/20; F24C 15/00; H05B 6/64

(52) U.S. Cl. CPC F24C 15/2042; F24C 15/006; F24C 15/2035; H05B 6/6423

(57) ABSTRACT

Disclosed is an invention related to a cooking apparatus. The invention disclosed herein is characterized in that a fan assembly that draws air into the cooking apparatus and then discharges the air to the outside of the cooking apparatus is disposed inside the cooking apparatus, the fan assembly being disposed in the space between the back surface of a cavity forming a cooking chamber therein and a rear plate forming the exterior of the back surface of the cooking apparatus.

### TECHNICAL FIELD

The present disclosure relates to a cooking appliance, and more particularly, to a cooking appliance which provides both a cooking function and a hood function.

### BACKGROUND ART

A cooking appliance is a home appliance for cooking food, and is an apparatus installed in a kitchen space to cook food according to a user's intention. Such cooking appliances may be variously classified according to a heat source, a form, or a type of fuel to be used.

When the cooking appliances are classified according to the type of food being cooked, the cooking appliances may be classified into open type and closed type cooking appliances according to a type of space in which the food is placed. The closed type cooking appliance includes an oven, a microwave oven, etc. and the open type cooking appliance includes a cooktop, a hop, etc.

The closed type cooking appliance is a cooking appliance that shields a space in which food is located and heats the shielded space to cook food. In the closed type cooking appliance, a chamber, that is, a cooking chamber, which is a space that is shielded when food is to be cooked while the food is placed, is provided inside the main body. Such a cooking chamber becomes a space in which food is substantially cooked. A heat source is provided in the inner or outer space of the cooking chamber to heat the cooking chamber.

The microwave of the closed type cooking appliance is a cooking apparatus which generates microwaves using electricity to penetrate into an object to be cooked accommodated in a cooking chamber, thereby heating the object to be cooked by causing molecular movement therein.

A microwave oven is a kitchen appliance which simultaneously heats the inside and the outside of the food by irradiating the high frequency of the magnetron to the food, and is widely used due to advantages such as significantly shortening the cooking time of the food due to high thermal efficiency, reducing the loss of nutritional value during cooking, defrosting, and heating of the food, and enabling direct cooking while the food is stored in a container.

Recently, a microwave oven combined with a hood having a hood function also known as an OTR (Over the Range) type microwave oven has been released. The OTR type microwave oven having the hood has a hood function of discharging air (hereinafter referred to as “cooking gas”) containing foreign substances generated in the process of cooking food from a cooking appliance installed thereunder, or filtering the cooking gas and then discharging the filtered gas to the inside.

A fan for suctioning and discharging air is provided in the hood-combined microwave oven. Such a fan is typically disposed on top of the cavity defining the cooking chamber therein. That is, in the microwave oven having the hood, the fan is generally disposed on top of the cavity.

However, when the fan is disposed at the position as described above, a distance between the fan and a suction hole disposed at a lower end of the hood-combined microwave oven is greater than a vertical length of the cavity. As described above, the distance between the suction hole and the fan is increased, such that the cooking gas collection performance of the microwave oven having the hood is inevitably lowered. This is because a flow rate of the suctioned airflow generated by the fan may be lowered in a manner inversely proportional to a square of the distance from the fan to the suction hole.

In addition, when the fan is disposed at the above-described position, an entirety of the vertical length of the hood-combined microwave oven is inevitably increased. Thus, when the hood-combined microwave oven having the increased vertical length is installed in an upper cabinet, the possibility that the hood-combined microwave oven protrudes downwardly beyond the upper cabinet is increased.

When the microwave oven having the hood protrudes downwardly beyond the upper cabinet, aesthetics thereof is not good, and a problem in which a spacing between a cooktop installed under the upper cabinet and the microwave oven having the hood is smaller may occur.

When the spacing between the cooktop and the microwave oven having the hood is smaller as the microwave oven having the hood protrudes downwardly beyond the upper cabinet, a problem in which the microwave oven having the hood screens the field of view of the user who wants to use the cooktop and a problem in which a cooking area of the cooktop is smaller may occur.

SUMMARY OF DISCLOSURE

### Technical Purpose

A purpose of the present disclosure is to provide a cooking appliance with an improved structure to provide a hood function while suppressing an increase in a total vertical length of the cooking appliance.

In addition, another purpose of the present disclosure is to provide a cooking appliance having an improved structure so as to suppress an increase in the lateral and front-rear lengths of the cooking appliance while reducing the vertical length of the cooking appliance.

In addition, still another purpose of the present disclosure is to provide a cooking appliance having an improved structure so as to reduce a flow loss generated inside the cooking appliance while suppressing an increase in a total volume of the cooking appliance.

In addition, still yet another purpose of the present disclosure is to provide a cooking appliance having an improved structure to lower a flow path resistance inside the cooking appliance and to allow exhausted air to flow smoothly.

### Technical Solution

The cooking appliance for achieving the above purpose according to an embodiment of the present disclosure is characterized in that a fan assembly for suctioning air into the inside of the cooking appliance and then discharging the air to the outside out of the cooking appliance is disposed in rear of a cavity having a cooking chamber defined therein.

In addition, another aspect of the present disclosure is characterized in that a fan assembly for suctioning air into the inside of the cooking appliance and then discharging the air to the outside out of the cooking appliance is disposed inside the cooking appliance, and is disposed in a space defined in rear of the cavity.

In addition, still another aspect of the present disclosure is characterized in that a fan assembly for suctioning air into the inside of the cooking appliance and then discharging the air to the outside out of the cooking appliance is disposed inside the cooking appliance, and is disposed in a space between a rear surface of a cavity having a cooking chamber defined therein and a rear plate constituting the rear outer appearance of the cooking appliance.

In addition, still yet another aspect of the present disclosure is characterized in that at least one fan assembly is disposed in a rear space which is a space between a rear surface of a cavity having a cooking chamber defined therein and a rear plate constituting an outer appearance of the rear surface of a cooking appliance, and at least one flow path defined by a plurality of flow path plates disposed in the rear space constitutes a passage connecting the fan assembly and an exhaust hole to each other, thereby inducing an exhaust flow.

In addition, still yet another aspect of the present disclosure provides a cooking appliance which may include a main body having a cooking chamber defined therein and having an air intake hole and an exhaust hole; a blower configured for suctioning air through the air intake hole and discharging the suctioned air toward the exhaust hole; and a flow path defining member inducing a flow of air discharged from the blower.

In addition, a rear space formed at a position in rear of the cooking chamber and communicating with the air intake hole and the exhaust hole may be provided inside the main body.

In addition, the flow path defining member may define an exhaust flow path for guiding the flow of air discharged from the blower toward the exhaust hole.

In addition, still yet another aspect of the present disclosure provides a cooking appliance which may include a main body including a cooking a cooking chamber defined in a cavity, a rear space disposed in rear of the cavity, a side space disposed on a side surface of the cavity, and a corner space in which the rear space and the side space partially overlap each other; a corner fan assembly disposed in the corner space and configured to intake air through a suction hole and discharge the suctioned air laterally through a discharge hole; and a support member configured to support the corner fan assembly so that a flow of air discharged from the discharge hole may be guided to the rear space.

In addition, the support member may preferably constitute a wall blocking the side space and the rear space from each other.

In addition, still yet another aspect of the present disclosure provides a cooking appliance which may include a main body having a cooking a cooking chamber defined in a cavity and a side space disposed on a side surface of the cavity; a partition plate configured to vertically partition the side space into a lower electronic/electrical component chamber and an upper electronic/electrical component chamber; a cooling fan disposed in the lower electronic/electrical component chamber; a blower disposed in rear of the cooling fan; and a support member configured to constitute a wall blocking the cooling fan and the blower from each other.

In addition, a connection flow path which constitutes a passage through which air introduced into the lower electronic/electrical component chamber by the cooling fan is introduced to the blower, may be provided inside the main body.

In addition, still yet another aspect of the present disclosure provides a cooking appliance which may include: a main body having a cooking a cooking chamber defined in a cavity, a rear space disposed in rear of the cavity, and an upper space disposed above the cavity, wherein the main body has an exhaust hole defined therein to communicate the upper space with the outside; a blower configured to suction air into the main body and discharge the suctioned air to the upper space through the rear space; and an extension plate disposed inside the main body.

According to still yet another aspect of the present disclosure, there is provided a cooking appliance including a main body having a cooking a cooking chamber defined in a cavity and an upper space disposed above the cavity, wherein the main body has an exhaust hole defined therein to communicate the upper space with the outside, and a circulation air discharge hole constituting a passage connecting the cooking chamber and the upper space to each other; a blower configured to suction air into the main body and discharge the suctioned air to the upper space; and an exhaust duct having a flow path defined therein connected to the circulation air discharge hole.

Furthermore, still yet another aspect of the present disclosure provides a cooking appliance which may include a cavity having a cooking chamber defined therein; a front plate disposed in front of the cavity; and a rear support member disposed in rear of the cavity.

In addition, still yet another aspect of the present disclosure provides a cooking appliance which may include a cavity having a cooking chamber defined therein; a rear plate disposed in rear of the cavity; and a rear support member disposed in a rear space which is a space between the rear surface of the cavity and the rear plate.

In this regard, a lower end of the front plate may be disposed at a vertical level lower than a vertical level of the cavity, and the rear support member may be in contact with a bottom surface of the cavity while being positioned at a vertical level lower than a vertical level of the cavity and may support the cavity.

In addition, still yet another aspect of the present disclosure provides a cooking appliance which may include: a main body having a cooking chamber defined in a cavity and a side space disposed on a side surface of the cavity; a partition plate vertically partitioning the side space into a lower electronic/electrical component chamber and an upper electronic/electrical component chamber; a through-hole constituting a passage connecting the lower electronic/electrical component chamber and the upper electronic/electrical component chamber to each other such that the passage is defined in the partition plate; and a screening member disposed to be spaced apart from the through-hole by a predetermined distance in a vertical direction and constructed to screen the through-hole while being positioned on top thereof or thereunder.

In addition, still yet another aspect of the present disclosure provides a cooking appliance which may include: a main body having a cooking chamber defined in a cavity and an upper space disposed above the cavity; a lamp installed on an upper surface of the cavity to illuminate the cooking chamber, wherein at least a portion of the lamp is exposed to a position above the cavity; and a lamp cover covering the lamp such that a space surrounding the lamp is blocked from the upper space.

According to one aspect of the present disclosure, a cooking appliance may include: a main body having a cooking chamber defined therein and having an air intake hole and an exhaust hole; and a blower disposed inside the main body.

In addition, a rear space formed at a position in rear of the cooking chamber and communicating with the air intake hole and the exhaust hole may be provided inside the main body.

In addition, the blower may include a fan assembly that suctions in air through the air intake hole and discharges the suctioned air to the exhaust hole.

In addition, the fan assembly may be disposed in the rear space.

In addition, the main body may include a cavity having a cooking chamber defined therein, and a rear plate disposed in rear of the cavity.

Further, the rear space may be defined between the cavity and the rear plate.

In addition, the main body may include a cavity having the cooking chamber defined therein, and a cabinet having an upper surface disposed above the cavity.

In addition, the exhaust hole may be in communication with an upper space defined between the upper surface of the cavity and the upper surface of the cabinet.

In addition, the fan assembly may discharge the suctioned air to the upper space.

In addition, the exhaust hole may be formed to extend through the upper surface of the cabinet.

In addition, the fan assembly may be disposed in a space communicating with the air intake hole and the exhaust hole.

In addition, the exhaust hole may be defined in an area overlapping the fan assembly in the vertical direction.

The fan assembly may be disposed at a position overlapping the cavity in the front-rear direction.

In addition, in the vertical direction, the fan assembly may be disposed between the upper surface and the lower surface of the cavity.

In addition, in the vertical direction, the fan assembly may be disposed at a position closer to the air intake hole than to the exhaust hole.

In addition, the blower may include a plurality of fan assemblies arranged in a lateral direction.

In addition, the fan assembly may include at least one fan module.

The fan module may include a fan housing having a suction hole and a discharge hole, and an impeller accommodated in the fan housing and configured to suction air through the suction hole and discharge air through the discharge hole.

In addition, the blower may include a rear fan assembly including a plurality of fan modules arranged in a lateral direction, and a corner fan assembly including one fan module.

In addition, the rear fan assembly and the corner fan assembly may be laterally arranged and disposed in the rear space.

In addition, a side space formed on the side of the cooking chamber may be defined inside the main body.

The rear space and the side space may communicate with each other through a corner space in which the rear space and the side space partially overlap each other.

In addition, at least a portion of the corner fan assembly may be disposed in the corner space.

In addition, in the corner fan assembly, the impeller may rotate about a vertical axis and suctions air in the vertical direction.

In addition, at least a portion of the fan assembly may be disposed in the corner space.

The blower may include a rear fan assembly disposed in the rear space; and a corner fan assembly, wherein at least a portion of the corner fan assembly is disposed in the rear space, and at least a portion of the conner fan assembly is disposed in the corner space.

In addition, an upper space formed above the cooking chamber, and an exhaust flow path configured to guide the air flow from at least one of the rear fan assembly and the corner fan assembly to the upper space may be defined in the main body.

In addition, the exhaust flow path may be disposed in the rear space.

In addition, the suction hole of the corner fan assembly may be disposed to face toward the air intake hole disposed below the blower.

In addition, the discharge hole of the corner fan assembly may be disposed to face laterally and be connected to the exhaust flow path.

In addition, the cooking appliance of the present disclosure may further include a flow path plate defining a lower boundary surface of the exhaust flow path while being positioned between the rear fan assembly and the corner fan assembly.

In addition, one end in the lateral direction of the flow path plate is disposed below the discharge hole.

In addition, at least a portion of the flow path plate may extend inclinedly upwardly in a lateral direction from one end in a lateral direction thereof adjacent to the corner fan assembly toward the rear fan assembly.

In addition, the fan assembly may be disposed between the upper surface and the lower surface of the main body.

In addition, the air intake hole may be defined in a bottom surface of the main body.

In addition, the exhaust hole may be defined in the upper surface of the main body.

In addition, an upper space formed above the cooking chamber may be defined inside the main body.

In addition, the fan assembly may suction air through the air intake hole and discharge the air to the rear space.

In addition, the rear space may connect the air intake hole and the upper space to each other.

In addition, the exhaust hole may communicate with the upper space.

In addition, the rear fan assembly may include at least one of a first fan module and a second fan module.

In addition, the first fan module may include a first suction hole disposed to face laterally, a first discharge hole disposed to face upwardly, and a first impeller configured to suction air through the first suction hole and discharge air through the first discharge hole.

The second fan module may include a second suction hole disposed to face downwardly, a second discharge hole disposed to face laterally, and a second impeller configured to suction air through the second suction hole and discharge air through the second discharge hole.

### Technical Effect

The cooking appliance of the present disclosure is configured such that the blower for providing a hood function is disposed in rear of the cavity instead of above the cavity, thereby suppressing an increase in the length in the vertical direction of the cooking appliance and providing the hood function at the same time.

In addition, in accordance with the present disclosure, the blower may be disposed in the rear space as a space secured for the installation of a convection module, etc., instead of the upper space and the side space defined inside the main body, thereby reducing the vertical length of the cooking appliance and effectively suppressing the increase of the vertical and lateral lengths of the cooking appliance, thereby effectively suppressing the increase in the vertical and lateral lengths of the cooking appliance and providing a hood function with improved performance at the same time.

In addition, the cooking appliance of the present disclosure adopts a structure in which the blower is disposed in the rear space which is connected to and is aligned with in a straight manner to the exhaust hole, thereby minimizing a flow loss inside the cooking appliance, and thus, further improving cooking gas removal performance.

In addition, in the cooling appliance of the present disclosure, the exhaust flow path defined by the flow path defining member may smoothly induce the exhaust flow while lowering the resistance of the flow path around the exhaust hole, thereby effectively improving the cooking gas discharge performance.

In addition, according to the present disclosure, the force provided by the suctioning force of the fan assembly may be applied to the electronic/electrical component chamber through the connection flow path, thereby allowing the air flow inside the electronic/electrical component chamber to be more smoothly performed such that the cooling of the electronic/electrical component disposed in the electronic/electrical component chamber may be more effectively performed.

In addition, the cooking appliance the present disclosure allows the air introduced into the electronic/electrical component chamber to flow into the fan assembly through the connection flow path from the electronic/electrical component chamber, thereby effectively increasing the suction flow rate of the fan assembly and thus providing more improved cooking gas removal performance.

In addition, according to the present disclosure, the total size of the exhaust space may be increased by the extension plate which divides the side space into upper and lower portions, thereby effectively increasing the size of the flow path required for the flow of air discharged to the exhaust hole through the exhaust space.

In addition, according to the present disclosure, each of a space involving in the gas exhaust and a space involving in the air intake may be secured in a sufficient size required for the intake or the exhaust due to the extension plate that vertically divides the side space. Thus, the cooking appliance of the present embodiment may provide the cooking gas removal performance that is equal to or higher than that of the conventional cooking appliance having a similar cooking capacity while having the total size smaller than that of the conventional cooking appliance having a similar cooking capacity.

In addition, the cooking appliance of the present disclosure is configured to allow both the steam and the gas discharged from the cooking chamber and the cooking gas suctioned through the air blower to be discharged through the common exhaust hole, thereby effectively increasing the area of the exhaust hole used for the gas exhaust, and thus more smoothly discharging the cooking gas through the exhaust hole.

In addition, the cooking appliance of the present disclosure may include the exhaust duct formed in a structure in which the vertical length thereof decreases as the exhaust duct extends toward the rear side, thereby effectively suppressing an increase in the flow resistance caused by the exhaust duct while smoothly discharging the steam and gas discharged from the cooking chamber to the outside out of the cooking appliance.

In addition, the cooking appliance of the present disclosure allows the exhaust duct to be removably coupled to the duct bracket bonded to the cavity, thereby allowing the exhaust duct to be easily and quickly removed from the cavity as needed, and suppressing the occurrence of damage to the cavity that may occur during the process of disassembling and reassembling the exhaust duct.

In addition, the cooking appliance of the present disclosure includes the rear support member which plays a role of stably maintaining the posture of the cavity so that the cavity does not fall over in the rearward direction during the assembly process of the cooking appliance, thereby enabling the assembly of the cooking appliance to be conveniently performed in a more stable environment, and suppressing the occurrence of various safety accidents which may occur due to the falling over of the cavity during the assembly process of the cooking appliance.

In addition, the cooking appliance of the present disclosure can effectively improve the structural stability of the cooking appliance due to the rear support member installed on the rear side of the cavity so as to stably support the rear plate and the base plate on the cavity.

In addition, the cooking appliance of the present disclosure maintains the spacing between the cavity and the rear plate via the rear support member so that a sufficient space required for air flow in the rear space can be secured, thereby effectively increasing the suction flow rate.

In addition, the cooking appliance of the present disclosure includes the screening member for screening the lower electronic/electrical component chamber while being positioned on top thereof, thereby allowing smooth inflow of air into the lower electronic/electrical component chamber, and at the same time, significantly reducing the risk of the fire spreading due to the flame generated inside the cooking appliance.

In addition, the cooking appliance of the present disclosure includes the lamp cover covering the lamp while being positioned on top thereof, thereby satisfying a purpose of reducing the vertical length of the cooking appliance and a purpose of protecting the lamp from oil vapor and heat.

In addition, the lamp cover according to the present disclosure is provided in a structure in which the vertical length thereof deceases as the lamp cover extends toward the rear side, so that the lamp may be effectively protected from the oil vapor and heat while an increase in the flow resistance caused by the lamp cover may be effectively suppressed.

In addition, in accordance with the present disclosure, a simple work of removing the ventilation grill and the opening/closing cover may allow the user to access the lamp, thereby enabling the maintenance and repair of the lamp to be performed in an easy and fast manner.

### BRIEF DESCRIPTION OF DRAWINGS

FIG. 1 is a perspective view illustrating a cooking appliance according to a first embodiment of the present disclosure.

FIG. 2 is a diagram illustrating an open state of a cooking chamber of the cooking appliance as illustrated in FIG. 1.

FIG. 3 is a bottom view illustrating a bottom surface of the cooking appliance as illustrated in FIG. 1.

FIG. 4 is a rear perspective view illustrating a state in which a cabinet has been removed from the cooking appliance as illustrated in FIG. 1.

FIGS. 5 and 6 are rear perspective views illustrating a state in which a rear plate has been removed from the cooking appliance as illustrated in FIG. 4.

FIG. 7 is a rear view of the cooking appliance as illustrated in FIG. 6 according to an embodiment.

FIG. 8 is a perspective view illustrating a rear fan assembly separated from the cooking appliance as illustrated in FIG. 6.

FIG. 9 is a perspective view illustrating a corner fan assembly separated from the cooking appliance as illustrated in FIG. 6.

FIG. 10 is a rear perspective view illustrating a flow path defining member separated from the cooking appliance as illustrated in FIG. 6.

FIG. 11 is a rear perspective view illustrating a cooking appliance to which another example of a flow path defining member is applied.

FIG. 12 is a rear perspective view illustrating a flow path defining member separated from the cooking appliance as illustrated in FIG. 11.

FIG. 13 is a rear view illustrating an air flow state in a cooking appliance according to a first embodiment of the present disclosure.

FIG. 14 is a rear perspective view illustrating a first state of a cooking appliance according to a first embodiment of the present disclosure.

FIG. 15 is a diagram illustrating an air flow state in the cooking appliance as illustrated in FIG. 14.

FIG. 16 is a rear perspective view illustrating a second state of a cooking appliance according to a first embodiment of the present disclosure.

FIG. 17 is a diagram illustrating an air flow state in the cooking appliance as illustrated in FIG. 16.

FIG. 18 is a rear perspective view illustrating a third state of a cooking appliance according to a first embodiment of the present disclosure.

FIG. 19 is a diagram illustrating an air flow state in the cooking appliance as illustrated in FIG. 18.

FIG. 20 is an enlarged view illustrating a corner fan assembly and an enlarged view of surroundings thereof.

FIG. 21 is a rear perspective view illustrating a support member separated from the cooking appliance as illustrated in FIG. 20.

FIG. 22 is a rear perspective view illustrating a portion of a cooking appliance to which another example of a support member is applied.

FIG. 23 is a rear perspective view illustrating the support member separated from the cooking appliance as illustrated in FIG. 22.

FIG. 24 is a diagram illustrating a state in which external air is introduced into an electronic/electrical component chamber through a cold air inlet.

FIGS. 25 to 27 are diagrams illustrating a flow state of air flowing into the electronic/electrical component chamber.

FIG. 28 is a diagram illustrating a flow state of air introduced from an upper corner space to a lower corner space through a connection flow path.

FIG. 29 is a rear perspective view illustrating a portion of a cooking appliance to which another example of a screening member is applied.

FIG. 30 is a rear perspective view illustrating each of an air intake state and an air exhaust state of a cooking appliance according to a first embodiment of the present disclosure.

FIG. 31 is a rear perspective view illustrating an air flow state inside the cooking appliance as illustrated in FIG. 30.

FIG. 32 is an enlarged plan view illustrating a surrounding around a common exhaust hole as illustrated in FIG. 30.

FIG. 33 is an enlarged view illustrating an exhaust duct and a surrounding therearound.

FIG. 34 is a side cross-sectional view illustrating the exhaust duct.

FIG. 35 is a plan view illustrating a state in which a duct bracket is installed on an upper surface of a cavity.

FIG. 36 is a diagram illustrating a state in which an exhaust duct is installed at a duct bracket.

FIG. 37 is an enlarged view illustrating a lamp cover and a surrounding therearound.

FIG. 38 is a plan view of the lamp cover as illustrated in FIG. 37.

FIG. 39 is a rear perspective view illustrating a cooking appliance to which another example of a lamp cover is applied.

FIG. 40 is a perspective view illustrating the lamp cover separated from the cooking appliance as illustrated in FIG. 39.

FIG. 41 is an exploded perspective view illustrating an exploded state of the lamp cover as illustrated in FIG. 40.

FIG. 42 is an exploded perspective view illustrating an exploded state of a ventilation grill and the lamp cover.

FIG. 43 is a rear perspective view illustrating a state in which a rear fan assembly has been removed from the cooking appliance according to the first embodiment of the present disclosure.

FIG. 44 is a rear perspective view illustrating a rear support member as illustrated in FIG. 43 separated from the cooking appliance.

FIG. 45 is a side view illustrating a coupling state between a cavity and a rear support member.

FIG. 46 is an enlarged bottom perspective view illustrating a coupling portion between the cavity and the rear support member as illustrated in FIG. 45.

FIG. 47 is a side view illustrating a state in which a rear plate is coupled to the rear support member as illustrated in FIG. 45.

FIG. 48 is a side cross-sectional view illustrating a coupling structure between the cavity and the rear support member and the rear plate.

FIG. 49 is a rear perspective view illustrating a state in which a cabinet has been removed from a cooking appliance according to a second embodiment of the present disclosure.

FIG. 50 is a rear perspective view illustrating a state in which a cabinet has been removed from a cooking appliance according to a third embodiment of the present disclosure.

FIG. 51 is a rear perspective view illustrating a state in which a cabinet has been removed from a cooking appliance according to a fourth embodiment of the present disclosure.

### DETAILED DESCRIPTIONS

The above-described purposes, features and advantages will be described in detail with reference to the accompanying drawings, and accordingly, a person having ordinary skill in the art to which the present disclosure belongs will be able to easily implement the technical idea of the present disclosure. In describing the present disclosure, a detailed description of known technologies related to the present disclosure will be omitted when it is determined that the gist of the present disclosure may be unnecessarily unclear. Hereinafter, preferred embodiments according to the present disclosure will be described in detail with reference to the accompanying drawings. In the drawings, the same reference numerals are used to refer to the same or similar components.

Although the first, second, and the like are used to describe various components, these components are not limited by these terms. These terms are only used to distinguish one component from another component, and it is obvious that the first component may be the second component unless there is a particular opposite description.

The present disclosure is not limited to the embodiments disclosed below. However, various changes may be applied thereto and the present disclosure may be implemented in various forms different from each other. However, the present embodiment is provided so that the present disclosure is complete and the scope of the present disclosure is fully known to those of ordinary skill in the art. Therefore, the present disclosure is not limited to the embodiments disclosed below, but it should be understood that the present disclosure includes all changes, equivalents, and substitutes included in the technical spirit and scope of the present disclosure, as well as includes replacing the configuration of one embodiment with the configuration of another embodiment and adding the configuration of another embodiment to the configuration of one embodiment.

The accompanying drawings are only set forth for the skilled person to the art to easily understand the embodiments disclosed in the present disclosure, and the technical spirit disclosed in the present disclosure is not limited by the accompanying drawings, and it should be understood that all changes, equivalents, and substitutes included in the spirit and technical scope of the present disclosure are included in the present disclosure. In the drawings, the components may be expressed in an exaggerated or small size in consideration of convenience of understanding or the like. However, the scope of protection of the present disclosure should not be limited thereto.

The terms used herein are used only to describe specific embodiments or implementations, and are not intended to limit the present disclosure. Further, the singular expression of a component includes the plural expression thereof unless the context clearly indicates otherwise. In the present disclosure, the terms “include,” “composed of”, etc. are intended to designate that the features, numbers, steps, operations, components, parts, or combinations thereof described in the present disclosure are present. That is, it should be understood that the terms such as “include” and “composed of” in the present disclosure do not exclude the possibility of the presence or addition of one or more other features, numbers, steps, operations, components, parts, or combinations thereof.

The terms including ordinals, such as first and second, may be used to describe various components, but the components are not limited by the terms. The terms are used only for the purpose of distinguishing one component from another component.

When it is mentioned that one component is “connected” or “coupled” to another component, it should be understood that one component may be directly connected or coupled to another component, or there may be still another component disposed therebetween. On the other hand, when it is stated that one component is “directly connected” or “directly coupled” to another component, it should be understood that still another component is absent therebetween.

When it is mentioned that a component is “above” or “under” another component, it should be understood that still another component may be present or absent therebetween.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In a state in which the cooking appliance is placed on the floor, a side at which the door is installed around a center of the cooking appliance is defined as a front side. Therefore, when the door is opened, the cooking target enters the cavity of the cooking appliance in a rear direction. For convenience, a front-rear direction may be referred to as a first direction. In this regard, the front side may be referred to as one side in the first direction, and the rear side may be referred to as the other side in the first direction.

In addition, the direction of gravity may be defined as a downward direction and the direction opposite to the direction of gravity may be defined as an upward direction.

In addition, a horizontal direction orthogonal to the front-rear direction of the cooking appliance, that is, a width direction of the cooking appliance in a front view of the door of the cooking appliance may be referred to as a left-right direction. For convenience, the left-right direction may be referred to as a second direction. Then, the right side may be referred to as one side in the second direction, and the left side may be referred to as the other side in the second direction.

In addition, the width direction of the cooking appliance may be referred to as a lateral direction. Then, the right side may be referred to as one side in the lateral direction, and the left side may be referred to as the other side in the lateral direction.

In addition, the above-described vertical direction may be referred to as a third direction. Then, the upper side may be referred to as one side in the third direction, and the lower side may be referred to as the other side in the third direction.

The front-rear direction and the left-right direction, that is, the first direction and the second direction may be first and second horizontal directions.

Throughout the present disclosure, “A and/or B” means A, B, or A and B, unless otherwise specified, and “C to D” means C inclusive to D inclusive unless otherwise specified.

### Overall Structure of Cooking Appliance

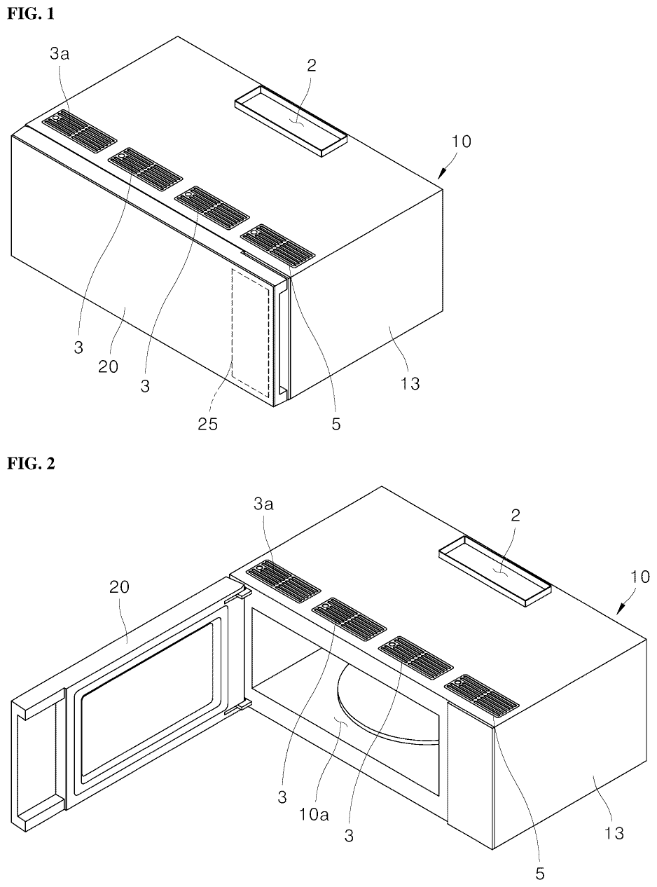

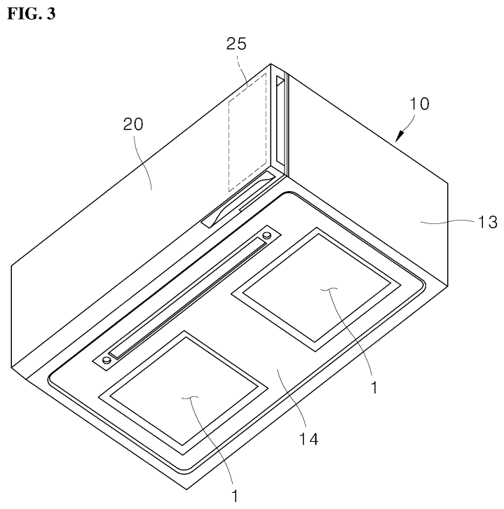

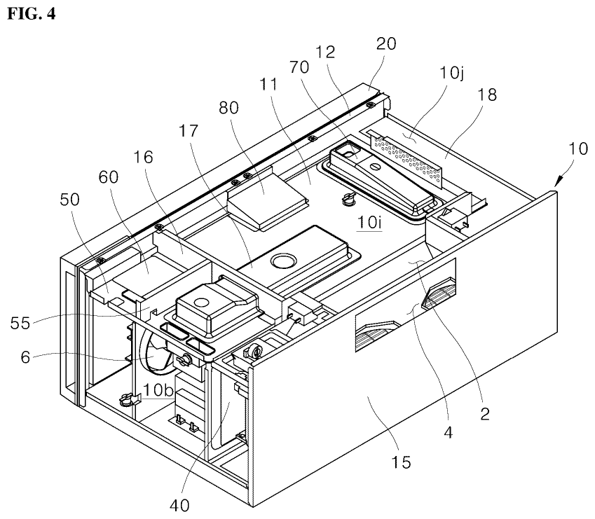

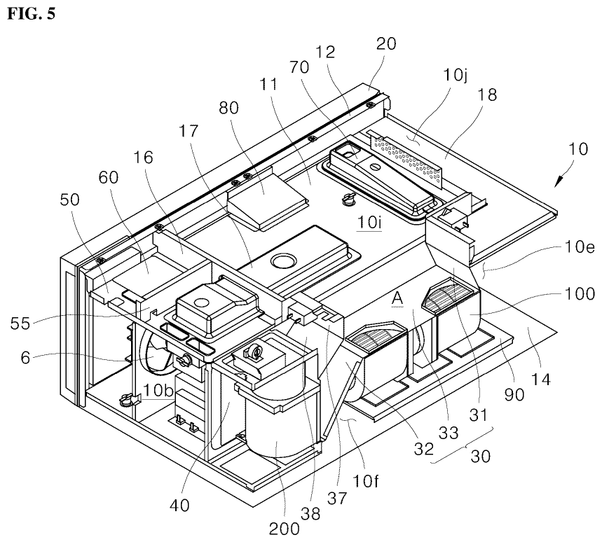

FIG. 1 is a perspective view illustrating a cooking appliance according to a first embodiment of the present disclosure, and FIG. 2 is a diagram illustrating an open state of a cooking chamber of the cooking appliance as illustrated in FIG. 1. In addition, FIG. 3 is a bottom view illustrating a bottom surface of the cooking appliance as illustrated in FIG. 1, and FIG. 4 is a rear perspective view illustrating a state in which a cabinet has been removed from the cooking appliance as illustrated in FIG. 1.

Referring to FIGS. 1 to 4, the cooking appliance according to an embodiment of the present disclosure has an outer appearance defined by the main body 10. The main body 10 may be provided in a shape including a substantially rectangular parallelepiped shape, and may be made of a material having a predetermined strength to protect a plurality of components installed in an inner space defined therein. The main body 10 may include a cavity 11, a cabinet 13, and a base plate 14.

The cavity 11 may constitute an internal skeleton of the main body 10. The cavity 11 may be formed in the form of a hexahedron with an open front surface. A cooking chamber 10a may be formed inside the cavity 11. The cooking chamber 10a may be formed in a shape corresponding to an inner shape of the cavity 11, that is, a hexahedral shape with an open front surface.

The cooking chamber 10a may be formed in a hexahedral shape with an open front surface. While the cooking chamber 10a is shielded, cooking may be performed while the inner space of the cooking chamber 10a is heated. That is, in the cooking appliance, the inner space of the cooking chamber 10a is a space in which food is substantially cooked.

A front plate 12 may be disposed in front of the cavity 11. The front plate 12 may define a front appearance of the main body 10 in front of the cavity 11. In an example, the front plate 12 may be provided in the form of a metal plate having a hollow.

The cabinet 13 may define an outer appearance of the main body 10 while being disposed on an outer side of the cavity 11. The cabinet 13 may cover the cavity 11 at upper and side portions thereof and may define the outer appearance of the main body 10.

The base plate 14 may be disposed on a lower side of the cavity 11. The base plate 14 may constitute a bottom surface of the cooking appliance, and may cover the cavity 11 at a lower side of the cavity 11.

In addition, the main body 10 may further include a rear plate 15. The rear plate 15 may be disposed on a rear side of the cavity 11. The rear plate 15 may constitute a rear surface of the cooking appliance, and may cover the cavity 11 while being disposed in rear of the cavity 11.

The rear plate 15 may be integrally formed with the cabinet 13, or may be formed separately from the cabinet 13.

A door 20 for selectively opening and closing the cooking chamber 10a may be pivotably provided on a front surface of the main body 10. The door 20 may open and close the cooking chamber 10a in a side-swinging manner in which the other side in the lateral direction thereof pivots in a left or right direction around one side in the lateral direction thereof.

The door 20 may be generally formed in a hexahedral shape having a predetermined thickness. In addition, a hinge may be installed at between the main body 10 and the door 20. The hinge may be disposed on one side in the lateral direction of the main body 10 to pivotably couple one side in the lateral direction of the door 20 to the main body 10. The door 20 may be pivotably coupled to the hinge while being disposed on the front surface of the main body 10, and may open and close the cooking chamber 10a while pivoting about the hinge.

In addition, a cooking chamber heat source for heating the inside of the cooking chamber 10a is provided inside the main body 10. The cooking chamber heat source may be implemented in one type, or may be implemented in two or more types.

In the present embodiment, an example in which the cooking chamber heat source includes a magnetron capable of supplying a high frequency heat source to the inside of the cooking chamber 10a is described. In this regard, the magnetron may be installed inside the main body 10, and may be installed to be located on an upper or lower side of the cooking chamber 10a.

In addition, an electronic/electrical component chamber 10b, 10c, and 10d located on an upper surface or a side surface of the cooking chamber 10a and in the main body 10 may be defined inside the main body 10. In the present embodiment, it is illustrated that the magnetron and the electronic/electrical component chamber 10b, 10c, and 10d are disposed on the side surface of the cooking chamber 10a. Electronic components such as the magnetron and a high-voltage transformer may be installed inside the electronic/electrical component chamber 10b, 10c, and 10d.

In addition, a control panel 25 may be provided at a front side of the main body 10. In one example, the control panel 25 may be disposed on the door 20.

The control panel 25 may be formed in a hexahedral shape having a predetermined internal space defined therein, and an input unit for inputting a manipulation signal for operating the cooking appliance by a user may be provided on a front surface of the control panel 25. A plurality of manipulation switches are provided in the input unit, and the user may directly input an operation signal thereon.

In another example, the control panel 25 may be disposed in front of the cavity 11. The control panel 25 may be disposed in an area not overlapping the cooking chamber 10a in the front-rear direction. For example, the electronic/electrical component chamber 10b, 10c, and 10d may be disposed on the side surface of the cooking chamber 10a, and the control panel 25 may be disposed on the front side of the electronic/electrical component chamber 10b, 10c, and 10d.

In addition, the cooking appliance of the present embodiment may further include a blower 100 and 200. In addition, the main body 10 may be provided with an air intake hole 1 and an exhaust hole 2, 3, and 4.

The air blower 100 and 200 may be accommodated in the cooking appliance, and may suction the cooking gas through the air intake hole 1 and discharge the suctioned cooking gas to the outside out of the cooking appliance through the exhaust hole 2, 3, and 4.

### Intake Hole, Exhaust Hole, Space

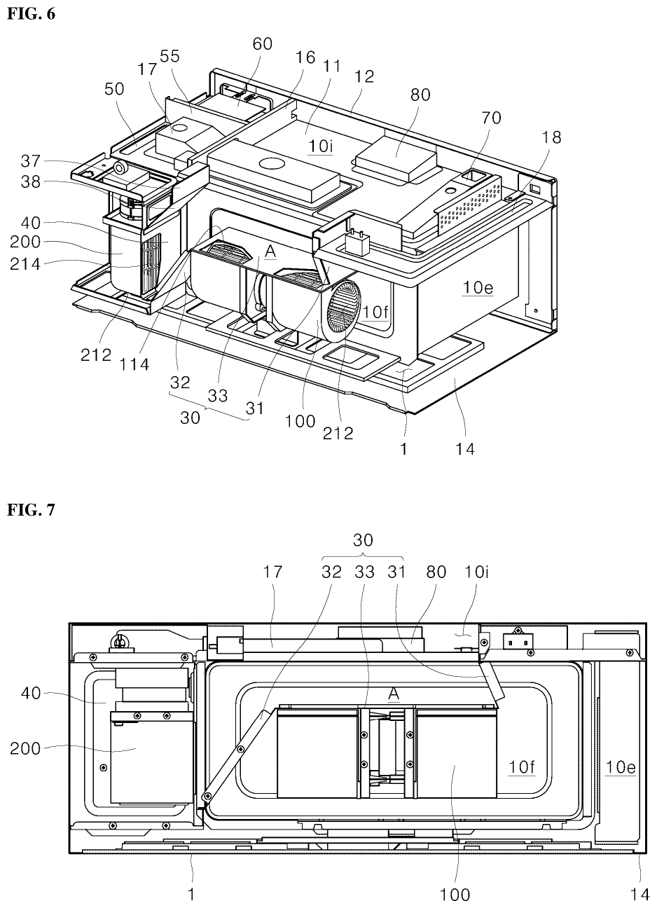

FIGS. 5 and 6 are rear perspective views illustrating a state in which a rear plate has been removed from the cooking appliance as illustrated in FIG. 4, and FIG. 7 is a rear view of the cooking appliance as illustrated in FIG. 6.

Referring to FIGS. 3 to 7, the air intake hole 1 may be disposed in a bottom surface of the cooking appliance. In one example, the air intake hole 1 may be defined in the base plate 14. The air intake hole 1 may constitute a passage for introducing the cooking gas into the cooking appliance such that the passage is defined at the lower end of the cooking appliance. In the present embodiment, it is illustrated that a pair of air intake holes 1 are disposed under the blower 100 and 200.

The base plate 14 may be disposed to be spaced apart downward from the bottom surface of the cavity 11 by a predetermined distance. Accordingly, a lower space (not indicated by a reference numeral) may be defined between the bottom surface of the cavity 11 and the base plate 14. Due to the lower space formed as described above, a space required for external air to be introduced into the cooking appliance through the air intake hole 1 may be provided on the upper side of the air intake hole 1.

The exhaust hole 2, 3, and 4 may be defined in the upper surface of the cooking appliance. The exhaust hole 2, 3, and 4 may constitute a passage defined in the upper portion of the cooking appliance for discharging the cooking gas suctioned into the cooking appliance to the outside out of the cooking appliance.

In the present embodiment, it is illustrated that the first exhaust hole 2, the second exhaust hole 3, and the third exhaust hole 4 are provided in the cooking appliance.

The first exhaust hole 2 and the second exhaust hole 3 may be disposed at the upper surface of the main body 10. The first exhaust hole 2 and the second exhaust hole 3 may constitute a passage defined at the upper end of the cooking appliance to discharge the cooking gas suctioned into the cooking appliance to the outside out of the cooking appliance.

In one example, the first exhaust hole 2 and the second exhaust hole 3 may be defined in the upper surface of the cabinet 13. The first exhaust hole 2 and the second exhaust hole 3 may be formed in the upper surface of the cabinet 13 so as to extend through the cabinet 13 in a vertical direction.

The first exhaust hole 2 may be disposed in a rear portion of the upper surface of the main body 10. In addition, the second exhaust hole 3 may be disposed at the front side of the upper surface of the main body 10. That is, the second exhaust hole 3 may be disposed at a side adjacent to the door 20, and may be disposed to be closer to the front side than the first exhaust hole 2 may be.

The first exhaust hole 2 may constitute a passage for discharging the cooking gas suctioned into the cooking appliance to the outside. The second exhaust hole 3 may constitute a passage for discharging the cooking gas suctioned into the cooking appliance into an indoor room.

In one example, the first exhaust hole 2 may be disposed in an area overlapping an upper cabinet in which the cooking appliance is received in the vertical direction. In addition, the second exhaust hole 3 may be disposed at a position protruding in a frontward direction beyond the upper cabinet.

In addition, the first exhaust hole 2 may be disposed approximately at a center in the lateral direction of the main body 10. In addition, a plurality of second exhaust holes 3 may be arranged in the lateral direction and may be positioned at the front side of the upper surface of the main body 10.

The first exhaust hole 2 disposed approximately at the center in the lateral direction of the main body 10 as described above may be connected to an exhaust pipe connected to the outdoor. The plurality of second exhaust holes 3 arranged in the lateral direction may discharge the cooking gas from a position in front of the upper cabinet to a position on top of the cooking appliance. In this regard, the cooking gas may be discharged through the second exhaust hole 3 in a state of being filtered inside the cooking appliance.

Like the first exhaust hole 2, the third exhaust hole 4 may constitute a passage for discharging the cooking gas suctioned into the cooking appliance to the outside. The third exhaust hole 4 may be disposed to face a wall surface on which the cooking appliance is installed. The third exhaust hole 4 may be installed on the rear surface of the main body and may be connected to an exhaust pipe connected to the outside.

The third exhaust hole 4 may be defined in the rear surface of the cooking appliance, and may be disposed above the blower 100 and 200. In one example, the third exhaust hole 4 may be defined in the rear plate 15. The third exhaust hole 4 may be formed to extend through the rear plate 15 in the front-rear direction.

A space may be formed in the main body 10. The space may be disposed between the cavity 11 and the cabinet 13.

The space may be divided into a side space 10e and a rear space 10f. The side space 10e may be disposed on each of both opposing sides in the lateral direction of the cavity 11. In addition, the rear space 10f may be disposed on the rear side of the cavity 11.

For example, each side space 10e may be a space defined between each side surface of the cavity 11 and each side surface of the cabinet 13. In addition, the rear space 10f may be a space defined between the rear surface of the cavity 11 and the rear plate 15.

The side space 10e and the rear space 10f may communicate with the lower space. The side space 10e and the rear space 10f may be connected to a lower space in the vertical direction or may be connected thereto in the lateral direction. The air intake hole 1 may be in communication with the lower space. The side space 10e and the rear space 10f may be in communication with the air intake hole 1 through the lower space.

The electronic/electrical component chamber 10b, 10c, and 10d may be disposed in one of the side spaces 10e. In the present embodiment, it is illustrated that the electronic/electrical component chamber 10b, 10c, and 10d are provided in the side space disposed in rear of the control panel 25.

In addition, a space disposed on the side surface of the cavity 11 and the rear side of the cavity 11 may be defined inside the main body 10. The space may be the rear space 10f, the side space 10e, or may be the electronic/electrical component chamber 10b, 10c, and 10d.

For example, the space may be disposed in a rear corner portion inside the main body 10. Hereinafter, the space disposed in rear of the electronic/electrical component chamber 10b, 10c, and 10d will be referred to as a corner space 10e. The rear space 10f and the side space 10e, more specifically, the rear space 10f and the electronic/electrical component chamber 10b, 10c, 10d may communicate with each other through the corner space 10e.

The blower 100 and 200 may be disposed inside the main body 10. More specifically, the air blower 100 and 200 may be disposed in the space, that is, the space between the cavity 11 and the cabinet 13. The blower 100 and 200 may include at least one fan assembly 100 and 200.

The fan assembly 100 and 200 may generate an airflow for suctioning the cooking gas outside the cooking appliance and discharging the cooking gas to the outside out of the cooking appliance. The fan assembly 100 and 200 may introduce the cooking gas into the main body 10 through the air intake hole 1 and discharge the introduced cooking gas through the exhaust hole 2, 3, and 4 out of the main body.

At least one of the fan assembly 100 and 200 provided in the air blower 100 and 200 may be disposed in the rear space 10f. Accordingly, the cooking gas introduced into the main body 10 through the air intake hole 1 may flow through the rear space 10f and then be discharged through the first exhaust hole 2 or the second exhaust hole 3. A detailed arrangement structure of the fan assembly 100 and 200 will be described later.

In addition, an upper space 10i may be further provided inside the main body 10. The upper space 10i may be disposed above the cavity 11.

For example, the upper space 10i may be defined between the upper surface of the cavity 11 and the upper surface of the cabinet 13. The upper space 10i may be connected to the rear space 10f.

That is, the air introduced into the rear space 10f may flow through the upper space 10i and be discharged to the outside out of the cooking appliance through the exhaust hole 2, 3, and 4. In addition, the air introduced into the side space 10e may also flow through the rear space 10f and the upper space 10i and may be discharged to the outside out of the cooking appliance through the exhaust hole 2, 3, and 4.

### Fan Assembly

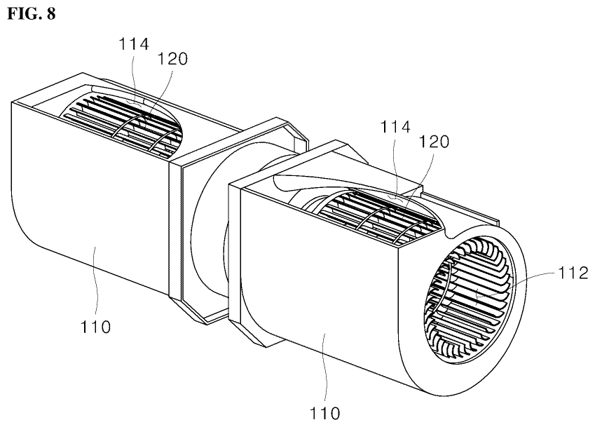

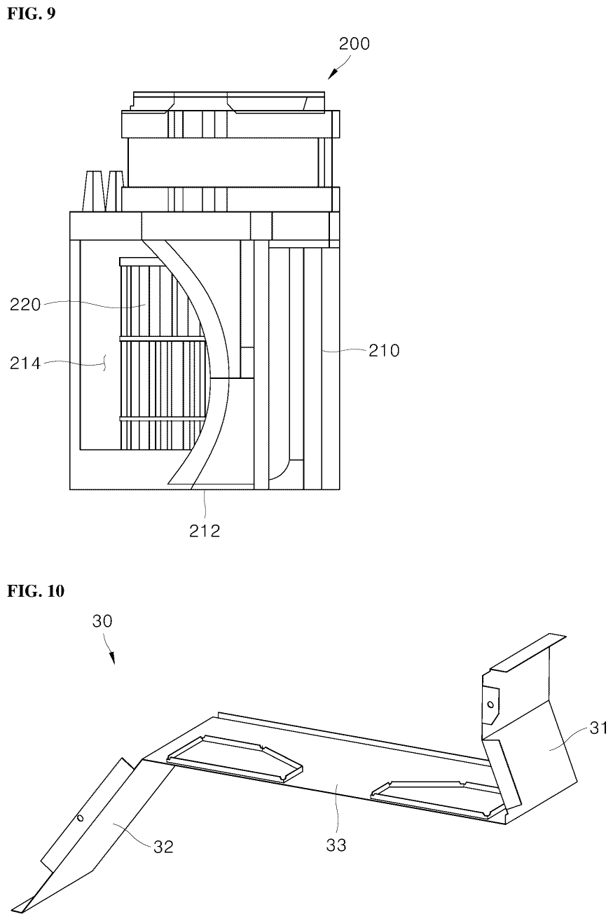

FIG. 8 is a perspective view illustrating a rear fan assembly separated from the cooking appliance as illustrated in FIG. 6, and FIG. 9 is a perspective view illustrating a corner fan assembly separated from the cooking appliance as illustrated in FIG. 6.

Referring to FIGS. 1 and 7 to 8, the blower 100 and 200 may include at least one fan assembly 100 and 200. In one example, the blower 100 and 200 may include a rear fan assembly 100.

The rear fan assembly 100 may include a fan housing 110, an impeller 120, and a fan motor.

The fan housing 110 may define an outer appearance of the rear fan assembly 100, and may accommodate the impeller 120 therein. A first suction hole 112 may be formed at a side portion of the fan housing 110. The first suction hole 112 may constitute a passage necessary for the air outside the rear fan assembly 100 to be suctioned into the impeller 120 in the fan housing 110.

In the present embodiment, the fan housing 110 is illustrated as being formed in a shape including a horizontally extending cylindrical shape in which both opposing sides thereof are open, and each of both opposing open sides of the fan housing 110 may be provided as the first suction hole 112.

An accommodation space for accommodating the impeller 120 therein may be formed in the fan housing 110.

The accommodation space for accommodating the impeller 120 therein may be formed inside the fan housing 110. In addition, an inner circumferential surface of the fan housing 110 defining the accommodation space may be formed as a curved surface surrounding an outer circumferential surface of the impeller 120.

A first discharge hole 114 may be provided at an upper side of the fan housing 110. The first discharge hole 114 constitutes a passage through which air suctioned into the accommodation space in which the impeller 120 is accommodated is discharged to the outside of the blower 100 and 200.

The first discharge hole 114 may be formed to extend through the fan housing 110 in the vertical direction. Accordingly, the air suctioned into the fan housing 110 in a lateral direction through the first suction hole 112 may be discharged to a position on top of the fan housing 110 through the first discharge hole 114.

The impeller 120 is constructed to be rotated about an axis extending in the lateral direction. A space into which air suctioned through a side portion of the impeller 120 is introduced is formed inside the impeller 120.

The impeller 120 may be connected to a rotation shaft of the fan motor. The rotation shaft of the fan motor rotates about an axis extending in a lateral direction, and the impeller 120 connected to the rotation shaft of the fan motor may rotate about an axis extending in a lateral direction together with the rotation shaft of the fan motor.

The rear fan assembly 100 provided as described above may be disposed inside the main body 10, and may be disposed in at least one of the rear space 10f and the corner space 10e. In the present embodiment, the rear fan assembly 100 is illustrated as being disposed in the rear space 10f.

In one example, the rear fan assembly 100 may be provided in a form including a pair of impellers 120. The rear fan assembly 100 may be provided in a form in which the fan motor is disposed between a pair of impellers 120 arranged in a lateral direction.

In the rear fan assembly 100, the fan motor may rotate the pair of impellers 120 respectively disposed on both opposing sides in the lateral direction thereof together. Each impeller 120 may be accommodated in each of a pair of fan housings 110 respectively disposed on both opposing sides in the lateral direction of the fan motor.

As described above, the rear fan assembly 100 including one fan motor, the pair of impellers 120, and the fan housing 110 may suction the air through the pair of first suction holes 112 respectively disposed at both opposing sides in the lateral direction of the rear fan assembly 100, and discharge the air through the pair of first discharge holes 114 disposed in the upper surface of the rear fan assembly 100 and arranged in the lateral direction.

The rear fan assembly 100 may be provided in a form in which the pair of impellers 120 are respectively disposed on both opposing sides in the lateral direction of the fan motor and the pair of fan housings 110 are respectively disposed on both opposing sides in the lateral direction of the fan motor. Hereinafter, an assembly of the impeller 120 and the fan housing 110 will be referred to as a “fan module.” In this regard, the rear fan assembly 100 may be provided in a form in which a pair of fan modules are connected to both opposing sides in the lateral direction of the fan motor.

The rear fan assembly 100 may be disposed in the rear space 10f, that is, in a space defined between the rear surface of the cavity 11 and the rear plate 15. The rear fan assembly 100 may be disposed in a space communicating with the air intake hole 110 and the exhaust hole 2, 3, and 4, and may suction air through the air intake hole 110 and discharge the air toward the exhaust hole 2, 3, and 4.

In addition, the rear fan assembly 100 may be disposed at the center in the lateral direction of the rear space 10f. That is, the rear fan assembly 100 may be disposed at approximately a center of the rear side inside the cooking appliance.

According to the present embodiment, the first exhaust hole 2 may be disposed approximately at the center in the lateral direction of the main body 10, and may be defined in the upper surface of the cabinet 13 and may be positioned at a position closer to the rear end thereof. In addition, the first exhaust hole 2 may be disposed in an area overlapping the fan assembly 100 and 200 in the vertical direction. That is, the first exhaust hole 2 may be disposed in an area overlapping the rear space 10a and the rear fan assembly 100 in the vertical direction.

In addition, the third exhaust hole 4 may be disposed at approximately the center in the lateral direction of the main body 10, and may be disposed in the rear plate 15 and at a position closer to an upper end thereof. That is, the third exhaust hole 4 may be disposed in the rear surface of the main body 10, but may be disposed at a position adjacent to the first exhaust hole 2.

In the cooking appliance according to the present embodiment, all of the first exhaust hole 2, the third exhaust hole 4, and the rear fan assembly 100 may be disposed in the rear space 10f. The first exhaust hole 2 and the third exhaust hole 4, in particular, the first exhaust hole 2 may be aligned with the rear fan assembly 100 in the vertical direction along the rear space 10f.

That is, the rear fan assembly 100, the rear space 10f, the first exhaust hole 2, and the third exhaust hole 4 may overlap each other in the vertical direction. Preferably, the rear fan assembly 100, the rear space 10f, the first exhaust hole 2, and the third exhaust hole 4 may be aligned with each other in a line along the vertical direction.

Accordingly, the flow of air performed by the operation of the rear fan assembly 100 may have the same straight line direction as the direction in which the rear fan assembly 100, the rear space 10f, the first exhaust hole 2, and the third exhaust hole 4 are aligned with each other.

When the air flows in the straight line direction as described above, the resistance to the air flow is lowered so that the air flow may be performed more smoothly. Accordingly, air suction and discharge performance by the rear fan assembly 100 may be improved, and thus cooking gas removal performance of the cooking appliance may be improved accordingly.

The blower 100 and 200 of the present embodiment may include a plurality of fan assemblies 100 and 200 arranged in the lateral direction. In one example, the blower 100 and 200 may further include a corner fan assembly 200, as illustrated in FIGS. 7 and 9. The rear fan assembly 100 and the corner fan assembly 200 may be laterally arranged and disposed in the rear space 10f.

The corner fan assembly 200 may be provided in a form in which one fan module is connected to a fan motor. In one example, the corner fan assembly 200 may be provided in a form in which one fan module is connected to a lower side of the fan motor.

In the corner fan assembly 200, the impeller 220 may rotate about a vertical axis. A second suction hole 212 may be disposed in a lower surface of the fan housing 210, and a second discharge hole 224 may be disposed at a side surface of the fan housing 210.

That is, the corner fan assembly 200 may be provided in a form similar to a form in which approximately a half of the rear fan assembly 100 is erected in the vertical direction.

The rear fan assembly 100 and the corner fan assembly 200 may be disposed together in the rear space 10f. In one example, the rear fan assembly 100 and the corner fan assembly 200 may be laterally arranged and disposed in the rear space 10f.

For example, the corner fan assembly 200 may be disposed adjacent to the electronic/electrical component chamber 10b, 10c, and 10d at one side of the main body, while the rear fan assembly 100 may be disposed adjacent to the side space 10e at the other side of the main body.

At least a portion of the corner fan assembly 200 may be disposed in the corner space 10e. In one example, a substantial portion of an area of the corner fan assembly 200 may be disposed in the corner space 10e, and the second suction hole 212 of the corner fan assembly 200 may also be disposed in the corner space 10e. The corner fan assembly 200 may be disposed to be spaced apart from the rear fan assembly 100 by a predetermined distance in the lateral direction.

According to the present embodiment, instead of including only the plurality of rear fan assemblies 100, the blower 100 and 200 may include the rear fan assembly 100 and the corner fan assembly 200 together.

As both the rear fan assembly 100 and the corner fan assembly 200 are applied to the blower 100 and 200, a total lateral length of the blower 100 and 200 may be reduced compared to a case where the blower 100 and 200 include only the plurality of rear fan assemblies 100.

For example, the lateral length of the blower 100 and 200 including one rear fan assembly 100 and one corner fan assembly 200 may be measured to be shorter than the lateral length of the blower 200 including a pair of rear fan assemblies 100 arranged in the lateral direction.

The corner fan assembly 200 may include only one of the fan modules included in the rear fan assembly 100, and may include the fan module erected in the vertical direction. Therefore, the lateral length of the corner fan assembly 200 is inevitably shorter than that of the rear fan assembly 100.

In consideration of this configuration, the blower 100 and 200 of the present embodiment including the corner fan assembly 200 may be provided in a significantly smaller size than that of the rear fan assembly 100 or the blower including only the rear fan assembly 100.

When the blower 100 or 200 of this type is applied to the cooking appliance, the size of the cooking appliance, especially the lateral length of the cooking appliance, may be reduced as the space occupied by the blower 100 or 200 is reduced.

Considering this point, when the size of the cooking appliance is small such that a plurality of rear fan assemblies 100 is not received inside the cooking appliance, the blower 100 and 200 of the present embodiment are very suitable for being applied to this cooking appliance.

In addition, in the corner fan assembly 200, the second suction hole 212 may be disposed in the lower surface of the fan housing 210. Accordingly, the second suction hole 212 may be disposed at the lowermost end of the corner fan assembly 200, and may be disposed at a position very adjacent to the air intake hole 1 provided at the lower end of the cooking appliance.

Considering that the suction performance of the fan assembly based on the output of the fan motor may be greatly improved as the distance between the second suction hole 212 and the air intake hole 1 is smaller, it may be identified that the suction performance of the corner fan assembly 200 may be significantly improved as the second suction hole 212 of the corner fan assembly 200 is closer to the air intake hole 1.

That is, the performance of the corner fan assembly 200 may be lower than that of the rear fan assembly 100, but this performance difference may be mostly offset by the performance improvement value obtained due to the reduction of the distance between the second suction hole 212 and the air intake hole 1.

In consideration of this fact, it may be evaluated that the blower 100 and 200 of the present embodiment may provide an effect of contributing to miniaturization of the cooking appliance while providing a cooking gas removal performance of an equal level or higher than that of another type of blower.

The cooking appliance of the present embodiment including the blower 100 and 200 may provide the improved cooking gas removal performance while maintaining a compact size.

Further, referring to FIGS. 5 to 7, the rear fan assembly 100 and the corner fan assembly 200 may be positioned so as to overlap the cavity 11 in the front-rear direction. That is, the rear fan assembly 100 and the corner fan assembly 200 may be disposed between the upper surface and the lower surface of the cavity 11 in the vertical direction.

In order for the air introduced into the main body 10 through the air intake hole 1 to smoothly flow toward the rear fan assembly 100 or the corner fan assembly 200, a certain distance should be secured between the rear fan assembly 100 and the corner fan assembly 200 and the air intake hole 1.

In addition, in order for the air discharged from the rear fan assembly 100 and the corner fan assembly 200 to smoothly flow toward the upper space 10i, the rear fan assembly 100 and the corner fan assembly 200 are disposed at a lower vertical level than a vertical level of the upper space 10i.

When the rear fan assembly 100 and the corner fan assembly 200 are disposed at a position higher than a position of the upper space 10i, a problem in which a passage between the first discharge hole 114 of the rear fan assembly 100 or the second discharge hole 214 of the corner fan assembly 200 and the upper space 10i is too narrow may occur.

In consideration of this situation, in the present embodiment, the rear fan assembly 100 and the corner fan assembly 200 are disposed at positions such that the rear fan assembly 100 and the corner fan assembly 200 may be properly spaced apart from the air intake hole 1, and the rear fan assembly 100 and the corner fan assembly 200 may be properly spaced apart from the upper space 10i.

Accordingly, the flow of air from the air intake hole 1 to the rear fan assembly 100 and the corner fan assembly 200 and the flow of air from the rear fan assembly 100 and the corner fan assembly 200 to the upper space 10i may be smoothly performed.

In addition, the corner fan assembly 200 may be disposed at a position closer to the air intake hole 1 than to the exhaust hole 2, 3, and 4. Accordingly, the second suction hole 212 of the corner fan assembly 200 may be disposed at a position very adjacent to the air intake hole 1. As a result, the suction performance of the corner fan assembly 200 having a relatively small size and a low output compared to the rear fan assembly 100 may be effectively improved.

### One Example of Flow Path Defining Member

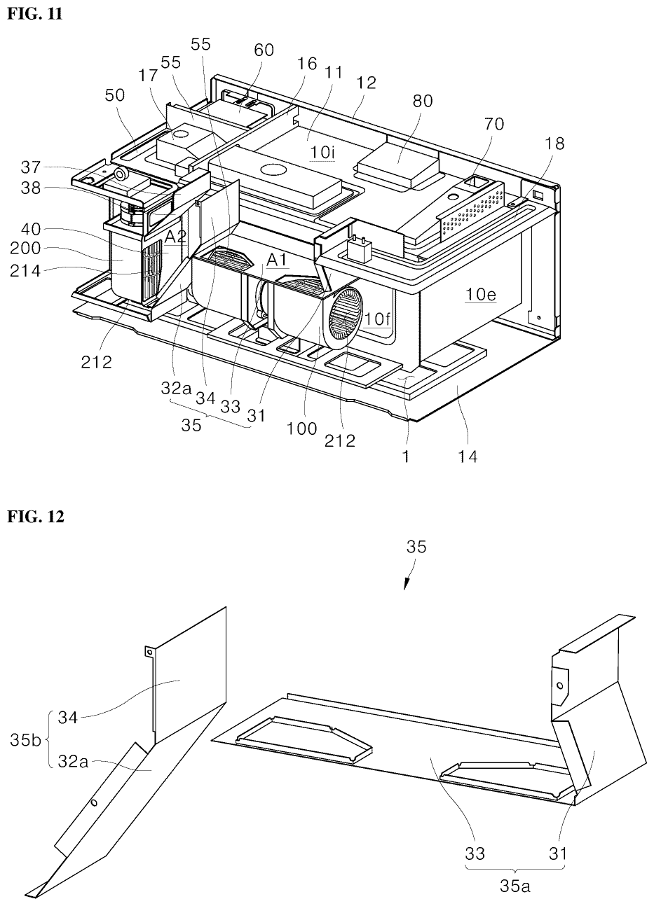

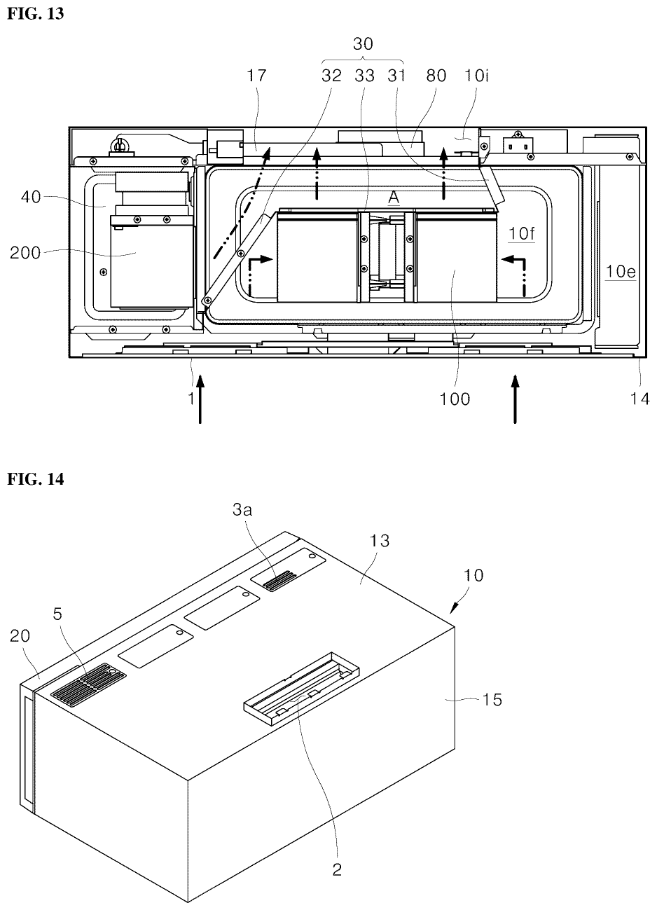

FIG. 10 is a rear perspective view illustrating a flow path defining member separated from the cooking appliance as illustrated in FIG. 6. FIG. 11 is a rear perspective view illustrating a cooking appliance to which another example of the flow path defining member is applied. FIG. 12 is a rear perspective view illustrating the flow path defining member separated from the cooking appliance as illustrated in FIG. 11, and FIG. 13 is a rear view illustrating an air flow state in the cooking appliance according to a first embodiment of the present disclosure.

Referring to FIGS. 5 to 7 and 10, the cooking appliance may include a flow path defining member 30. The flow path defining member 30 is constructed to induce the flow of air discharged from the blower 100 and 200.

The flow path defining member 30 may define an exhaust flow path A inside the cooking appliance. The exhaust flow path A may connect the blower 100 and 200 and the upper space 10i to each other, and may guide the flow of air from at least one of the rear fan assembly 100 and the corner fan assembly 200 to the upper space 10i. The exhaust flow path A may guide the flow of air discharged from the blower 100 and 200 toward the exhaust hole 2, 3, and 4.

In one example, the exhaust flow path A may be disposed in the rear space 10f. An inlet of the exhaust flow path A may be opened toward the blower 100 and 200. For example, the inlet of the exhaust flow path A may be opened toward the first discharge hole 114 of the rear fan assembly 100 and the second suction hole 214 of the corner fan assembly 200. An outlet of the exhaust flow path A may be opened toward the upper space 10i.

The exhaust flow path A may be formed inside the cooking appliance and may constitute a flow path for guiding the air flow from the first discharge hole 114 of the rear fan assembly 100 to the upper space 10i. In addition, the exhaust flow path A may be formed inside the cooking appliance and may constitute a flow path for guiding the air flow from the second suction hole 214 of the corner fan assembly 200 to the upper space 10i.

In one example, at least a portion of the exhaust flow path A may be defined by a first flow path plate 31. The first flow path plate 31 may constitute a wall that blocks the first suction hole 112 from the first discharge hole 114 of the rear fan assembly 100.

The first flow path plate 31 may be disposed in the rear space 10f, and may be disposed above the rear fan assembly 100. That is, the first flow path plate 31 may constitute a wall blocking the first suction hole 112 from the first discharge hole 114 such that the wall is positioned above the rear fan assembly 100.

According to the present embodiment, the rear fan assembly 100 and the corner space 10g and 10h may be laterally arranged and be disposed in the rear space 10f. In the rear space 10f, the first suction holes 112 may be respectively disposed on both lateral sides of the rear fan assembly 100. The first discharge hole 114 may be disposed between the pair of first suction holes 112 disposed to be spaced apart from each other by a predetermined spacing in the lateral direction, and may be defined in the upper surface of the rear fan assembly 100.

When one of the pair of first suction holes 112 which is disposed closer to the corner space 10g and 10h is referred to as a left first suction hole 112, the first flow path plate 31 is constructed to constitute a wall that blocks the first discharge hole 114 from the right first suction hole 112. The first flow path plate 31 may be disposed at a position closer to the right first suction hole 112 around a lateral center of the rear fan assembly 100, that is, a position adjacent to the right first suction hole 112.

Hereinafter, a direction toward the electronic/electrical component chamber 10a, 10c, and 10d along the lateral direction around the lateral center of the cooking appliance will be referred to as a left direction, and a direction toward the side space 10e located at the opposite side thereto will be referred to as a right direction.

The first flow path plate 31 may constitute a vertical wall extending upwardly from the upper surface of the rear fan assembly 100 in which the first discharge hole 114 is formed toward the upper space 10i. The first flow path plate 31 may define a right boundary surface of the exhaust flow path A.

The cooking appliance of the present embodiment may further include an extension plate 18. The extension plate 18 may be disposed to block the upper space 10i from the rear space 10f.

At least a portion of the extension plate 18 may be disposed in the rear space 10f. At least a portion 18b (hereinafter, referred to as a “rear partition portion”) of the extension plate 18 disposed at the rear space may be disposed between the rear fan assembly 100 and the upper space 10i in the vertical direction. In addition, the rear partition portion 18b of the extension plate 18 may be disposed between the rear surface of the cavity 11 and the rear plate 15 in the front-rear direction.

The rear partition portion 18b of the extension plate 18 disposed as described above covers a portion of the rear space 10f while being disposed at a position higher than a position of the rear fan assembly 100 and blocks the portion of the rear space 10f from the upper space 10i.

In the present embodiment, it is illustrated that the right area of the rear space 10f and the upper space 10i is blocked from each other via the extension plate 18.

The extension plate 18 and the rear fan assembly 100 are vertically spaced apart from each other, and accordingly, a lateral passage is defined between the extension plate 18 and the rear fan assembly 100. The thus formed lateral passage may connect the right area covered with the extension plate 18 of the rear space 10f and an area above the rear fan assembly 100 in which the exhaust flow path A is defined to each other.

The first flow path plate 31 may constitute a vertical wall extending upwardly toward the extension plate 18 from the rear fan assembly 100. In one example, the first flow path plate 31 may constitute a vertical wall connecting the upper surface of the rear fan assembly 100 to a side end of the extension plate 18. At least a portion of the first flow path plate 31 may protrude upwardly beyond the extension plate 18.

The first flow path plate 31 connected to the extension plate 18 as described above may constitute a vertical wall that blocks a lateral passage defined between the rear fan assembly 100 and the extension plate 18. That is, the first flow path plate 31 may constitute a wall blocking air flow between the right area of the rear space 10f and the exhaust flow path A such that the wall is positioned in the rear space 10f.

The flow path defining member 30 may further include a second flow path plate 32. The second flow path plate 32 may constitute a wall that blocks the first suction hole 112 and the first discharge hole 114 of the rear fan assembly 100 from each other.

The second flow path plate 32 may be disposed on the left side of the rear fan assembly 100. Accordingly, the rear fan assembly 100 may be disposed between the first flow path plate 31 and the second flow path plate 32 in the lateral direction.

In the lateral direction, the second flow path plate 32 may be disposed between the rear fan assembly 100 and the corner fan assembly 200. The second flow path plate 32 may constitute a wall blocking the first suction hole 112 and the first discharge hole 114 from each other, and simultaneously constitute a wall blocking the second suction hole 214 of the corner fan assembly 200 and the first suction hole 112 of the rear fan assembly 100 from each other.

In the corner fan assembly 200, the second suction hole 212 is disposed so as to face toward the air intake hole 1, that is, downwardly. The second suction hole 214 may be disposed so as to face toward the rear fan assembly 100, that is, laterally, more specifically, toward the right side, and may be connected to the exhaust flow path A.

The second flow path plate 32 may be disposed on the right side of the second suction hole 214 so as to define a lower boundary surface of the exhaust flow path A. The second flow path plate 32 may define a lower boundary surface of the exhaust flow path A while being disposed between the rear fan assembly 100 and the corner fan assembly 200. In this regard, the lower boundary surface of the exhaust flow path A defined by the second flow path plate 32 may be formed as an inclined surface in which a vertical level is changed along the lateral direction.

According to the present embodiment, the second suction hole 214 may be disposed to face toward the first suction hole 112 disposed to face toward the corner fan assembly 200. A vertical level of the first discharge hole 114 may be higher than that of the first suction hole 112, and may be higher than that of the second suction hole 214.

In one example, the second flow path plate 32 may constitute an inclined surface extending laterally from a lower side of the second suction hole 214 toward an upper side of the first suction hole 112. For example, the second flow path plate 32 may extend from one end thereof in the lateral direction adjacent to the corner fan assembly 200 and extend inclinedly upwardly in the lateral direction toward the rear fan assembly 100.

One end in the lateral direction of the second flow path plate 32 may be disposed under the second suction hole 214. For example, a left end of the second flow path plate 32 may be disposed at a vertical level lower than a vertical level of the second suction hole 214.

In addition, the other end in the lateral direction of the second flow path plate 32 may be disposed above the first suction hole 112. For example, a vertical level of a right end of the second flow path plate 32 may be higher than that of the first suction hole 112.

The second flow path plate 32 may constitute an inclined wall that blocks the first suction hole 112 and the first discharge hole 114 from each other, and blocks the first suction hole 112 and the second suction hole 214 from each other. That is, the second flow path plate 32 may constitute an inclined wall while being disposed between the rear fan assembly 100 and the corner fan assembly 200, and this wall may not only block the first suction hole 112 and the first discharge hole 114 from each other, but also block the first suction hole 112 and the second suction hole 214 from each other.

Accordingly, between the rear fan assembly 100 and the corner fan assembly 200, the air discharged from the first discharge hole 114 does not flow into the first suction hole 112, and the air discharged through the second suction hole 214 does not flow into the first suction hole 112.

That is, the second flow path plate 32 may constitute a wall that blocks the flow of air from the first discharge hole 114 and the second suction hole 214 to the first suction hole 112 such that the wall is positioned between the rear fan assembly 100 and the corner fan assembly 200.

According to the present embodiment, the exhaust flow path A may be formed on the left side of the first flow path plate 31 and on the upper side of the second flow path plate 32. The air intake hole 1 may be disposed under the exhaust flow path A. In addition, in the vertical direction, the first suction hole 112 and the second suction hole 212 may be disposed between the air intake hole 1 and the exhaust flow path A, and the first discharge hole 114 and the second suction hole 214 may be disposed between the exhaust flow path A and the upper space 10i.

The first discharge hole 114 and the second suction hole 214 may be connected to the exhaust flow path A. The first discharge hole 114 may be disposed to face upwardly and connected to the exhaust flow path A. The second suction hole 214 may be disposed to face laterally and connected to the exhaust flow path A.

In addition, the second flow path plate 32 may define a flow path for guiding air to the first suction hole 112.

In one example, the second flow path plate 32 is disposed above the air intake hole 1, and may be disposed on the left side and above the first suction hole 112. The second flow path plate 32 may define left and upper boundary surfaces of a flow path connecting the air intake hole 1 and the first suction hole 112 to each other. Due to the second flow path plate 32 provided as described above, air may be effectively introduced into the first suction hole 112 from the left side of the rear fan assembly 100.

In one example, the flow path defining member 30 may further include a fastening plate 33. The fastening plate 33 may be installed at the rear fan assembly 100.

In one example, the fastening plate 33 may be constructed such that the first discharge hole 114 is open upwardly and may be coupled to the upper surface of the rear fan assembly 100. The fastening plate 33 may be disposed above the first suction hole 112. A vertical level of the fastening plate 33 may be higher than that of each of the second suction hole 212 and the second suction hole 214.

According to the present embodiment, the first flow path plate 31 may be provided in a form extending upwardly from the fastening plate 33. In addition, the second flow path plate 32 may be provided in a form extending downwardly from the fastening plate 33. That is, the upper end of the second flow path plate 32 may be connected to the fastening plate 33.

The first flow path plate 31 and the second flow path plate 32 connected to the fastening plate 33 may be coupled to the rear fan assembly 100 via the fastening plate 33.

In addition, the fastening plate 33 may be disposed between the first flow path plate 31 and the second flow path plate 32 so as to connect the first flow path plate 31 and the second flow path plate 32 to each other. In one example, the flow path defining member 30 may be provided in a form in which the first flow path plate 31, the second flow path plate 32, and the fastening plate 33 are integrally formed with each other.

In the flow path defining member 30 provided in this manner, the first flow path plate 31 and the second flow path plate 32 do not need to be separately coupled to the rear fan assembly 100, respectively, and the first flow path plate 31 and the second flow path plate 32 may be easily and quickly installed to the fastening plate 33 coupled to the rear fan assembly 100.

The fastening plate 33 may have a discharge hole (a reference numeral being omitted) defined therein. The first discharge hole 114 may be exposed to the upper side of the fastening plate 33, that is, the inside of the exhaust flow path A through this discharge hole.

In addition, the cooking appliance of the present embodiment may further include a support member 40. The support member 40 is constructed to support the corner fan assembly (200). At least a portion of the support member 40 may be disposed in the corner space 10g and 10h.

In one example, the support member 40 may include a lateral support 41. The lateral support 41 may be disposed on a lateral side of the corner fan assembly 200. The lateral support 41 may constitute a side surface of the support member 40, more specifically, a right side surface of the support member 40.

The lateral support 41 may constitute a vertical wall covering the corner fan assembly 200 while being disposed on the lateral side thereof. For example, the lateral support 41 may constitute a vertical plane orthogonal to a lateral axis. The lateral support 41 may constitute a wall that blocks the corner fan assembly 200 and the rear fan assembly 100 from each other in the rear space 10a.

The lateral support 41 may be disposed between the corner fan assembly 200 and the second flow path plate 32. The lateral support 41 may define a left boundary surface of the exhaust flow path A.

A discharge hole (a reference numeral being omitted) may be formed in the lateral support 41. The second suction hole 214 may be exposed to a right side of the lateral support 41, that is, the inside of the exhaust flow path A through this discharge hole.

In addition, the cooking appliance of the present embodiment may further include a connection flow path defining member 37 and 38. The connection flow path defining member 37 and 38 may be disposed above the corner fan assembly 200. The connection flow path defining member 37 and 38 may partition the rear space 10f such that a partial area around the support member 40 of the rear space 10f is separated as a connection flow path 39.

In one example, the connection flow path defining member 37 and 38 may include a first partition portion 37 and a second partition portion 38.

The first partition portion 37 may constitute a vertical wall disposed on the lateral side of the support member 40 so as to be spaced apart therefrom by a predetermined spacing. In one example, the first partition portion 37 may constitute the vertical wall disposed on the lateral side of the lateral support 41 so as to be spaced apart therefrom by a predetermined distance. In the lateral direction, the first partition portion 37 may be disposed between the corner fan assembly 200 and the rear fan assembly 100.

The second partition portion 38 may constitute a wall connecting the lateral support 41 and the first partition portion 37 to each other. In one example, the first partition portion 37 may be disposed on the right side of the lateral support 41 and at a position spaced apart from the lateral support 41 by a predetermined distance. The second partition portion 38 may constitute a wall connecting a lower end of the first partition portion 37 and the lateral support 41 to each other.

In one example, the second partition portion 38 may be disposed above the second flow path plate 32. A left end of the second partition portion 38 may be coupled to the lateral support 41. In addition, the left end of the second partition portion 38 may be spaced apart from a left end of the second flow path plate 32 in the vertical direction while the second suction hole 214 is interposed therebetween.

In one example, the second partition portion 38 may constitute an inclined surface parallel to the second flow path plate 32. The second partition 38 together with the lateral support 41 may define a left boundary surface of the exhaust flow path A, and may guide a flow of air discharged from the second suction hole 214 to the exhaust flow path A to a lateral center point of the exhaust flow path A.

The first partition portion 37 may extend upwardly from the second partition portion 38. Thus, the first partition portion 37 together with the lateral support 41 and the second partition portion 38 may define a left boundary surface of the exhaust flow path A. The first partition portion 37 may guide the flow of air flowing through the exhaust flow path A toward the upper space 10i.

When the operation of the blower 100 and 200 is started, as illustrated in FIGS. 8 to 10 and 13, a suctioning airflow for suctioning the air outside the cooking appliance into the cooking appliance may be generated. The suctioning airflow generated as described above acts on the external air to be suctioned through the air intake hole 1 disposed at the lower end of the cooking appliance. The external air around the air intake hole 1, that is, the cooking gas may be suctioned into the main body 10 through the air intake hole 1 under the suctioning airflow acting in this way.

The cooking gas suctioned into the main body 10 may be introduced into the rear space 10f among the spaces defined in the main body 10. The cooking gas introduced into the rear space 10f may be suctioned into the rear fan assembly 100 and the corner fan assembly 200 through the first suction holes 112 respectively disposed at both opposing sides of the rear fan assembly 100 and the suction hole disposed at the lower side of the corner fan assembly 200.

In this regard, air intake into the rear fan assembly 100 may be guided by at least a portion of the flow path defining member 30. Specifically, the intake of air to the first suction hole 112 disposed at the left side of the rear fan assembly 100 may be guided by the second flow path plate 32.

The air suctioned into the rear fan assembly 100 and the corner fan assembly 200 may be discharged through the first discharge hole 114 and the second suction hole 214, respectively. The flow of air discharged in this way may be guided by the exhaust flow path A.

The air discharged from the second discharge hole 214 of the corner fan assembly 200 may flow through the exhaust flow path A and then flow through the rear space 10i and to the upper space 10f. The exhaust flow path A may constitute an inclined flow path extending inclinedly right-upwardly from the second discharge hole 214 around the second discharge hole 214.

The right-upwardly inclined flow path formed as described above may reduce resistance to air flow in the exhaust flow path A and minimize flow loss inside the cooking appliance. The right-upwardly inclined flow path formed as described above may be formed by the second flow path plate 32 defining a lower boundary surface of the exhaust flow path A and the connection flow path defining member 37 and 38 defining a left boundary surface of the flow path, on the right side of the second suction hole 214.

In addition, the air discharged from the first discharge hole 114 of the rear fan assembly 100 may flow through the exhaust flow path A and through the rear space 10i and then toward the upper space 10f. In this regard, the exhaust flow path A may guide the air flow so that the air discharged through the first discharge hole 114 may flow toward the upper space 10i without spreading to the surrounding therearound.

### Another Example of Flow Path Defining Member

Referring to FIGS. 11 and 12, the flow path defining member 35 may further include an extension plate 34. The extension plate 34 may constitute a wall that blocks the first suction hole 112 and the first discharge hole 114 from each other.

Like the second flow path plate 32a, the extension plate 34 may be disposed on the left side of the rear fan assembly 100. The extension plate 34 may be disposed above the rear fan assembly 100, and the second flow path plate 32a may extend downwardly from the extension plate 34. In one example, the extension plate 34 may be disposed above the second flow path plate 32a, and may be provided in a form extending upwardly from the second flow path plate 32a.

In the lateral direction, the rear fan assembly 100 may be disposed between the extension plate 34 and the first flow path plate 31. In addition, the extension plate 34 may be disposed between the rear fan assembly 100 and the corner fan assembly 200 in the lateral direction. In addition, the extension plate 34 may be disposed between the lateral support 41 and the fastening plate 33, and between the connection flow path defining member 35 and the fastening plate 33 in the lateral direction.

The extension plate 34 disposed as described above may be disposed between the lateral support 41 and the first flow path plate 31, and between the connection flow path defining member 35 and the first flow path plate 31 in the exhaust flow path A. That is, the extension plate 34 may constitute a vertical wall between the left boundary surface and the right boundary surface of the exhaust flow path A.

The extension plate 34 may divide the exhaust flow path A into a first exhaust flow path A1 constituting the right side thereof and the second exhaust flow path A2 constituting the left side thereof. The extension plate 34 may define a left boundary surface of the first exhaust flow path A1, and may define a right boundary surface of the second exhaust flow path A2.

The first exhaust flow path A1 may constitute a passage connecting the first discharge hole 114 and the upper space 10i to each other such that the passage is defined in the rear space 10f. The second exhaust flow path A2 may constitute a passage connecting the second suction hole 214 and the upper space 10i to each other such that the passage may be formed in the rear space, and the passage is isolated from the first exhaust flow path A1.

In addition, the flow path defining member 35 may be divided into a first flow path defining member 35a and a second flow path defining member 35b. In one example, the first flow path defining member 35a may be provided in a form in which the first flow path plate 31 and the fastening plate 33 are connected to each other, and the second flow path defining member 35b may be provided in a form in which the second flow path defining member 35b and the extension plate 34 are connected to each other.

The first flow path defining member 35a may be installed inside the cooking appliance via coupling between the fan housing of the rear fan assembly 100 and the fastening plate 33. The second flow path defining member 35b may be installed inside the cooking appliance via coupling between the second flow path plate 32a and the lateral support 41.

The exhaust flow path A may be divided into the first exhaust flow path A1 and the second exhaust flow path A2 via the flow path defining member 35 as described above. Thus, the air discharged to the rear space 10f by the rear fan assembly 100 and the air discharged to the rear space 10f by the corner fan assembly 200 may flow toward the upper space 10i through separate flow paths, respectively.

The flow path defining member 35 may divide the exhaust flow path A into the first and second flow paths as described above, thereby suppressing the air discharged from the corner fan assembly 200 and the air discharged from the rear fan assembly 100 from being mixed with each other inside the exhaust flow path A.

### Structure of Air Intake and Discharge of Cooking Appliance

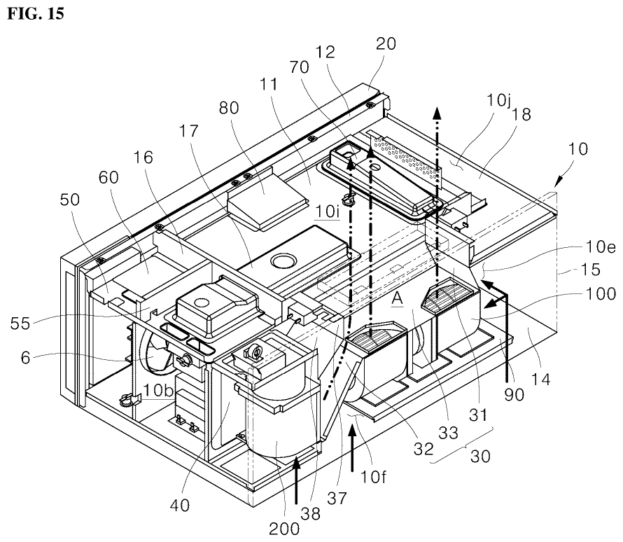

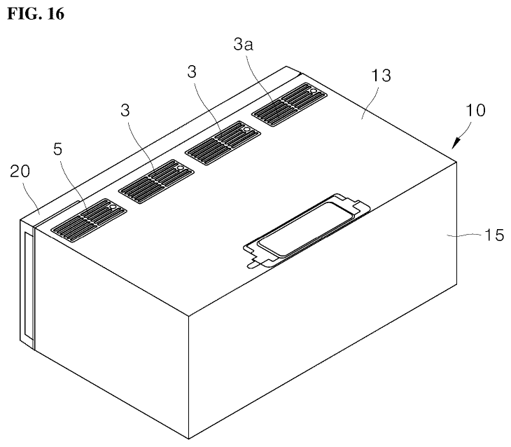

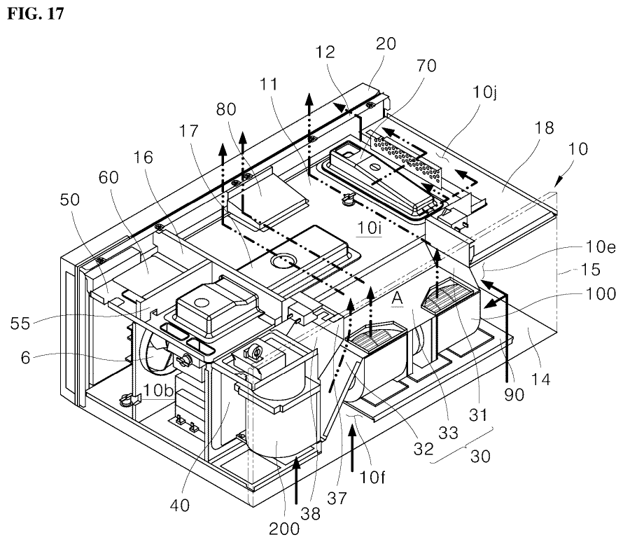

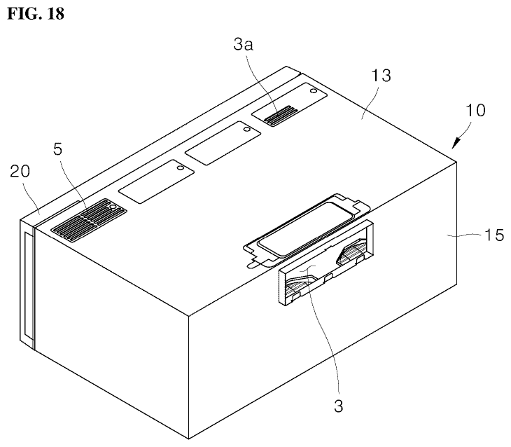

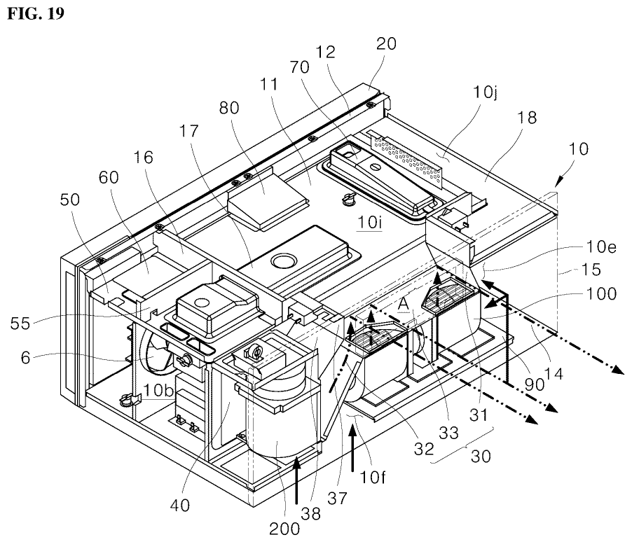

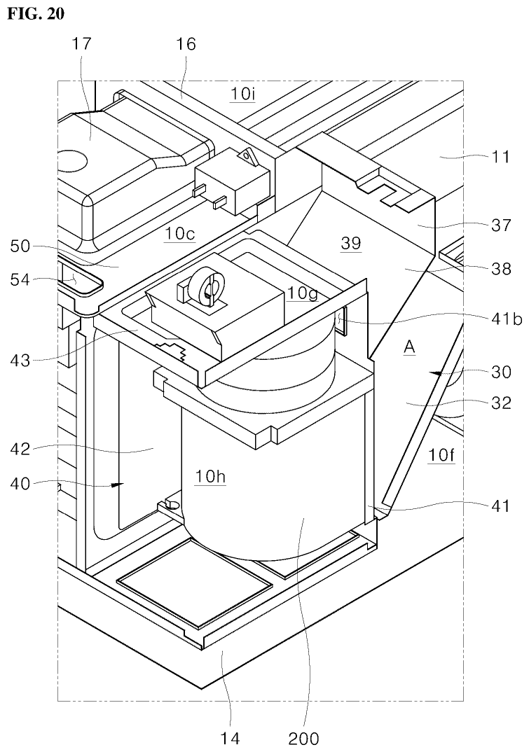

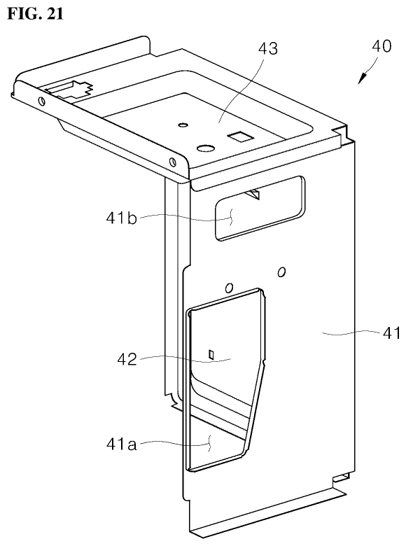

FIG. 14 is a rear perspective view illustrating a first state of the cooking appliance according to a first embodiment of the present disclosure, and FIG. 15 is a diagram illustrating an air flow state in the cooking appliance as illustrated in FIG. 14. FIG. 16 is a rear perspective view illustrating a second state of the cooking appliance according to the first embodiment of the present disclosure, and FIG. 17 is a diagram illustrating an air flow state in the cooking appliance as illustrated in FIG. 16. FIG. 18 is a rear perspective view illustrating a third state of the cooking appliance according to the first embodiment of the present disclosure, and FIG. 19 is a diagram illustrating an air flow state in the cooking appliance as illustrated in FIG. 18.

Hereinafter, a structure for suctioning and discharging the air in the cooking apparatus according to the present embodiment will be described with reference to FIGS. 13 to 19.

Referring to FIGS. 13 to 15, the air intake hole 1 may be provided at a lower end of the cooking appliance, and the exhaust hole may be provided at an upper end of the cooking appliance. The first exhaust hole 2 may be disposed in the upper surface of the cabinet 13 and may be disposed to be closer to the rear side of the cooking appliance, and the second exhaust hole 3 may be disposed in the upper surface of the cabinet 13 and may be disposed to be closer to the front side of the cooking appliance. In addition, the third exhaust hole 4 may be disposed in a rear end of the cooking appliance, and may be defined in the rear plate 15.

The blower 100 and 200 may include the rear fan assembly 100 and the corner fan assembly 200, and the rear fan assembly 100 may be disposed in the rear space 10f. The corner fan assembly 200 may be disposed in the rear space 10f or the corner space 10g and 10h.

When the operation of each of the rear fan assembly 100 and the corner fan assembly 200 starts, a suctioning airflow for suctioning air outside the cooking appliance into the cooking appliance may be generated. The suctioning airflow generated as described above acts on the external air through the air intake hole 1 disposed at the lower end of the cooking appliance. The external air around the air intake hole 1, that is, the cooking gas may flow through the air intake hole 1 and be suctioned into the main body 10 under the suctioning air flow acting in this way.

In addition, the cooking gas suctioned into the main body 10 may be introduced into the rear space 10f through the lower space. For example, the cooking gas introduced into the lower space may be introduced into the rear space 10f and the corner space 10g and 10h.

The cooking gas introduced into the rear space 10f may be suctioned into the rear fan assembly 100 through the first suction holes 112 disposed at both opposing sides of the rear fan assembly 100, respectively. The cooking gas suctioned into the rear fan assembly 100 may be discharged upwardly through the first discharge hole 114 disposed at the upper side of the rear fan assembly 100.

The cooking gas introduced into the corner space 10g and 10h may be suctioned into the corner fan assembly 200 through the second suction hole 212 disposed at the lower surface of the corner fan assembly 200. The cooking gas suctioned into the corner fan assembly 200 may be discharged laterally from the corner fan assembly 200 through the second discharge hole 214 disposed at the side surface of the corner fan assembly 200.

The rear space 10f may connect the air intake hole 1 disposed under the lower space to the upper space 10i. In addition, the exhaust flow path A may be formed in the rear space 10f. The flow of the cooking gas discharged from the rear fan assembly 100 and the corner fan assembly 200 may be guided toward the upper space 10i by the exhaust flow path A.

When only the first exhaust hole 2 of the exhaust holes 2, 3, and 4 is open and the second exhaust hole 3 and the third exhaust hole 4 of the exhaust holes 2, 3, and 4 are closed (hereinafter referred to as a “first state of the cooking appliance”), the cooking gas flowing upwardly through the exhaust flow path A may be discharged to the outside through the first exhaust hole 2.

In one example, the first exhaust hole 2 may be connected to a duct (not shown) connected to the outdoor area. For example, the duct may be installed on the upper surface of the main body 10, and an inner space of the duct may be connected to the first exhaust hole 2.

The first exhaust hole 2 connected to the duct as described above may constitute a passage connecting the upper space 10i to the outside out of the cooking appliance. The first exhaust hole 2 may be disposed above the upper space 10i, and may be disposed at a position overlapping the rear space 10f in the vertical direction.

That is, the rear fan assembly 100, the rear space 10f, and the first exhaust hole 2 may overlap each other in the vertical direction. Preferably, the rear fan assembly 100, the rear space 10f, and the first exhaust hole 2 may be aligned with each other in a line along the vertical direction.

In addition, the exhaust flow path A may be disposed between the blower 100 and 200 and the first exhaust hole 2 and in the rear space 10f. The inlet of the exhaust flow path A may be opened toward the blower 100 and 200, and the outlet of the exhaust flow path A may be opened toward the upper space 10i. In addition, the first exhaust hole 2 may be disposed in an area overlapping the outlet of the exhaust flow path A in the vertical direction.

Accordingly, the flow of air generated by the operation of the rear fan assembly 100 may have the same straight line direction as the alignment direction of the rear fan assembly 100, the rear space 10f, and the first exhaust hole 2.

As described above, when the air flows in the straight line direction, the resistance to the air flow is lowered so that the air flow may be performed more smoothly. Accordingly, air suction and discharge performance by the rear fan assembly 100 may be improved, and thus cooking gas removal performance of the cooking appliance may be improved accordingly.

In one example, the cooking appliance of the present embodiment may discharge the cooking gas suctioned into the cooking appliance into the indoor room, as illustrated in FIGS. 16 and 17. In this regard, the cooking appliance may be in a state in which only the second exhaust hole 3 of the exhaust holes 2, 3, and 4 is opened and the first exhaust hole 2 and the third exhaust hole 4 thereof are closed (hereinafter, referred to as a “second state of the cooking appliance”).

In the second state of the cooking appliance, a passage for discharging the cooking gas suctioned into the inside of the cooking appliance into the indoor room may be composed of the second exhaust hole 3. That is, the cooking gas introduced into the rear space 10f through the air intake hole 1 may flow through the upper space 10i and then be discharged to the indoor room through the second exhaust hole 3.

In one example, a filter (not shown) may be disposed at a bottom surface of the cooking appliance. The filter may be disposed in the air intake hole 1, and the cooking gas may flow through the air intake hole 1 while being filtered by the filter.

In another example, a filter may be disposed in the upper space 10i. For example, the filter may be disposed inside the main body 10, and may be disposed in the second exhaust hole 3. In this case, the cooking gas flowing from the rear space 10f to the upper space 10i may flow through the filter and be discharged to the indoor room through the second exhaust hole 3 in a state in which the air has been filtered by the filter.

The cooking appliance of the present embodiment as illustrated in FIGS. 18 and 19 may discharge the cooking gas suctioned into the cooking appliance to the outside through the third exhaust hole 4.

In this regard, the cooking appliance may be in a state in which only the third exhaust hole 4 among the exhaust holes 2, 3, and 4 is opened and the first exhaust hole 2 and the second exhaust hole 3 among the exhaust holes 2, 3, and 4 are closed (hereinafter, referred to as a “third state of the cooking appliance”).

In one example, the third exhaust hole 4 may be connected to a pipe or a duct (not shown) embedded in a wall surface on which the cooking appliance is installed. For example, the pipe or the duct may be coupled to the rear plate 15, and an inner space of the pipe or duct may be connected to the third exhaust hole 4.

The third exhaust hole 4 connected to the pipe or the duct is disposed at a position closest to the blower 100 and 200. Accordingly, in the third state of the cooking appliance, the distance between the air blower 100 and 200 and the exhaust hole 2, 3, and 4 may be the shortest. In addition, since the third exhaust hole 4 is defined in the rear surface of the cooking appliance facing the wall surface, the third exhaust hole 4 and the pipe or duct are not exposed to the outside.

That is, while the cooking appliance is in the third state, the cooking appliance may reduce the flow resistance inside the cooking appliance by reducing the air flow distance inside the cooking appliance, and may keep the outer appearance of the cooking appliance simple and clean.

As described above, the cooking appliance according to the present embodiment employing the structure in which the blower 100 and 200 is disposed in the rear space 10f allows the flow of the air involved in suctioning the cooking gas and discharging the cooking gas through the first exhaust hole 2 to be performed in the straight linear direction, thereby minimizing the flow loss in the cooking appliance and providing a more improved cooking gas removal performance.

In addition, in the cooking appliance according to the present embodiment, a filter installation space may be effectively secured in the upper space 10i, thereby maintaining a compact size and smoothly filtering and discharging the cooking gas to the indoor room.

In one example, the space inside the main body 10 may be divided into the side space 10e, the rear space 10f, and the upper space 10i as described above, and the blower 100 and 200 according to the present embodiment is disposed in the rear space 10f rather than the side space 10e or the upper space 10i.

In general, the lateral length of the side space 10e in which the electronic/electrical component chamber is not disposed is set to be shorter than the length in the front-rear direction of the rear space 10f. That is, the side space 10e may provide only a space narrower than the rear space 10f.

Various devices may be disposed in the rear space 10f according to the type of the cooking appliance. For example, in the cooking appliance providing a convection function, a convection module may be disposed in the rear space 10f.

On the other hand, it is very rare that the devices are disposed in the side space 10e that does not constitute the electronic/electrical component chamber 10b, 10c, and 10d. Therefore, the lateral width of the lateral space 10e does not need to be unnecessarily increased. When the lateral length of the side space 10e unnecessarily increases, only the overall size of the cooking appliance is increased regardless of whether the performance of the cooking appliance is improved or not.

In consideration of this fact, the side space 10e is formed to provide a space narrower than the rear space 10f.

In order to reduce the cost, it is common for cooking appliances of different types having the same cooking chamber volume to employ the main body 10 of the same size. For example, a cooking appliance that provides both a high-frequency function and a convection function may be manufactured using the main body 10 of the same size as that of the main body which a cooking appliance that provides only the high-frequency function employs.

Accordingly, the main body 10 of the present embodiment may include the rear space 10f providing a space suitable for receiving therein the convection module, and the side space 10e may be formed in a form providing only a space narrower than the rear space 10f.

In consideration of this fact, the blower 100 and 200 of the present embodiment may be disposed in the rear space 10f that provides a more sufficient space than the side space 10e. As described above, the blower 100 and 200 is disposed in the rear space 10f, such that the flow loss inside the cooking appliance as described above may be reduced, and a larger fan assembly having high performance may be applied to the blower 100 and 200.

That is, the cooking appliance of the present embodiment which includes the blower 100 and 200 disposed in the rear space 10f may provide improved cooking gas removal performance while suppressing an increase in the size of the cooking appliance using the main body 10 of the commonly used size.

### Support Member

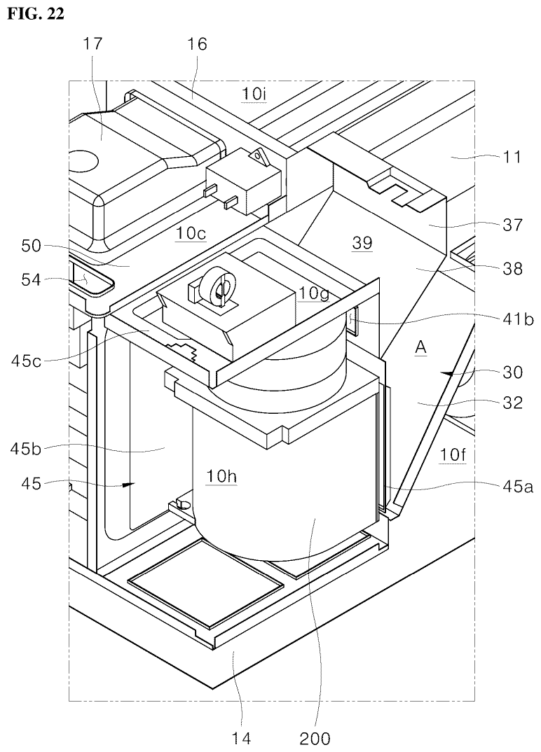

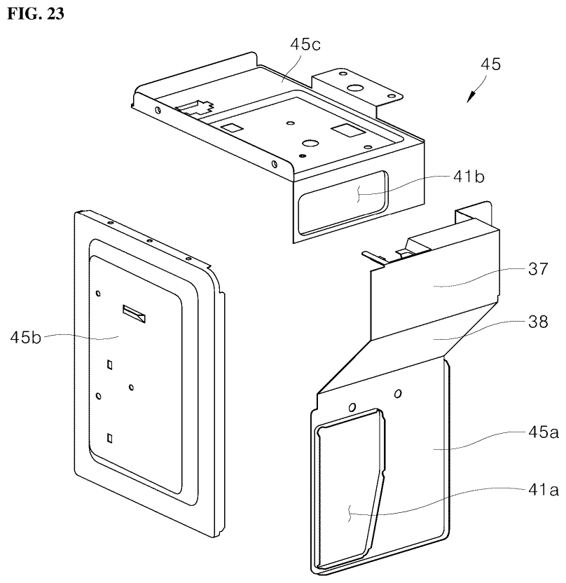

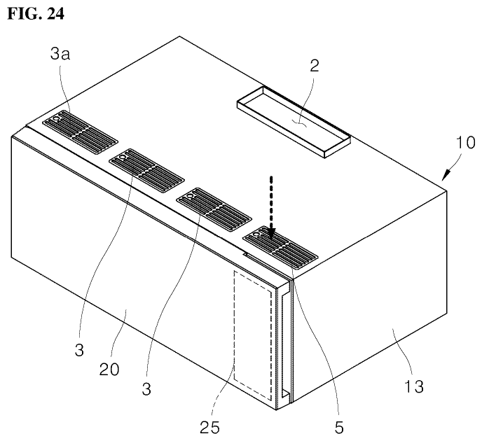

FIG. 20 is an enlarged view illustrating the corner fan assembly and the periphery thereof in an enlarged manner, and FIG. 21 is a rear perspective view illustrating the support member removed from the cooking appliance as illustrated in FIG. 20. FIG. 22 is a rear perspective view illustrating a portion of a cooking appliance to which another example of a support member is applied, and FIG. 23 is a rear perspective view illustrating the support member removed from the cooking appliance as illustrated in FIG. 22.

Referring to FIGS. 6, 20 and 21, the cooking appliance of the present embodiment may include the support member 40. The support member 40 may support the corner fan assembly 200 so that the flow of air discharged from the second suction hole 214 may be guided toward the rear space 10f.

At least a portion of the support member 40 may constitute a wall that blocks the side space 10e and the rear space 10f from each other. That is, at least a portion of the support member 40 may constitute a wall that blocks the corner fan assembly 200 and the rear fan assembly 100 from each other in the rear space 10f.

The support member 40 may constitute a wall dividing the rear space 10f into two areas arranged along the lateral direction. In one example, the support member 40 may divide a portion of the rear space 10f which is adjacent to the side space 10e into the corner spaces 10g and 10h. In addition, at least a portion of the support member 40 may constitute a wall covering the corner fan assembly 200 while being disposed on the side thereof. Such a wall may be composed of the lateral support 41.

The second suction hole 214 may be disposed at the side portion of the corner fan assembly 200 and may face toward the support member 40, more specifically, the lateral support 41. In addition, a discharge hole 41a may be formed in the lateral support 41. The discharge hole 41a may be constructed to expose the second suction hole 214 laterally, and may be formed to extend through the lateral support 41 laterally.

The lateral support 41 may be coupled to the corner fan assembly 200. That is, the corner fan assembly 200 may be laterally coupled to the lateral support 41 and may be supported by the support member 40.

The support member 40 may include a front support 42. The front support 42 may constitute a front surface of the support member 40 and may be disposed in front of the corner fan assembly 200.

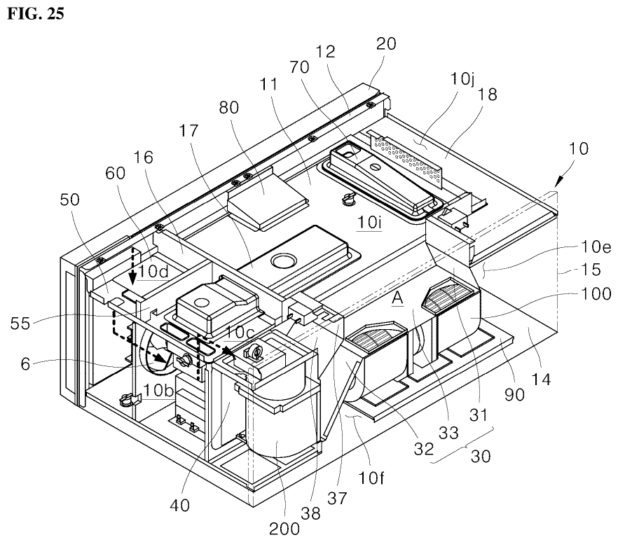

The front support 42 may constitute a vertical wall covering the corner fan assembly 200 while being disposed in front thereof. For example, the front support 42 may constitute a vertical plane orthogonal to the front-rear axis. The front support 42 may be disposed between a cooling fan 6 (see FIG. 25) which will be described later and the corner fan assembly 200, and may constitute a wall blocking the cooling fan 6 and the corner fan assembly 200 from each other such that the wall is positioned in the electronic/electrical component chamber 10b, 10c, and 10d.

The front support 42 may be connected to the lateral support 41 at the side of the lateral support 41. In one example, a right end of the front support 42 may be connected to a front end of the lateral support 41. For example, the front support 42 and the lateral support 41 may be coupled to each other to form a “L” shape.

The front support 42 connected to the lateral support 41 may support the lateral support 41 while being disposed in front thereof. The front support 42 may serve as a screening wall which blocks the cooling fan 6 and the corner fan assembly 200 from each other and as a support wall which supports the lateral support 41 supporting the corner fan assembly 200.

In addition, the front support 42 may include a support surface constituting a vertical plane for coupling with the electronic/electrical component. For example, electronic/electrical components such as a magnetron, a high-voltage transformer, a high-voltage condenser, a noise filter, etc. may be disposed in the electronic/electrical component chamber 10b, 10c, and 10d, and at least one of the electronic/electrical components may be installed on the support surface of the front support 42. In this embodiment, it is illustrated that the high-voltage condenser is installed on the support surface of the front support 42.

In addition, the support member 40 may further include an upper support 43. The upper support 43 may constitute an upper surface of the support member 40 and may be disposed above the corner fan assembly 200. In one example, the upper support 43 may be disposed in the corner space 10g and 10h.

The upper support 43 may be disposed above the lateral support 41 and the front support 42, and may be connected to at least one of the lateral support 41 and the front support 42 in the vertical direction. In the present embodiment, it is illustrated that the upper support 43 is connected to both the lateral support 41 and the front support 42.

In one example, a front end of the upper support 43 may be connected to an upper end of the front support 42, and a right end of the upper support 43 may be connected to an upper end of the lateral support 41. Due to the upper support 43, three directional surfaces of the support member 40 are connected to each other, and thus the structural stability of the support member 40 may be improved.

In addition, the upper support 43 may include a support surface for constituting a horizontal plane for coupling with the electronic/electrical component. In the present embodiment, it is illustrated that the noise filter connected to the corner fan assembly is installed on the support surface of the upper support 43.

The support member 40 including the lateral support 41, the front support 42 and the upper support 43 as described above may provide a screening wall that blocks the cooling fan 6 and the corner fan assembly 200 from each other, and may also provide a support wall for stable installation of the electronic/electrical components and the corner fan assembly 200.

In one example, the support member 40 may be provided in a form in which the lateral support 41, the front support 42, and the upper support 43 are integrally formed with each other. The support member 40 may facilitate the assembly and installation of the electronic/electrical components and the management of the components, and may have excellent structural stability.

In another example, as illustrated in FIGS. 22 and 23, the lateral support, the front support, and the upper support may be separately provided.

Accordingly, the support member 45 may include a first support plate 45a, a second support plate 45b, and a third support plate 45c. The first support plate 45a, the second support plate 45b, and the third support plate 45c may be provided separately.

For example, the first support plate 45a may constitute the lateral support, the second support plate 45b may constitute the front support, and the third support plate 45c may constitute the upper support. The first support plate 45a, the second support plate 45b, and the third support plate 45c provided as separate plates may be coupled to each other to form the support member 40.

In one example, the first support plate 45a may be provided in a form including both the lateral support and the connection flow path defining member 37 and 38. That is, in the first support plate 45a, the lateral support and the connection flow path defining member 37 and 38 may be integrally formed with each other.

In addition, a through-hole 41b may be defined in the first support plate 45a or may be defined in the third support plate 45c.

### Structure of Electronic/electrical Component Chamber

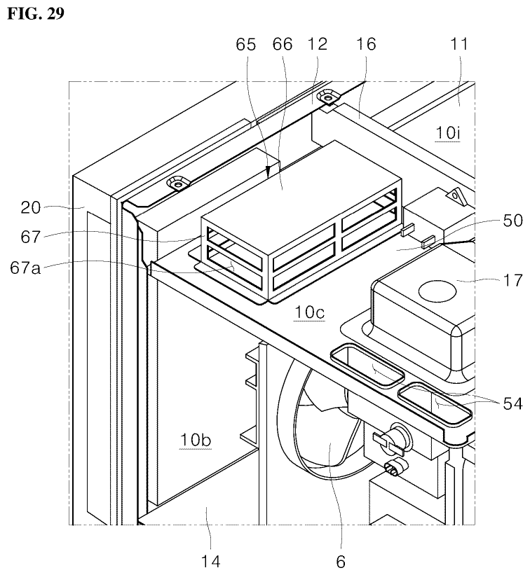

FIG. 24 is a diagram illustrating a state in which the external air is introduced into the electronic/electrical component chamber through a cold air inlet, FIGS. 25 to 27 are diagrams illustrating a flow state of the air introduced into the electronic/electrical component chamber, and FIG. 28 is a diagram illustrating a flow state of the air introduced from an upper corner space to a lower corner space through the connection flow path.

Referring to FIGS. 24 and 25, the main body 10 ma have a cold air inlet 5 defined therein. The cold air inlet 5 may be disposed in the upper surface of the main body 10 in which the first exhaust hole 2 and the second exhaust hole 3 are defined.

In one example, the cold air inlet 5 may be formed to extend through the upper surface of the cabinet 13 in the vertical direction. The cold air inlet 5 may be disposed above the electronic/electrical component chamber 10b, 10c, and 10d, and may open the electronic/electrical component chamber 10b, 10c, and 10d to the outside out of the main body 10. External air may be introduced into the electronic/electrical component chamber 10b, 10c, and 10d through the cold air inlet 5.

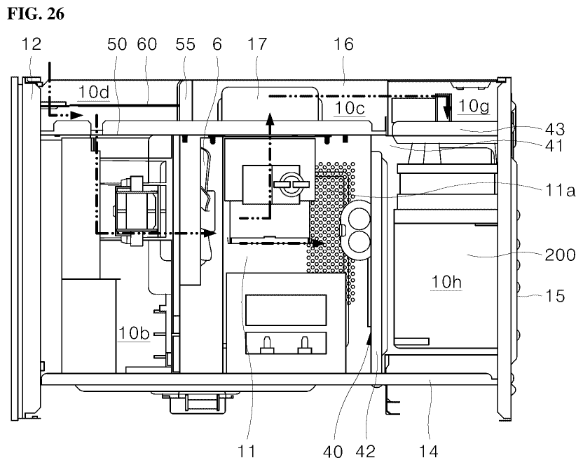

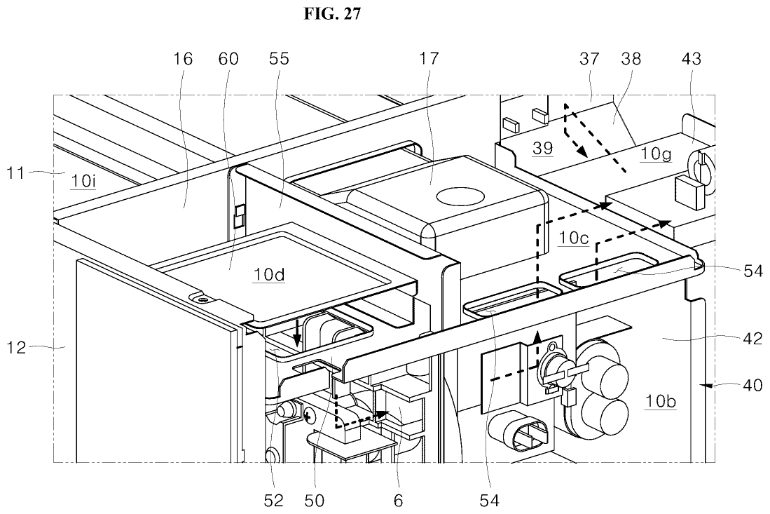

Referring to FIGS. 25 to 26, the cooking appliance of the present embodiment may include a partition plate 50. The partition plate 50 may be disposed in the side space 10e, more specifically, the electronic/electrical component chamber 10b, 10c, and 10d.

In one example, the partition plate 50 may constitute a horizontal plane orthogonal to the vertical axis. The partition plate 50 may vertically partition the side space 10e into the lower electronic/electrical component chamber 10b and the upper electronic/electrical component chamber 10c. For example, the electronic/electrical component chamber 10b, 10c, and 10d may be divided into the lower electronic/electrical component chamber 10b under the partition plate 50 and the upper electronic/electrical component chamber 10c above the partition plate 50.

In one example, in the electronic/electrical component chamber 10b, 10c, and 10d, the lower electronic/electrical component chamber 10b may occupy a much wider space than that of the upper electronic/electrical component chamber 10c. For example, a vertical length of the lower electronic/electrical component chamber 10b may be set to be much larger than a vertical length of the upper electronic/electrical component chamber 10c. Most of the electronic/electrical components including the magnetron, the high-voltage transformer, the high-voltage condenser, etc. may be mainly disposed in the lower electronic/electrical component chamber 10b.

The cooking appliance of the present embodiment may further include a cooling fan 6. The cooling fan 6 is configured to allow the external air to be introduced into the electronic/electrical component chamber 10b, 10c, and 10d through the cold air inlet 5. In one example, the cooling fan 6 together with most electronic/electrical components may be disposed in the lower electronic/electrical component chamber 10b.

The blower 100 and 200 may be disposed in rear of the cooling fan 6. The support member 40, more specifically, the front support 42 may be disposed between the cooling fan 6 and the corner fan assembly 200.

The cooling fan 6 may generate an airflow for introducing the external air into the main body 10 through the cold air inlet 5.

When the cooling fan 6 operates, the external air may be introduced into the upper electronic/electrical component chamber 10c through the cold air inlet 5. The air introduced into the upper electronic/electrical component chamber 10c may flow through the partition plate 50 and be introduced into the lower electronic/electrical component chamber 10b.

To this end, the partition plate 50 may have a through-hole 52 and 54 defined therein. The through-hole 52 and 54 may constitute a passage connecting the upper electronic/electrical component chamber 10a and the lower electronic/electrical component chamber 10b to each other such that the passage is defined in the partition plate 50. In one example, the through-hole 52 and 54 may be formed to extend through the partition plate 50 in the vertical direction.

The air introduced into the upper electronic/electrical component chamber 10c through the cold air inlet 5 may be introduced into the lower electronic/electrical component chamber 10b through the through-hole 52 and 54. The air introduced into the electronic/electrical component chamber 10b, 10c, and 10d may cool the electronic/electrical components disposed in the lower electronic/electrical component chamber 10b.

In addition, a portion of the air introduced into the lower electronic/electrical component chamber 10b may be introduced into the cooking chamber 10a (see FIG. 2). To this end, the cavity 11 may have a side hole 11a. The side hole 11a may constitute a passage connecting at least one of the lower electronic/electrical component chamber 10a and the upper electronic/electrical component chamber 10c to the cooking chamber 10a.

In this embodiment, it is illustrated that the side hole 11a is disposed in the lower electrical equipment chamber 10b. In one example, the side hole 11a is formed to extend through the cavity 11 in a lateral direction, such that a passage connecting the lower electronic/electrical component chamber 10b and the cooking chamber 10a to each other may be formed in the cavity 11. The side hole 11a may be disposed in front of the support member 40.

The cooking appliance of this embodiment may further include a blocking plate 55. The blocking plate 55 may divide the upper electronic/electrical component chamber 10c in the front-rear direction such that a front area of the upper electronic/electrical component chamber 10d is separated as an air intake chamber 10d.

In one example, the blocking plate 55 may constitute a vertical wall surface orthogonal to the front-rear axis. The blocking plate 55 may be disposed above the partition plate 50, and may be coupled to an upper surface of the partition plate 50.

Due to the blocking plate 55 provided as described above, an area between the front plate 12 and the blocking plate 55 of the upper electronic/electrical component chamber 10c may be separated as the air intake chamber 10d.

A plurality of through-holes 52 and 54 may be defined in the partition plate 50. In one example, the partition plate 50 may have a first through-hole 52 and a second through-hole 54. The first through-hole 52 and the second through-hole 54 may be spaced apart from each other in the front-rear direction while the blocking plate 55 is interposed therebetween.

The first through-hole 52 may constitute a passage connecting the air intake chamber 10a and the lower electronic/electrical component chamber 10b to each other. The first through-hole 52 may be disposed in front of the blocking plate 55 and the cooling fan 6, and may be formed to extend through the partition plate 50 in the vertical direction.

The second through-hole 54 may constitute a passage connecting the upper electronic/electrical component chamber 10c and the lower electronic/electrical component chamber 10b to each other while being disposed in rear of the air intake chamber 10a. The second through-hole 54 may be disposed in rear of the blocking plate 55 and the cooling fan 6, and may be formed to extend through the partition plate 50 in the vertical direction.

According to the present embodiment, the upper support 43 may be disposed in rear of the partition plate 50. The upper support 43 may be disposed in the corner space 10g and 10h, and may partition the corner space 10g and 10h in a vertical direction into upper and lower corner spaces. The corner space 10g and 10h may be divided into an upper corner space 10g and a lower corner space 10h via the upper support 43.

The lower corner space 10h may be disposed under the upper support 43. The upper boundary surface of the lower corner space 10h may be defined by the upper support 43, the front boundary surface of the lower corner space 10h may be defined by the front support 42, and the right boundary surface of the lower corner space 10h may be defined by the lateral support 41. The corner fan assembly 200 may be disposed in the lower corner space 10h.

The upper corner space 10g may be disposed above the upper support 43. The upper corner space 10g may be disposed in rear of the upper electronic/electrical component chamber 10c, and may communicate with the upper electronic/electrical component chamber 10c while being positioned in rear of the upper electronic/electrical component chamber 10c.

At least one of the electronic/electrical components disposed in the upper electronic/electrical component chamber 10c may be disposed in the upper support 43. In one example, the noise filter connected to the corner fan assembly 200 may be disposed in the upper corner space 10g, and the noise filter may be installed on the upper surface of the upper support 43.

The air introduced into the lower electronic/electrical component chamber 10b by the cooling fan 6 may flow into the upper electronic/electrical component chamber 10c through the second through-hole 54. As such, the air introduced into the upper electronic/electrical component chamber 10c may cool the electronic/electrical component installed in the upper support 43 while flowing through the upper corner space 10g.

In one example, the upper electronic/electrical component chamber 10c and the lower electronic/electrical component chamber 10b may be connected to each other via the connection flow path 39. The connection flow path 39 may constitute a passage through which air introduced into the lower electronic/electrical component chamber 10b by the cooling fan 6 flows toward the blower 100 and 200 through the upper electronic/electrical component chamber 10c. For example, the connection flow path 39 may constitute a path through which air introduced into the electronic/electrical component chamber 10b, 10c, and 10d may be introduced into the corner fan assembly 200 through the upper corner space 10g.

In addition, the through-hole 41b may be defined in the lateral support 41. The through-hole 41b is constructed to laterally open the space surrounded with the lateral support 41 and the front support 42, that is, the lower corner space 10h.

The connection flow path 39 may constitute a passage that connects the through-hole 41b and the upper electronic/electrical component chamber 10c to each other, and more specifically, connects the through-hole 41b and the upper corner space 10g to each other. The connection flow path 39 may communicate with the upper corner space 10g and the lower corner space 10h while being disposed on the lateral side of the corner space 10g and 10h. The connection flow path 39 and the lower corner space 10h may communicate with each other through the through-hole 41b.

As described above, the connection flow path 39 may be defined by the connection flow path defining member 37 and 38. In the connection flow path defining member 37 and 38, the first partition portion 37 may constitute a vertical wall disposed on the lateral side of the lateral support 41 so as to be spaced apart therefrom by a predetermined spacing. The second partition portion 38 may be connected to the lateral support 41 while being disposed under the through-hole 41b and constitute a wall connecting the lateral support 41 and the first partition portion 37 to each other.

Both opposing side surfaces of the connection flow path 39 may be defined by the lateral support 41 and the first partition portion 37. For example, the left side surface of the connection flow path 39 may be defined by the lateral support 41, and the right side surface of the connection flow path 39 may be defined by the first partition portion 37. The bottom surface of the connection flow path 39 may be defined by the second partition portion 38.

The air introduced into the upper electronic/electrical component chamber 10c may flow through the upper corner space 10g and be introduced into the connection flow path 39. The air introduced into the connection flow path 39 may be introduced into the lower corner space 10h through the through-hole 41b, and then be suctioned into the corner fan assembly 200.

A suctioning force of the corner fan assembly 200 may act on the lower corner space 10h. As described above, the suctioning force acting on the lower corner space 10h may also affect the connection flow path 39 connected to the lower corner space 10h and the upper corner space 10g. That is, the suctioning force of the corner fan assembly 200 may affect the upper corner space 10g, which may act as a force for flowing the air flowing into the upper corner space 10g toward the lower corner space 10h.

Ultimately, the suctioning force of the corner fan assembly 200 may act as a force to guide the flow of air introduced into the upper electronic/electrical component chamber 10c from the lower electronic/electrical component chamber 10b to the lower corner space 10h through the connection flow path 39.

Hereinafter, the air flow in the electronic/electrical component chamber 10b, 10c, and 10d will be described.

As illustrated in FIG. 24, the external air may be introduced into the main body 10 through the cold air inlet 5. The air having flowed through the cold air inlet 5 may be introduced into the air intake chamber 10d, as illustrated in FIGS. 25 to 27.

The air introduced into the air intake chamber 10d may flow through the partition plate 50 through the first through-hole 52 and may flow into the lower electronic/electrical component chamber 10b. In the lower electronic/electrical component chamber 10b, air may flow in a rearward direction by the cooling fan 6. As described above, the air flowing rearwards in the lower electronic/electrical component chamber 10b may cool the electronic/electrical components disposed in the lower electronic/electrical component chamber 10b.

A portion of the air flowing in the lower electronic/electrical component chamber 10b may flow through the cavity 11 through the air intake hole 1 and be introduced into the electronic/electrical component chamber. The other portion of the air flowing in the lower electronic/electrical component chamber 10b may flow through the partition plate 50 through the second through-hole 54 and flow to the upper electronic/electrical component chamber 10c.

In the upper electronic/electrical component chamber 10c, the air may flow toward the connection flow path 39 under the influence of the suctioning force of the corner fan assembly 200. For example, the air introduced into the upper electronic/electrical component chamber 10c may cool the electronic/electrical component while flowing through the upper corner space 10g, and then flow into the connection flow path 39, as illustrated in FIG. 28.

The air having flowed to the connection flow path 39 may flow through the through-hole 41b defined in the lateral support 41 and flow into the lower corner space 10h and then be suctioned into the corner fan assembly 200. That is, the air introduced into the lower corner space 10h from the connection flow path 39 may be combined with the air introduced into the main body 10 through the air intake hole 1, and then the combined air may be suctioned into the corner fan assembly 200, and then be discharged to the exhaust flow path A, as illustrated in FIG. 13.

As illustrated in FIGS. 24 to 28, the flow path formed in the electronic/electrical component chamber 10b, 10c, and 10d, the corner space 10g and 10h, and the connection flow path 39 allows the force provided by the suctioning force of the corner fan assembly 200 to be added to the force provided by the cooling fan 6 in the electronic/electrical component chamber 10b, 10c, and 10d, thereby allowing air to more smoothly flow inside the electronic/electrical component chamber 10b, 10c, and 10d and thus allowing the electronic/electrical components disposed in the electronic/electrical component chamber 10b, 10c, and 10d to be more effectively cooled.

In addition, the flow path formed in the electronic/electrical component chamber 10b, 10c, and 10d, the corner space 10g and 10h, and the connection flow path 39 as described above may allow the air introduced into the electronic/electrical component chamber 10b, 10c, and 10d to flow toward the corner fan assembly 200, thereby increasing the air suctioning amount of the corner fan assembly 200 and ultimately contributing to effectively increasing the discharge air amount of the corner fan assembly 200.

In one example, referring to FIGS. 25 to 27, the cooking appliance of the present embodiment may further include a flow path partitioning plate 16. The flow path partitioning plate 16 is constructed to partition a space above the cavity 11 and the partitioning plate 50. The flow path partitioning plate 16 may partition the space above the cavity 11 and the partition plate 50 into the upper electronic/electrical component chamber 10c and the upper space 10i.

In one example, the flow path partitioning plate 16 may constitute a vertical wall orthogonal to the lateral axis. The flow path partitioning plate 16 may block the upper electronic/electrical component chamber 10c and the upper space 10i from each other, and may isolate these two spaces from each other. For example, the flow path partitioning plate 16 may define a right boundary surface of the upper electronic/electrical component chamber 10c, and a left boundary surface of the upper space 10i.

In addition, the cooking appliance of the present embodiment may include a waveguide 17. The waveguide 17 is constructed to transmit microwaves generated from the magnetron installed in the electronic/electrical component chamber 10b, 10c, and 10d to the cooking chamber 10a.

The waveguide 17 may be disposed in the upper electronic/electrical component chamber 10c and the upper space 10i, and may be installed on the upper surface of each of the partition plate 50 and the cavity 11. That is, a portion of the waveguide 17 may be installed on the upper surface of the partition plate 50, and the remaining portion of the waveguide 17 may extend through the flow path partitioning plate 16 in the lateral direction and be installed on the upper surface of the cavity 11.

A space is formed inside the waveguide 17, and an inlet of the waveguide 17 connected to the space may be connected to the magnetron, and an outlet of the waveguide 17 connected to the space may be connected to the cooking chamber 10a. The microwaves introduced into the waveguide 17 through the inlet of the waveguide 17 may be introduced into the cooking chamber 10a through the outlet of the waveguide 17.

The outlet of the waveguide 17 may be connected to the cooking chamber 10a while being defined at the upper surface of the cavity 11. Accordingly, the microwave transmitted from the magnetron through the waveguide 17 may flow through the upper surface of the cavity 11 defining the cooking chamber 10a and be introduced into the cooking chamber 10a. In one example, the outlet of the waveguide 17 may be defined in the upper surface of the cavity 11, and may be disposed approximately at a lateral center of the cavity 11.

When the vertical length of the cooking appliance is shortened, the vertical length of the cooking chamber 10a is highly likely to be shortened. Even though the air blower 100 and 200 is disposed in the rear space 10f instead of the upper space 10i, and thus the vertical length of the upper space 10i can be reduced accordingly, the reduction in the length of the upper space 10i is inevitably smaller than the reduction in the total length of the cooking appliance. Thus, it is difficult to avoid the reduction in the length of the cooking chamber 10a due to the reduction in the length of the cooking appliance.

In this case, the shape of the cooking chamber 10a has a flat shape elongate in the horizontal direction compared to a cooking chamber of a typical cooking appliance. In the cooking appliance having the cooking chamber 10a having this shape, when the microwaves are introduced into the cooking chamber 10a through the side surface of the cavity 11, it is difficult to evenly supply the microwaves to the entire cooking chamber 10a.

In consideration of this situation, in the present embodiment, the waveguide 17 is installed on the upper surface of the cavity 11, and the microwaves may be introduced into the cooking chamber 10a through the upper surface of the cavity 11. That is, in the cooking appliance of the present embodiment, the microwave may be supplied through the upper surface of the cooking chamber 10a, and accordingly, the microwaves may be evenly supplied to the entire cooking chamber 10a.

### One Example of Screening Member

Referring to FIGS. 25 to 27, the cooking appliance of the present embodiment may include the screening member 60. The screening member 60 is constructed to screen the through-hole 52 and 54 formed in the partition plate 50, more specifically, the first through-hole 52 while being disposed on top thereof or thereunder. The screening member 60 may be disposed to be spaced apart from the partition plate 50 or the first through-hole 52 by a predetermined distance in the vertical direction.

In the present embodiment, the screening member 60 is illustrated as being disposed above the partition plate 50 and the first through-hole 52. The screening member 60 may be disposed between the upper surface of the cabinet 13 and the partition plate 50. In one example, the screening member 60 may be disposed in the upper electronic/electrical component chamber 10c, more specifically in the air intake chamber 10d.

In the vertical direction, the screening member 60 may be disposed between the first through-hole 52 and the cold air inlet 5. The screening member 60 may be constructed such that one of the first through-hole 52 and the cold air inlet 5 is entirely screened with the screening member 60 in a top view of the main body 10.

In one example, the screening member 60 may be constructed such that the first through-hole 52 is entirely screened with the screening member 60. For example, the screening member 60 may constitute a horizontal wall that entirely screens the first through-hole 52 while being positioned on top thereof.

The screening member 60 may be installed on the blocking plate 55. The screening member 60 may be installed on the blocking plate 55 so as to be coupled to a front surface of the blocking plate 55, and to protrude in the frontward direction from the blocking plate 55. In this regard, the screening member 60 may be coupled to the blocking plate 55 and at a position spaced apart upwardly from the upper surface of the partition plate 50 by a predetermined distance.

Due to the screening member 60, the first through-hole 52 is entirely screened such that the viewer above the cooking appliance cannot view the first through-hole 52, while the air flow through the first through-hole 52 may be smoothly performed. That is, the screening member 60 screens the first through-hole 52 so that the first through-hole 52 is not visible to a position on top of the screening member 60, while the air in the air intake chamber 10d may be smoothly introduced into the lower electronic/electrical component chamber 10b through the first through-hole 52 regardless of the presence or absence of the screening member 60.

The screening member 60 may block the first through-hole 52 and the cold air inlet 5 from each other. The screening member 60 may serve to screen the flame rising upwardly from the first through-hole 52 while being positioned between the first through-hole 52 and the cold air inlet 5 such that the flame generated in the lower electronic/electrical component chamber 10b is not exposed to the outside out of the cooking appliance through the cold air inlet 5.

Most of the high-voltage electronic/electrical components such as the high-voltage transformer, the high-voltage condenser, and the like are disposed in the lower electronic/electrical component chamber 10b. As described above, the high-voltage electronic/electrical component disposed in the lower electronic/electrical component chamber 10b has a risk of generating a fire in the lower electronic/electrical component chamber 10b.

When the fire occurs in the lower electronic/electrical component chamber 10b, and the generated flame is exposed to the outside out of the cooking appliance. Thus, the flame exposed to the outside out of the cooking appliance is transferred to surroundings around the cooking appliance, thereby increasing the risk of spreading the fire.

In the cooking appliance, the first through-hole 52 is disposed at an upper side of the lower electronic/electrical component chamber 10b to constitute a passage necessary for the air in the air intake chamber 10d to flow into the lower electronic/electrical component chamber 10b. Moreover, the cold air inlet 5 which constitutes a passage necessary for external air to be introduced into the air intake chamber 10d is disposed above the first through-hole 52.

Accordingly, the flame generated in the lower electronic/electrical component chamber 10b may rise upwardly into the air intake hole 1 through the first through-hole 52, and may rise upwardly to the upper side of the main body 10 through the cold air inlet 5 in the air intake chamber 10d and be exposed to the outside out of the cooking appliance. In order to prevent this situation, it is necessary to block the flame generated in the lower electronic/electrical component chamber 10b inside the cooking appliance so as to prevent the flame from being exposed to the outside out of the cooking appliance.

In consideration of this fact, in the present embodiment, the screening member 60 disposed in the air intake chamber 10d is constructed to be able to block the first through-hole 52 and the cold air inlet 5 from each other. The screening member 60 may allow the flame generated in the lower electronic/electrical component chamber 10b to be blocked in the air intake chamber 10d, so that the flame generated in the lower electronic/electrical component chamber 10b may not be exposed to the outside out of the cooking appliance.

The cooking appliance of the present embodiment including the screening member 60 as described above may smoothly introduce the air into the lower electronic/electrical component chamber 10b, while significantly reducing the risk of fire spreading due to the flame generated inside the cooking appliance.

### Another Example of Screening Member

FIG. 29 is a rear perspective view illustrating a portion of a cooking appliance to which another example of a screening member is applied.

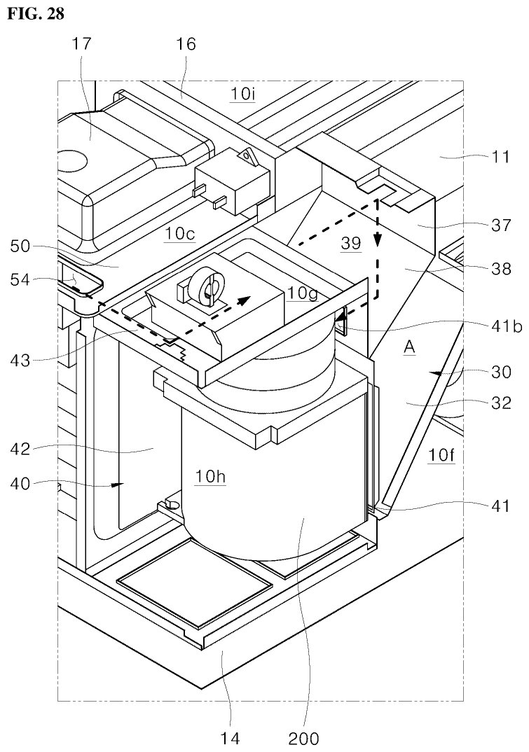

As illustrated in FIG. 29, the blocking plate 60 (see FIG. 27) is not disposed in the upper electronic/electrical component chamber 10c, and accordingly, the upper electronic/electrical component chamber 10c may not be partitioned in the front-rear direction. The screening member 65 disposed in the upper electronic/electrical component chamber 10c may be provided in a form in which the screening member 65 is directly installed on the partition plate 50. In one example, the screening member 65 may be formed in a hexahedral shape including a horizontal surface portion 66 and a vertical surface portion 67.

The horizontal surface portion 66 constitutes an upper surface of the screening member 65, and is constructed to screen the first through-hole 52 while being positioned on top thereof. In one example, the horizontal surface portion 66 may constitute a horizontal plane orthogonal to the vertical axis US.

The screening member 65 may further include the vertical surface portion 67. The vertical surface portion 67 may constitute a side surface of the screening member 65 and may be disposed between the horizontal surface portion 66 and the partition plate 50. The vertical surface portion 67 may be coupled to the upper surface of the partition plate 50 while spacing the horizontal surface portion 66 from the upper surface of the partition plate 50.

The screening member 65 may include a plurality of vertical surface portions 67 surrounding the first through-hole 52. A space surrounding the first through-hole 52 may be formed inside the screening member 65 including the plurality of vertical surface portions 67.

A ventilation hole 67a may be defined in at least one of the plurality of vertical surface portions 67. In the present embodiment, it is illustrated that the ventilation hole 67a is respectively defined in each of the vertical surface portions 67.

The ventilation hole 67a may be formed to extend through the vertical surface portion 67 in the horizontal direction. The ventilation hole 67a may constitute a passage that communicates the outside out of the screening member 65 with the inner space of the screening member 65. The air introduced into the upper electronic/electrical component chamber 10c through the cold air inlet 5 (see FIG. 24) may be introduced into the screening member 65 through the ventilation hole 67a from the outside out of the screening member 65 and then may be introduced into the lower electronic/electrical component chamber 10b through the first through-hole 52.

The screening member 65 provided as described above may provide an effect of significantly lowering the risk that the fire spreads due to the flame generated inside the cooking appliance, and may be effectively installed in the upper electronic/electrical component chamber 10c even when the blocking plate 55 is not installed.

### Structure of Upper Space

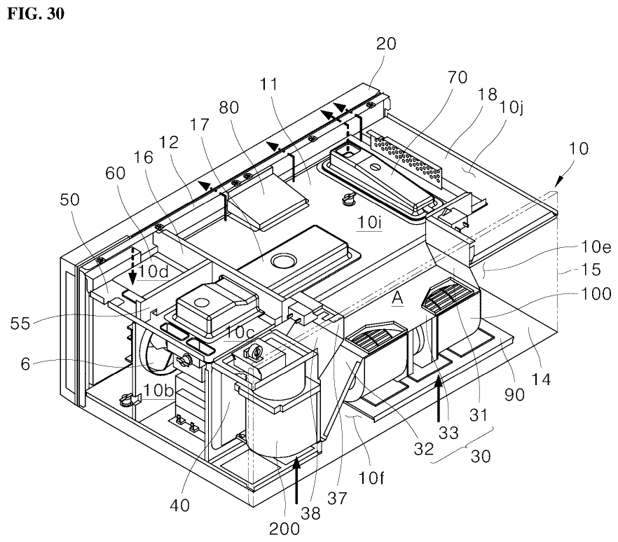

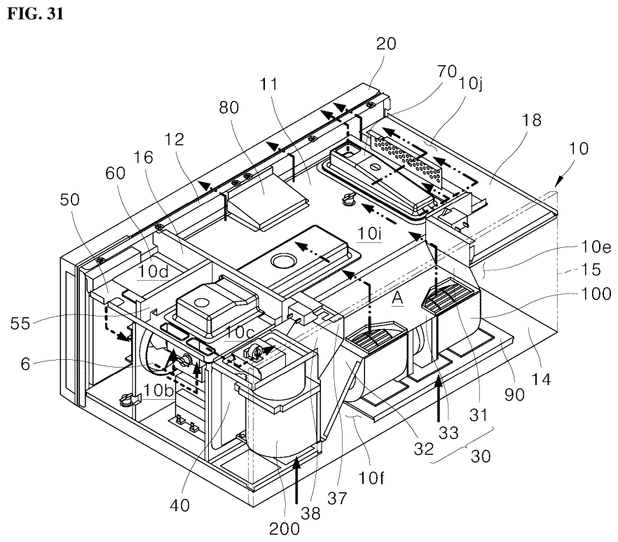

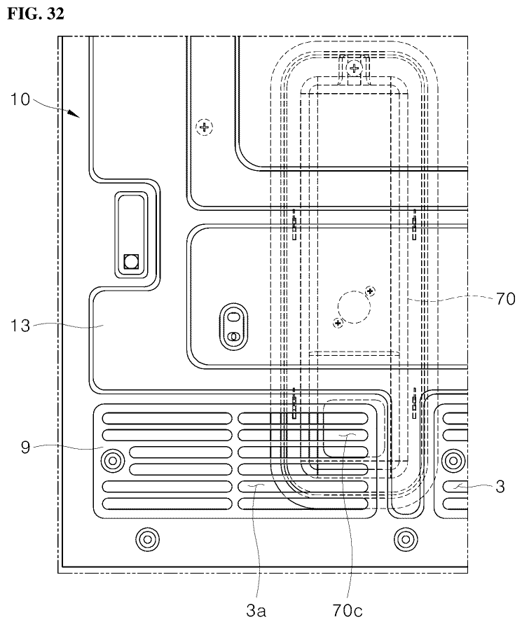

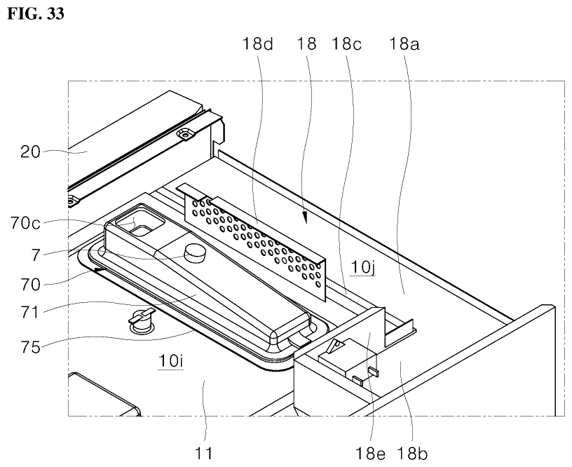

FIG. 30 is a rear perspective view illustrating an air intake state and an exhaust state of a cooking appliance according to a first embodiment of the present disclosure, and FIG. 31 is a rear perspective view illustrating an air flow state inside the cooking appliance as illustrated in FIG. 30. FIG. 32 is an enlarged plan view of a surrounding around a common exhaust hole as illustrated in FIG. 30, and FIG. 33 is an enlarged view of an exhaust duct and a surrounding therearound.

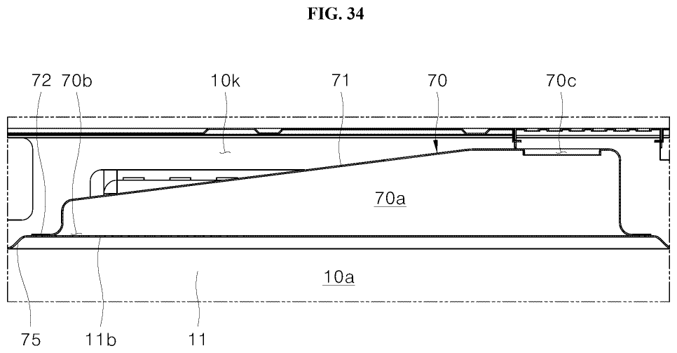

Referring to FIGS. 14, 30, and 32, a circulating air discharge hole 11b (see FIG. 34) may be provided inside the main body 10. The circulating air discharge hole 11b may constitute a passage connecting the cooking chamber 10a and the upper space 10i to each other such that the passage is defined in the upper surface of the cavity 11. In one example, the circulating air discharge hole 11b may be formed to extend through the upper surface of the cavity 11 in the vertical direction.

According to the present embodiment, a plurality of second exhaust holes 3 may be disposed in the upper surface of the main body 10. At least one of the plurality of second exhaust holes 3 may be provided as a common exhaust hole 3a. The common exhaust hole 3a is constructed to discharge, therethrough, both the air having flowed into the upper space 10i by the blower 100 and 200 and the air having flowed into the upper space 10i through the circulating air discharge hole 11b.

In one example, the circulating air discharge hole 11b may be disposed at a position closer to the right end around the lateral center of the cavity 11. For example, the circulating air discharge hole 11b may be disposed at a position overlapping at least a portion of the common exhaust hole 3a in the front-rear direction.

According to the present embodiment, the plurality of second exhaust holes 3 and the cold air inlet 5 may be arranged in the lateral direction. In one example, at least one of the plurality of second exhaust holes 3 disposed at a position farthest from the cold air inlet 5 may be provided as the common exhaust hole 3a. For example, the cold air inlet 5 may be disposed on the left side of the second exhaust hole 3, and one disposed at the rightmost side among the plurality of second exhaust holes 3 may be provided as the common exhaust hole 3a.

In another example, at least one of the plurality of second exhaust holes 3 arranged laterally at the position farthest from the electronic/electrical component chamber 10b, 10c, 10d may be provided as the common exhaust hole 3a.

In still another example, at least one of the plurality of second exhaust holes 3 arranged laterally and disposed at a position closest to the extension plate 18 may be provided as the common exhaust hole 3a. In this regard, at least a portion of the common exhaust hole 3a may be disposed to overlap the extension plate 18 in the vertical direction.

In addition, an exhaust duct 70 may be disposed in the upper space 10i. The exhaust duct 70 is constructed to guide the flow of air discharged from the cooking chamber 10a to the circulation air discharge hole 11b toward the common exhaust hole 3a.

In the present embodiment, the circulating air discharge hole 11b may be disposed at a position closer to the rear side around a front-rear directional center of the cavity 11. For example, the circulating air discharge hole 11b may be disposed in the upper surface of the cavity 11, and may be disposed at a position adjacent to the rear right corner of the cavity 11.

The exhaust duct 70 is constructed to guide the flow of air discharged to the circulation air discharge hole 11b disposed at the above-defined position toward the common exhaust hole 3a disposed at a position adjacent to the front surface of the main body 10.

In addition, the cooking appliance of the present embodiment may include the extension plate 18. The extension plate 18 may partition the side space 10e such that a partial area of the side space 10e is separated as the extended upper space 10j. Due to the extension plate 18, an area of the side space 10e above the extension plate 18 may be separated as the extended upper space 10j.

### Extension Plate

Referring to FIGS. 14, 30 and 33, at least a portion of the extension plate 18 may be disposed in the side space 10e. In the present embodiment, the extension plate 18 is illustrated as being disposed in the side space 10e rather than the electronic/electrical component chamber 10b, 10c, and 10d, among a pair of side spaces 10e disposed inside the cooking appliance.

In one example, the extension plate 18 may constitute a horizontal plane orthogonal to the vertical axis. For example, the extension plate 18 may constitute a plane parallel to the upper surface of the cavity 11.

Preferably, the upper surface of the extension plate 18 and the upper surface of the cavity 11 may constitute the same plane. The upper surface of the cavity 11 may define a bottom surface of the upper space 10i, and the upper surface of the extension plate 18 may define a bottom surface of the extended upper space 10j. Accordingly, the bottom surface of the upper space 10i and the bottom surface of the extended upper space 10j may be coplanar with each other.

The extended upper space 10j provided as described above may communicate with the upper space 10i while being positioned above the side space 10e. That is, the extended upper space 10j may be disposed above the side space 10e and on the lateral side of the upper space 10i, and may be connected to the upper space 10i in the lateral direction.

According to the present embodiment, the upper space 10i and the extended upper space 10j are connected to each other while being disposed above the cavity 11, and accordingly, the exhaust space 10i and 10j may be formed above the cavity 11 and the side space 10e. In the present embodiment, the exhaust space 10i and 10j may be defined as a single space into which the upper space 10i and the extended upper space 10j are connected to each other while being disposed above the cavity 11 and the extension plate 18.

The exhaust space 10i and 10j formed above the cavity 11 and the extension plate 18 may communicate with the exhaust hole 2, 3, and 4 disposed in the upper surface of the main body 10. The exhaust hole 2, 3, and 4 may communicate the single space into which the upper space 10i and the extended upper space 10j are connected to each other, that is, the exhaust space 10i and 10j with the outside out of the main body 10.

The side space 10e and the rear space 10f may communicate with the lower space. The side space 10e and the rear space 10f may be connected to the lower space in the vertical direction or may be connected thereto in the lateral direction. The air intake hole 1 may be in communication with the lower space, and the side space 10e and the rear space 10f may be in communication with the air intake hole 1 through the lower space.

A portion of the extension plate 18 may be disposed in the rear space 10f. Accordingly, a portion 18a of the extension plate 18 (hereinafter, referred to as a “side partition portion of the extension plate”) may be disposed in the side space 10e, and another portion 18b of the extension plate 18 (hereinafter, referred to as a “rear partition portion of the extension plate”) may be disposed in the rear space 10f.

As described above, the side partition portion 18a of the extension plate 18 may partition the side space 10e such that a partial area of the side space 10e is separated as the extended upper space 10j. In addition, the rear partition portion 18b of the extension plate 18 may partition the rear space 10f so that a partial area of the rear space 10f is separated as the extended upper space 10j.

That is, the extension plate 18 may divide the rear space 10j and the side space 10f such that a partial area of each of the side space 10f and the rear space 10e is separated as the extended upper space 10a.

The extension plate 18 may include a first coupling portion 18c. The first coupling portion 18c may be provided for coupling between the extension plate 18 and the cavity 11. In one example, the first coupling portion 18c may be formed to protrude from at least one of the side partition portion 18a and the rear partition portion 18b in the horizontal direction. The first coupling portion 18c may be coupled to the cavity 11 while contacting the upper surface of the cavity 11 in the vertical direction.

The coupling between the first coupling portion 18c and the cavity 11 may be performed in a bonding manner using welding or the like, or may be performed in a fastening manner using a screw or the like.

In the present embodiment, it is illustrated that the first coupling portion 18c protrudes from the side partition portion 18a in a lateral direction. In another example, the first coupling portion 18c may be formed to protrude in the frontward direction from the rear partition portion 18b. In still another example, the first coupling portion 18c may protrude vertically from at least one of the side partition portion 18a and the rear partition portion 18b and be coupled to the side surface of the cavity 11.

In addition, the extension plate 18 may include at least one of a second coupling portion 18d and a third coupling portion 18e. The second coupling portion 18d and the third coupling portion 18e may be provided for coupling between the extension plate 18 and the cabinet 13.

The second coupling portion 18d may be provided in a shape protruding from the side partition portion 18a or the first coupling portion 18c. In the present embodiment, it is illustrated that the first coupling portion 18c protrudes from the side partition portion 18a in the horizontal direction, and the second coupling portion 18d protrudes from the first coupling portion 18c in the vertical direction.

In one example, the second coupling portion 18d may constitute a vertical wall orthogonal to the lateral axis. A flat portion parallel to the upper surface of the cabinet 13 may be formed at the upper end of the second coupling portion 18d.

The third coupling portion 18e may be provided in a shape protruding from the rear partition portion 18b. In one example, the third coupling portion 18e may constitute a vertical wall orthogonal to the front-rear axis. A flat portion parallel to the upper surface of the cabinet 13 may be formed at the upper end of the third coupling portion 18e.

The vertical length of each of the second coupling portion 18d and the third coupling portion may be set to a length corresponding to a distance between the extension plate 18 and the cabinet 13. The second coupling portion 18d and the third coupling portion 18e formed as described above may be coupled to the cabinet 13 while being positioned under the cabinet 13.

The extension plate 18 may support the cabinet 13 so that the upper surface of the cabinet 13 does not sag downwardly, via the coupling between the second coupling portion 18d and the cabinet 13 and the coupling between the third coupling portion 18e and the cabinet 13. In addition, the extension plate 18 may be coupled to various structures at various positions using the first coupling portion 18c, the second coupling portion 18d, and the third coupling portion 18e and thus may be stably fixed installed inside the cooking appliance.

In one example, the second coupling portion 18d may be disposed between the upper space 10i and the extended upper space 10j. That is, the second coupling portion 18d may be disposed in the exhaust space 10i and 10j in the form of the vertical wall that laterally and partially blocks the upper space 10i and the extended upper space 10j from each other.

The second coupling portion 18d may have a plurality of ventilation holes defined therein. Each ventilation hole may be formed to extend through the second coupling portion 18d in the lateral direction, and the ventilation holes may be disposed in a substantial area of the second coupling portion 18d.

As described above, the second coupling portion 18d having the plurality of ventilation holes defined therein may act as a structure for coupling between the extension plate 18 and the cabinet 13, while minimizing interference of the flow of air in the exhaust space 10i and 10j due to the second coupling portion 18d.

In the present embodiment, the third coupling portion 18e is illustrated as being disposed in an area where the rear space 10f and the upper space 10i overlap each other or in a very close proximity thereto. The third coupling portion 18e may be disposed at a position adjacent to the rear fan assembly 100 disposed in the rear space 10f.

The electronic/electrical component related to the rear fan assembly 100, for example, the electronic/electrical component such as a capacitor connected to the rear fan assembly 100, may be coupled to the third coupling portion 18e disposed as described above. That is, the third coupling portion 18e may serve to provide a structure for coupling between the extension plate 18 and the cabinet 13 and to provide a structure for installing an electronic/electrical component related to the rear fan assembly 100.

### Exhaust Duct

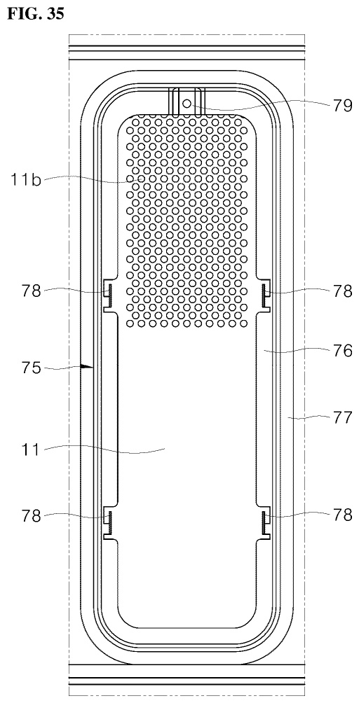

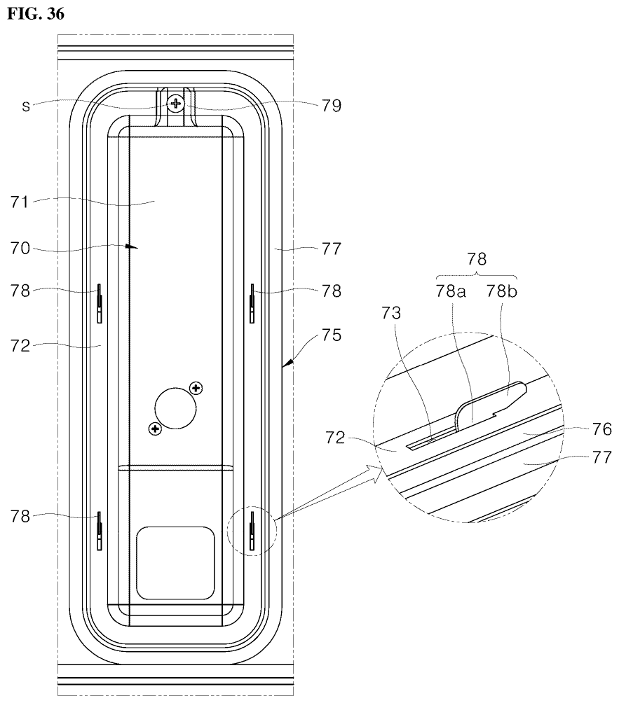

FIG. 34 is a side cross-sectional view illustrating the exhaust duct, FIG. 35 is a plan view illustrating a state in which a duct bracket is installed on the upper surface of the cavity, and FIG. 36 is a diagram illustrating a state in which the exhaust duct is installed on the duct bracket.

Referring to FIGS. 33 to 35, the exhaust duct 70 may have a flow path defined therein connected to the circulating air discharge hole 11a. In one example, the exhaust duct 70 may be formed in a polyhedral shape having a much larger length in the front-rear direction than each of the lateral length and the vertical length thereof.

A rear end of the exhaust duct 70 may be disposed between the rear surface of the cavity 11 and the circulating air discharge hole 11b. A front end of the exhaust duct 70 may be disposed between a center in the front-rear direction of the cavity 11 and the front surface of the cavity 11.

For example, the rear end of the exhaust duct 70 may be disposed at a position very adjacent to the rear surface of the cavity 11, and the front end of the exhaust duct 70 may be disposed at a position very adjacent to the front surface of the cavity 11.

A space is formed inside the exhaust duct 70, and the space may constitute a flow path 70a connected to the circulating air discharge hole 11b and defined inside the exhaust duct 70. A duct inlet 70b and a duct outlet 70c may be defined in the exhaust duct 70.

The duct inlet 70b is constructed to open the flow path 70a toward the circulation air discharge hole 11b while being disposed on one side in the longitudinal direction of the flow path 70a. The duct outlet 70c is constructed to open the flow path inside the exhaust duct 70 toward the common exhaust hole 3a.

In one example, the duct inlet 70b may be formed in a form in which the bottom surface of the exhaust duct 70 is open. At least a portion of the duct inlet 70b may overlap the circulation air discharge hole 11b in the vertical direction.

In addition, the duct outlet 70c may be formed in a form in which a portion of the upper surface of the exhaust duct 70 is open. The duct outlet 70c may be disposed at a position closer to a front end around a front-rear directional center of the exhaust duct 70. The duct outlet 70c may be disposed adjacent to the common exhaust hole 3a.

In the lateral direction, the duct outlet 70c may be disposed at a position close to the common exhaust hole 3a among the plurality of exhaust holes 2, 3, and 4 arranged in the lateral direction. The duct outlet 70c may be disposed to overlap at least a portion of the common exhaust hole 3a in the vertical direction.

The cooking appliance of this embodiment may further include a humidity sensor 7. The humidity sensor 7 is installed in the exhaust duct 70, and is configured to measure humidity in the flow path 70a.

The humidity sensor 7 is configured to measure the humidity of the air introduced into the flow path 70b through the circulating air discharge hole 11a in the cooking chamber. In order to effectively measure the humidity of the air introduced into the flow path 70a using the humidity sensor 7, the flow path 70a having a sufficient length is required.

To this end, the circulating air discharge hole 11b may be disposed at a position closer to a rear end of the upper space 10i, the duct outlet 70c may be disposed at a position closer to a front end of the upper space 10i, and the exhaust duct 70 may be formed to have a sufficient length to cover them.

The exhaust duct 70 of the present embodiment may be disposed between the upper surface of the cavity 11 and the upper surface of the cabinet 13 in the vertical direction. The exhaust duct 70 may include a vertical length change section 71.

The vertical length change section 71 is a section in which the vertical length of the exhaust duct 70 is changed along the longitudinal direction of the flow path 70a. For example, the vertical length change section 71 may be a section of the exhaust duct 70 whose a vertical length is changed in the front-rear direction.

According to the present embodiment, the circulating air discharge hole 11b defined in the cavity 11 is disposed at a vertical level lower than a vertical level of the second exhaust hole 3 defined in the upper surface of the cabinet 13. In the vertical length change section 71, the vertical length of the exhaust duct 70 may decrease as the exhaust duct 70 extends toward one side in the longitudinal direction of the flow path 70a, for example, toward the rear side.

That is, in the vertical length change section 71, the upper surface of the exhaust duct 70 may constitute an inclined surface whose a vertical level decreases as the exhaust duct 70 extends toward one side in the longitudinal direction of the flow path 70a.

In other words, in the vertical length change section 71, the vertical length of the exhaust duct 70 may increase as the exhaust duct 70 extends toward the other side in the longitudinal direction of the flow path 70a, for example, toward the front side.

In the vertical length change section 71, a passage space 10k may be defined between the upper surface of the exhaust duct 70 and the upper surface of the cabinet 13. The passage space 10k may constitute a passage connecting a space on one side the lateral direction of the exhaust duct 70 of the upper space 10i and a space on the other side in the lateral direction of the exhaust duct 70 of the upper space 10i to each other such that the passage is positioned above the exhaust duct 70. In the present embodiment, the passage space 10k may be formed in a form in which a vertical dimension of the passage space 10k increases as the passage space 10k extends toward the rear side.

In one example, the cooking appliance of the present embodiment may further include a duct bracket 75. The duct bracket 75 may be provided for coupling between the exhaust duct 70 and the cavity 11. The duct bracket 75 may be coupled to the upper surface of the cavity 11. In addition, the exhaust duct 70 may be detachably coupled to the duct bracket 75.

In one example, the duct bracket 75 may include a bracket body 76 and a flange 77.

The bracket body 76 is a portion of the duct bracket 75 provided for coupling between the duct bracket 75 and the exhaust duct 70. The bracket body 76 may be coupled to the upper surface of the cavity 11 and coupled to the exhaust duct 70.

The flange 77 is a portion of the duct bracket 75 provided for coupling between the duct bracket 75 and the cavity 11. The flange 77 is bond to the upper surface of the cavity 11 to couple the bracket body 76 to the upper surface of the cavity 11.

The flange 77 may constitute a plane parallel to the upper surface of the cavity 11, and may be constructed to contact the upper surface of the cavity 11 in the vertical direction. The coupling between the flange 77 and the cavity 11 may be performed in a bonding manner using welding or the like.

Referring to FIGS. 35 and 36, a coupling surface 72 may be provided on the exhaust duct 70. The coupling surface 72 may be disposed on a lower end of the exhaust duct 70, and may constitute a surface that is in contact with an upper surface of the bracket body 76 in the vertical direction. In one example, the upper surface of the bracket body 76 may constitute a horizontal plane orthogonal to the vertical axis, and the coupling surface 72 may constitute a plane parallel thereto.

The duct bracket 75 may further include a first duct coupling portion 78 coupled to the coupling surface 72. The first duct coupling portion 78 may be detachably coupled to the coupling surface 72 in a state in which the coupling surface 72 contacts the bracket body 76 in the vertical direction.

In one example, the first duct coupling portion 78 may include a vertical protrusion 78a and a horizontal protrusion 78b. The vertical protrusion 78a may be formed in a shape protruding upwardly from the bracket body 76. The horizontal protrusion 78b may be formed to protrude from the vertical protrusion 78a in a horizontal direction, more specifically, in a front-rear direction.

In one example, the horizontal protrusion 78b may protrude rearwards from the upper end of the vertical protrusion 78a. In the present embodiment, it is illustrated that the first duct coupling portion 78 protrudes from the bracket body 76 in a “T” shape.

The vertical protrusion 78a may pass through a slit 73 formed in the coupling surface 72 so as to pass through the coupling surface 72 in the vertical direction. The horizontal protrusion 78b protruding from the upper end of the vertical protrusion 78a may restrict the upward movement of the duct bracket 75 while being positioned on the upper side of the coupling surface 72.

The slit 73 may be defined so that the entire first duct coupling portion 78 can extend through the slit 73. When the exhaust duct moves backwards so that the horizontal protrusion 78b may move to the rear side of the slit 73 in a state in which the horizontal protrusion 78b passes through the slit 73 and is disposed above the coupling surface 72 and the coupling surface 72 contacts the upper surface of the bracket body 76, the horizontal protrusion 78b may restrict the upward movement of the duct bracket 75 while being positioned on the upper side of the coupling surface 72.

The exhaust duct 70 may be temporarily fixed to the duct bracket 75 via fitting-coupling between the first duct coupling portion 78 and the coupling surface 72. That is, the position of the exhaust duct 70 relative to the duct bracket 75 may be temporarily fixed via the fitting-coupling between the first duct coupling portion 78 and the coupling surface 72.

In one example, a plurality of first duct coupling portions 78 may be included in the duct bracket 75 and may be arranged so as to be spaced apart from each other by a predetermined spacing in the lateral direction. Accordingly, the exhaust duct 70 may be temporarily fixed using the first duct coupling portions 78 at a plurality of points arranged along the lateral direction.

The duct bracket 75 may further include a second duct coupling portion 79. The second duct coupling portion 79 may be constructed to couple the exhaust duct 70 and the duct bracket 75 to each other using a fastening member s such as a screw.

In one example, the fastening member s may pass through the upper surface of the bracket body 76 and the coupling surface 72 to couple the duct bracket 75 to the exhaust duct 70. The second duct coupling portion 79 may be constructed to be fastened to the fastening member s.

In one example, the second duct coupling portion 79 may constitute a convex plane upwardly from the upper surface of the bracket body 76, and a fastening hole for fastening with the fastening member s may be defined in the second duct coupling portion 79.

As described above, the exhaust duct 70 may be installed on the upper surface of the cavity 11 via the duct bracket 75.

In order to install the exhaust duct 70 on the cavity 11 so that the exhaust duct 70 may be removed from the cavity 11 as needed, it is necessary to couple the exhaust duct 70 to the cavity 11 using a fastening member such as a screw.

However, in this case, a fastening hole for screw fastening should be formed in the cavity 11, and it is not preferable that unnecessary damage is applied to the cavity 11 due to the fastening holes.

In addition, in the process of fastening the screw to the cavity 11, the damage to the cavity 11 may be further increased, and in the process of removing the screw from the cavity 11 or refastening the screw to the cavity 11 in order to disassemble and reassemble the exhaust duct 70, severe damage may be applied to the cavity 11.

In order to prevent the cavity 11 from being damaged, the exhaust duct 70 may be joined to the cavity 11 in a welding or bonding manner. However, in this case, it becomes very difficult for the exhaust duct 70 to be removed from the cavity 11, and the cavity 11 may be damaged in the process of removing the exhaust duct 70 from the cavity 11.

In consideration of this fact, in the present embodiment, the duct bracket 75 is bonded to the cavity 11 in a welding or adhesive manner, and the exhaust duct 70 may be detachably coupled to the duct bracket 75.

Accordingly, the cavity 11 and the duct bracket 75 are coupled to each other in a welding or adhesive bonding manner, whereby damage to the cavity 11 due to perforation or the like may be minimized.

In addition, the exhaust duct 70 is removably coupled to the duct bracket 75 bonded to the cavity 11 as described above. Thus, the exhaust duct 70 may be easily and quickly removed from the cavity 11 as needed, and damage to the cavity 11 that may occur in the process of disassembling and reassembling the exhaust duct 70 may be minimized.

In addition, via the fitting-coupling between the first duct coupling portion 78 and the coupling surface 72, the coupling position of the exhaust duct 70 relative to the duct bracket 75 may be guided, and the exhaust duct 70 may be temporarily fixed to the duct bracket 75. Thus, the installation of the exhaust duct 70 may be performed more easily and quickly.

### One Example of Lamp Cover

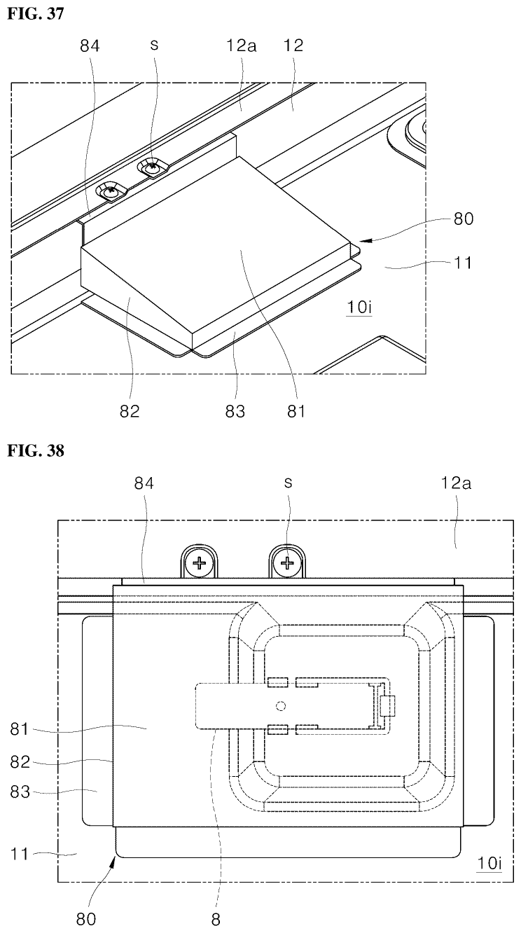

FIG. 37 is an enlarged view of a lamp cover and a surrounding therearound, and FIG. 38 is a plan view of the lamp cover as illustrated in FIG. 37.

Referring to FIGS. 31, 37 and 38, a lamp 8 may be provided inside the main body 10. The lamp 8 is configured to emit light to the cooking chamber 10a.

In one example, the lamp 8 may be installed on an upper surface of the cavity 11. At least a portion of the lamp 8 may be exposed to the upper side of the cavity 11. For example, a portion of the lamp 8 installed on the upper surface of the cavity 11 may be exposed to the upper space 10i.

The cooking appliance of the present embodiment may include a lamp cover 80. The lamp cover 80 is constructed to cover the lamp 8. The lamp cover 80 may cover the lamp 8 while being disposed above the cavity 11 such that the space surrounding the lamp 8 is blocked from the upper space 10i.

In one example, the lamp cover 80 may include a cover upper surface portion 81 and a cover side surface portion 82. The cover upper surface portion 81 is constructed to cover an upper side of the lamp 8, and the cover side surface portion 82 is constructed to surround a lateral side of the lamp.

In one example, the cover upper surface portion 81 may constitute a horizontal plane disposed to be spaced apart from the upper surface of the cavity 11 by a predetermined spacing in the vertical direction. The cover side surface portion 82 may constitute a vertical wall surface that connects the upper surface of the cavity 11 and the cover upper surface portion 81 to each other.

In one example, the lamp cover 80 may be formed in a hexahedral shape with an open lower side. The lamp 8 may be disposed so as to be surrounded with the cover upper surface portion 81 and the cover side surface portion 82.

The lamp cover 80 may further include a close contact portion 83. The close contact portion 83 may be constructed to be in surface contact with the upper surface of the cavity 11 and connected to the lower end of the cover side portion 82. In one example, the close contact portion 83 may extend in the horizontal direction from the lower end of the cover side portion 82 and may constitute a plane parallel to the upper surface of the cavity 11.

The close contact portion 83 may be in surface contact with the upper surface of the cavity 11, and may serve to allow the lamp cover 80 to be in close contact with the upper surface of the cavity 11. Accordingly, the space inside the lamp cover 80 surrounding the lamp 8 may be reliably blocked from the upper space 10i, and the inflow of air into the lamp cover 80 from the upper space 10i may be effectively inhibited.

The lamp cover 80 of the present embodiment may be disposed between the upper surface of the cavity 11 and the upper surface of the cabinet 13 in the vertical direction. In addition, the lamp cover 80 may be disposed adjacent to the front surface of the main body 10.

According to the present embodiment, the front plate 12 may be formed such that the upper end of the front plate 12 is disposed at a position higher than a position of the upper surface of the cavity 11. An upper end surface portion 12a may be provided at an upper end of the front plate 12. The upper end surface portion 12a may constitute a horizontal surface protruding rearwards and positioned at a position on top of the cavity 11.

The lamp cover 80 may be disposed adjacent to the front plate 12. In one example, the lamp cover 80 may be disposed at a position in which the front end of the lamp cover 80 is in close contact with a rear surface of the front plate 12.

The cover upper surface portion 81 of the lamp cover 80 may constitute an inclined surface whose a vertical level is changed along the front-rear direction. In one example, the cover upper surface portion 81 may constitute an inclined surface whose a vertical level decreases as the cover upper surface portion 81 extends toward the rear side.

The lamp cover 80 may be coupled to the front plate 12. A cover coupling portion 84 may be included in the lamp cover 80. The cover coupling portion 84 may protrude rearwards from the lamp cover 80 so as to contact the upper end surface portion 12a of the front plate 12 in the vertical direction.

The cover coupling portion 84 may be formed in a shape protruding upwardly and rearwards from the front end of the cover upper surface portion 81. In one example, the cover coupling portion 84 may be formed to protrude in a “T” shape from the front end of the cover upper surface portion 81. In one example, the coupling between the cover coupling portion 84 and the upper end surface portion 12a may be performed using a fastening member s such as a screw or the like.

According to the present embodiment, the lamp cover 80 is coupled only to the front plate 12 and not to the cavity 11. For example, the lamp cover 80 is only in close contact with the upper surface of the cavity 11 via the close contact portion 83, and is not coupled to the cavity 11. This is intended to allow the lamp cover 80 to be detachably coupled to the main body 10 while avoiding unnecessary damage to the cavity 11.

To this end, the lamp cover 80 may be coupled to the front plate 12 via the cover coupling portion 84 and the upper end portion 12a, and thus may be detachably coupled to the main body 10. That is, the cover coupling portion 84 may be constructed to couple the lamp cover 80 to the front plate 12 instead of the cavity 11.

According to the present embodiment, at least a portion of the lamp 8 is exposed to the inside of the cooking chamber 10a so as to illuminate the cooking chamber 10a. In addition, in order for the lamp 8 to be connected to other electronic/electrical components, a portion of the lamp 8 is exposed to the outside out of the cooking chamber 10a. For example, a connection between a wire for power supply and the lamp 8 may be made through a portion of the lamp 8 exposed to the outside out of the cooking chamber 10a.

According to the present embodiment, the lamp 8 is installed on the upper surface of the cavity 11, and accordingly, a portion of the lamp 8 is exposed to the space above the cavity 11, that is, the upper space 10i. As the portion of the lamp 8 is exposed to the upper space 10i, the lamp 8 may be exposed to oil vapor and heat.

The cooking gas that is suctioned by the blower 100 and 200 and then flows through the upper space 10i may include an oil vapor, a hot steam, and the like. The cooking gas including the oil vapor and the hot steam may contact the lamp 8 while flowing through the upper space 10i, thereby causing contamination, failure, and the like of the lamp 8.

In consideration of this situation, in the present embodiment, the lamp cover 80 is installed in the upper space 10i. The lamp cover 80 may protect the lamp 8 from the oil vapor and heat by the lamp cover covering the lamp 8 while being disposed above the cavity 11 so that the space surrounding the lamp 8 is blocked from the upper space 10i.

In the conventional cooking appliance, the blower is disposed in the upper space rather than the rear space. In this case, a sufficient space necessary for the blower to be installed in the upper space must be secured. In such a conventional cooking appliance, the vertical length of the upper space should be considerably higher than that of the upper space 10i of the cooking appliance of the present embodiment.

In addition, as the blower is disposed in the upper space, in the conventional cooking appliance, a flow path defining member for defining an exhaust flow path in the upper space is installed in the upper space. The flow path defining member defines the exhaust flow path that connects the exhaust hole disposed in the front surface of the conventional cooking appliance and the blower to each other such that the exhaust flow path is positioned in the upper space.

In the conventional cooking appliance, the flow path defining member may be formed in a shape including a pair of sidewalls disposed to be spaced apart from each other by a predetermined spacing in a lateral direction, and a bottom surface connecting the sidewalls to each other at lower sides thereof. For example, the flow path defining member may be formed in a “U” shape.

The flow path defining member may be installed on an upper side of the cavity. The flow path defining member may be detachably installed onto the upper side of the cavity, and the lower surface of the flow path defining member is seated on the upper surface of the cavity.

The lamp installed on the upper surface of the cavity is disposed under the flow path defining member. That is, in the conventional cooking appliance, the lamp is covered with the bottom surface of the flow path defining member and is not exposed to the exhaust flow path. Therefore, in the conventional cooking appliance, a separate structure for covering the lamp in addition to the flow path defining member is not required.

In contrast thereto, in the cooking appliance of the present embodiment, the blower 100 and 200 is disposed in the rear space 10f. Therefore, in the cooking appliance of the present embodiment, a space required for installing the blower 100 and 200 does not need to be secured in the upper space 10i. In the cooking appliance of the present embodiment, the vertical length of the upper space 10i may be significantly lowered compared to the vertical length of the upper space of the conventional cooking appliance.

As the vertical length of the upper space 10i decreases, it is difficult to secure a space required for installation of a structure such as the flow path defining member of the conventional cooking appliance in the upper space 10i. In addition, in the cooking appliance according to the present embodiment, the blower 100 and 200 and the flow path defining member 30 are disposed in the rear space 10f, such that a structure for defining the exhaust flow path does not need to be installed in the upper space 10i.

As the vertical length of the upper space 10i decreases, the vertical length of the cooking appliance may be shortened, and the total size of the cooking chamber may be reduced relative to the volume of the cooking chamber 10a. However, as the structure such as the flow path defining member of the conventional cooking appliance is not installed in the upper space 10i, the lamp 8 is exposed to the upper space 10i.

In consideration of this fact, in the present embodiment, the lamp cover 80 is installed in the upper space 10i, and the lamp cover 80 may cover the lamp 8 while being disposed above the cavity 11 so that the space surrounding the lamp 8 is blocked from the upper space 10i. Accordingly, both a purpose for reducing the vertical length of the upper space 10i and a purpose for protecting the lamp 8 from the oil vapor and heat may be satisfied at the same time.

### Other Example of Lamp Cover

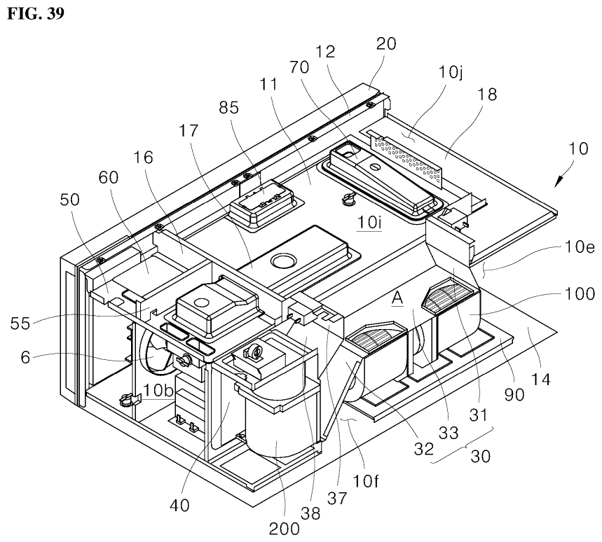

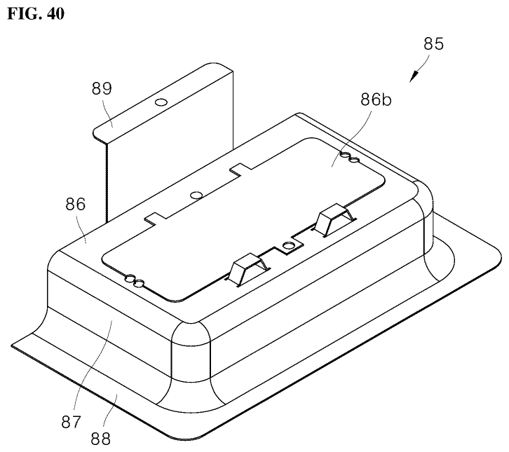

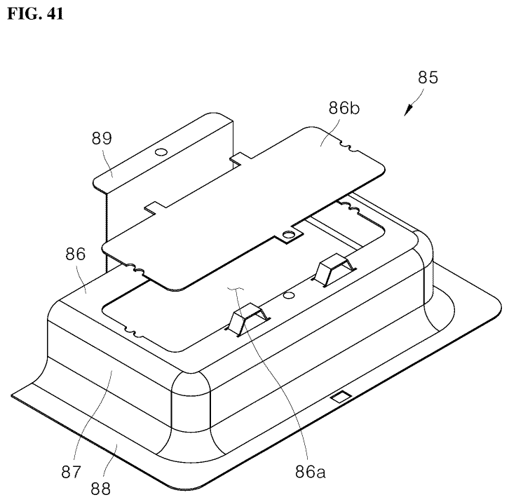

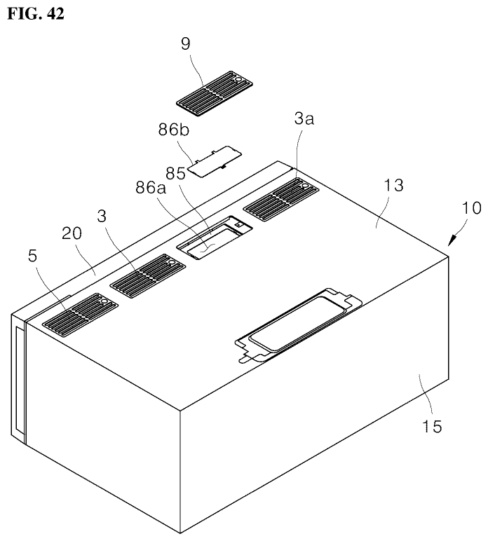

FIG. 39 is a rear perspective view illustrating a cooking appliance to which another example of a lamp cover is applied, and FIG. 40 is a perspective view illustrating the lamp cover separated from the cooking appliance as illustrated in FIG. 39. FIG. 41 is an exploded perspective view illustrating an exploded state of the lamp cover as illustrated in FIG. 40, and FIG. 42 is an exploded perspective view illustrating an exploded state of the ventilation grill and the lamp cover.

Referring to FIGS. 39 to 41, the lamp cover 85 may be provided in a form including an opening/closing cover 86b. The lamp cover 85 may include a cover upper surface portion 86, a cover side surface portion 87, a close contact portion 88, and a cover coupling portion 89 in a similar manner to the lamp cover illustrated in the above-described embodiment, and may further include the opening/closing cover 86b.

A through-hole 86a may be defined in the upper surface of the lamp cover 85 of the present embodiment. The through-hole 86amay open an upper side of an inner space of the lamp cover 85, and may be formed to extend through the cover upper surface portion 86 in the vertical direction. The lamp 8 may be exposed to a position on top of the lamp cover 85 thorough the through-hole 86a.

The opening/closing cover 86b is installed in the lamp cover 85, more specifically, the cover upper surface portion 86, to open and close the through-hole 86a. In one example, the opening and closing cover 86b may be detachably coupled to the cover upper surface portion 86. For example, the opening and closing cover 86b may cover the through-hole 86a while being positioned on top thereof, and may be removed from the upper surface of the cover 86 while being positioned on top thereof.

Referring to FIGS. 39 to 42, the lamp cover 85 may be disposed under one of the plurality of second exhaust holes 2. For example, at least a portion of the lamp cover 85 may be disposed under one of the plurality of second exhaust holes 2 in the vertical direction.

In one example, the cooking appliance may further include at least one ventilation grill 9. Each ventilation grill 9 may be coupled to the cabinet 13 so as to cover each of the second exhaust hole 3 or the cold air inlet 5. Each ventilation grill 9 may be detachably coupled to the cabinet 13.

For example, each ventilation grill 9 may be seated on the upper surface of the cabinet 13, may cover each of the second exhaust hole 3 or the cold air inlet 5, and may be lifted upwardly from the upper surface of the cabinet 13 and be removed from the cabinet 13.

In one example, the opening and closing cover 86b may be disposed under one of the plurality of second exhaust holes 2 in the vertical direction. In the vertical direction, the through-hole 86a may be disposed between the second exhaust hole 3 and the lamp 8, and the opening/closing cover 86b may be disposed between the ventilation grill 9 installed in the second exhaust hole 3 and the lamp 8. In a top view, when the ventilation grill 9 has been removed from the second exhaust hole 3, the opening and closing cover 86b is visible to a position on top of the cooking appliance. The opening and closing cover 86b has been removed in this state, such that the lamp 8 is visible to a position on top of the cooking appliance.

As the lamp cover 85 and the opening/closing cover 86b are installed inside the main body 10 in the above-described form, the maintenance work on the lamp 8 may be performed in a state in which the ventilation grill 9 and the opening/closing cover 86b are sequentially removed from the cabinet 13 and the cover upper surface portion 86.

That is, the lamp cover 85 according to the present embodiment enables access to the lamp 8 by only a simple operation of separating the ventilation grill 9 and the opening/closing cover 86b, thereby providing an effect of making maintenance work on the lamp 8 easy and fast.

### Exhaust Through Exhaust Space

Referring to FIGS. 16 and 31 to 33, the upper space 10i may be formed above the cavity 11. In addition, the extended upper space 10j may be formed above the side space 10b, not the electronic/electrical component chambers 10e, 10c, and 10d.

As described above, the upper space 10i and the extended upper space 10j are connected to each other while being disposed above the cavity 11, and accordingly, the exhaust space 10i and 10j may be formed above the cavity 11 and the side space 10e.

The extended upper space 10j may be defined by the extension plate 18 that vertically partitions the side space 10e. In the present embodiment, the extension plate 18 may serve to extend the exhaust space 10i and 10j in the lateral direction by allowing the exhaust space 10i and 10j to be a space including not only the upper space 10i but also the extended upper space 10j. In addition, the extension plate 18 may serve to block the side space 10e from the exhaust space 10i and 10j.

As the exhaust space 10i and 10j is extended to a space including both the upper space 10iand the extended upper space 10j, the size of the flow path required for the flow of air discharged to the second exhaust hole 3 through the exhaust space 10i and 10j may be increased. In particular, the size of the exhaust space 10i and 10j may be further increased laterally by the size of the extended upper space 10j.

That is, the extension plate 18 according to the present embodiment divides the side space 10e so that the extended upper space 10j that may be connected to the upper space 10i may be formed, thereby providing an effect of increasing the size of the exhaust space 10i and 10j.

As described above, in the cooking apparatus according to the present embodiment, the air blower 100 and 200 is disposed in the rear space 10i rather than the upper space 10f. Accordingly, since a space required for installation of the blower 100 and 200 is not required in the upper space 10i, the vertical length of the upper space 10i may be reduced, compared to the case where the blower is installed in the upper space 10.

In the cooking appliance according to the present embodiment, one of the methods for reducing the total size of the cooking appliance while minimizing the reduction in the volume of the cooking chamber, that is, the methods for reducing the total vertical length of the cooking appliance while minimizing the reduction in the vertical length of the cooking chamber, is to reduce the vertical length of the upper space 10i.

In consideration of this fact, in the cooking appliance according to the present embodiment, the vertical length of the upper space 10i is set to be smaller than the vertical length of the upper space of the conventional cooking appliance. That is, in the cooking appliance of the present embodiment, the vertical length of the upper space 10i is set to be significantly smaller than the vertical length in which the rear fan assembly 100 or the corner fan assembly 200 can be installed.

As described above, when the vertical length of the upper space 10i is reduced, the volume of the upper space 10i is inevitably reduced. In this regard, the upper space 10i is related to the exhaust. Thus, when the volume of the upper space 10i is reduced, the size of the flow path required for the flow of the air discharged to the second exhaust hole 3 is inevitably reduced by the reduction amount of the volume thereof.

When the size of the flow path necessary for the flow of the air discharged to the second exhaust hole 3 is reduced, the exhaust performance of the cooking appliance is inevitably deteriorated. In addition, when the exhaust performance of the cooking appliance is deteriorated, the air intake performance of the cooking appliance is also inevitably deteriorated, and in the end, the performance of removing the cooking gas of the cooking appliance is deteriorated.

In consideration of this situation, in the present embodiment, the extended upper space 10e is blocked from the side space 10e via the extension plate 18 that vertically divides the side space 10j, and the extended upper space 10j is connected to the upper space 10i, so that the total size of the exhaust space 10i and 10j including the upper space 10i can be increased. Accordingly, the size of the flow path required for the flow of the air discharged to the second exhaust hole 3 through the exhaust space 10i and 10j may be effectively increased.

As described above, when the size of the flow path required for the flow of the air discharged to the second exhaust hole 3 through the exhaust space 10i and 10j is increased, the exhaust performance of the cooking appliance may be improved accordingly, and as a result, the cooking gas removal performance of the cooking appliance may be improved.

In one example, the structures such as an exhaust duct 70 and the lamp cover 80 are disposed in the exhaust space 10i and 10j. These structures have the shape protruding from the upper surface of the cavity 11 into the exhaust space 10a and 10j to perform each of the functions thereof.

For example, the exhaust duct 70 is formed in a shape protruding from the upper surface of the cavity 11 and has a flow path defined therein for the flow of air discharged from the cooking chamber. The lamp cover 80 is formed in a shape protruding from the upper surface of the cavity 11 so as to cover the upper side of the lamp and to be coupled to the front plate 12.

Each of the exhaust duct 70 and the lamp cover 80 may be formed in a shape including an inclined surface. That is, each of the exhaust duct 70 and the lamp cover 80 may be formed in a shape that inevitably protrudes from the upper surface of the cavity 11 to perform each function, but may be formed in the shape that is constructed to reduce the flow resistance generated by the exhaust duct 70 and the lamp cover 80 in the exhaust space 10a and 10j.

That is, in accordance with the present embodiment, the size of the exhaust space 10i and 10j is increased by the extended upper space 10j, such that the size of the flow path required for the flow of the air discharged to the second exhaust hole 3 through the exhaust space 10i and 10j is increased. Each of the exhaust duct 70 and the lamp cover 80 disposed in the exhaust space 10i and 10j is formed in a shape in which the flow resistance thereof can be reduced, so that the flow of the air discharged to the second exhaust hole 3 through the exhaust space 10i and 10j can be smoothly performed.

Accordingly, the cooking appliance of the present embodiment may provide the cooking gas removal performance that is equal to or higher than that of the conventional cooking appliance having a similar cooking capacity while having the total size smaller than that of the conventional cooking appliance having a similar cooking capacity.

In addition, the extension plate 18 may serve as a blocking wall blocking the side space 10e and the exhaust space 10i and 10j from each other. Accordingly, the side space 10e may be blocked from the exhaust space 10i and 10j via the extension plate 18.

That is, a space in which the upper space 10i and the extended upper space 10j are connected to each other is formed above the extension plate 18 via the extension plate 18, while the side space 10e and the exhaust space 10i and 10j are blocked from each other via the extension plate 18.

According to the present embodiment, the side space 10e is connected to the lower space defined between the air intake hole 1 and the cavity 11. Accordingly, the side space 10e may be referred to as a space connected to the air intake hole 1. In addition, the exhaust space 10i and 10j may be referred to as a space connected to the second exhaust hole 3. That is, the side space 10e may be referred to as a space involving in the air intake, and the exhaust space 10i and 10j may be referred to as a space involving in the gas exhaust.

The extension plate 18 may block the exhaust space 10i and 10j from the side space 10e, thereby blocking the space involving in the gas exhaust from the space involving in the air intake. Accordingly, the space involving in the gas exhaust is increased by the extended upper space 10j, and the space involving in the air intake is increased by the space occupied with the side space 10e.

That is, as the exhaust space 10i and 10j and the side space 10e are blocked from each other via the extension plate 18, the space involving in the gas exhaust and the space involving in the air intake may be secured to have sufficient sizes necessary for the gas exhaust and the air intake, respectively.

In addition, as the exhaust space 10i and 10j and the side space 10e are blocked from each other via the extension plate 18, the air in the exhaust space 10i and 10j may be effectively prevented from being re-suctioned into the air blower 100 and 200, that is, a backflow phenomenon, thereby effectively improving the cooking gas exhaust performance of the cooking appliance.

In one example, in the cooking appliance of the present embodiment, the plurality of second exhaust holes 3 may be disposed. Each of the second exhaust holes 3 may be defined in the upper surface of the main body 10, may be disposed at a position adjacent to the front surface of the main body 10, and may communicate with the exhaust space 10i and 10j.

In the main body 10, the cold air inlet 5 and the plurality of second exhaust holes 3 may be defined and may be arranged in a lateral direction. Further, one of the plurality of second exhaust holes 3 may be provided as the common exhaust hole 3a.

In the present embodiment, it is illustrated that the cold air inlet 5 is disposed on the left side of the second exhaust holes 3 and one disposed at the rightmost side among the plurality of second exhaust holes 3 is provided as the common exhaust hole 3a.

At least a portion of the common exhaust hole 3a may be disposed to overlap at least a portion of the duct outlet 70c provided in the exhaust duct 70. That is, in the top view, at least a portion of the duct outlet 70c may be exposed upwardly through the common exhaust hole 3a. Accordingly, the air discharged through the duct outlet 70c may be effectively discharged through the common exhaust hole 3a.

A portion of the air introduced into the electronic/electrical component chamber 10b, 10c, and 10d through the cold air inlet 5 may be introduced into the cooking chamber 10a. The air introduced into the cooking chamber 10a together with the steam, the gas, and the like generated in the cooking chamber 10a during the cooking process of the cooking appliance may be discharged to the exhaust duct 70.

The air introduced into the exhaust duct 70 may be discharged through the duct outlet 70c, and the air discharged from the exhaust duct 70 may be discharged to the outside out of the cooking appliance through the common exhaust hole 3a. That is, the common exhaust hole 3a may act as an outlet used to discharge the air discharged from the cooking chamber to the outside out of the cooking appliance.

In the present embodiment, at least a portion of the common exhaust hole 3a is illustrated as being disposed on the left side of the extended upper space 10j. The common exhaust hole 3a may be disposed above a boundary between the upper space 10i and the extended upper space 10j. That is, in the top view of the cooking appliance, the boundary between the upper space 10i and the extended upper space 10j may be exposed to a position on top of the cooking appliance through the common exhaust hole 3a.

In one example, approximately the left half of the common exhaust hole 3a may be disposed above the upper space 10i. In addition, the other half of the common exhaust hole 3a may be disposed above the extended upper space 10j.

The common exhaust hole 3a may be used to discharge both the air discharged from the exhaust duct 70 and the air introduced into the exhaust space 10i and 10j from the blower 100 and 200. That is, both the steam and the gas discharged from the cooking chamber and the cooking gas suctioned through the blower 100 and 200 may be discharged together through the common exhaust hole 3a.

According to the present embodiment, the exhaust space 10i and 10j includes the upper space 10i and the extended upper space 10j, and the air suctioned through the blower 100 and 200 may flow not only to the upper space 10i but also to the extended upper space 10j. In particular, the air flowing from the blower 100 and 200 to the extended upper space 10j may be discharged to the outside out of the cooking appliance through the common exhaust hole 3a.

In this regard, the air flowing from the blower 100 and 200 to the extended upper space 10j may not necessarily be discharged to the outside out of the cooking appliance only through the common exhaust hole 3a, and may also be discharged to the outside out of the cooking appliance through the second exhaust hole 3 other than the common exhaust hole 3a.

If the extension plate 18 is not provided in the main body 10, and thus the extended upper space 10j is not formed in the main body 10, the area occupied by the exhaust space 10i and 10j is inevitably reduced to only the upper space 10i.

In this case, a substantial portion of an area under the common exhaust hole 3a is occupied with the exhaust duct 70, and thus it is difficult to form the passage connecting the common exhaust hole 3a and the exhaust space 10a and 10j to each other.

In addition, if the extension plate 18 is not provided inside the main body 10, the common exhaust hole 3a is directly connected to the side space 10e. In this case, the suctioning force of the rear fan assembly 100 acting on the side space 10e may affect the surrounding around the common exhaust hole 3a.

In this case, it is very difficult for the air flowing from the air blower 100 and 200 to the exhaust space 10i and 10j to be discharged to the outside out of the cooking appliance through the common exhaust hole 3a. As a result, only the steam and gas discharged from the cooking chamber are mainly discharged through the common exhaust hole 3a, and the cooking gas suctioned by the blower 100 and 200 may not be almost discharged.

In contrast thereto, in the cooking appliance of the present embodiment, the side space 10e and the upper extended upper space 10j are blocked from each other via the extension plate 18, and the area occupied with the exhaust space 10i and 10j may be extended not only to the upper space 10i but also to the upper extended upper space 10j disposed under the common exhaust hole 3a.

Accordingly, the cooking appliance of the present embodiment may discharge both of the steam and the gas discharged from the cooking chamber and the cooking gas suctioned through the blower 100 and 200 through the common exhaust hole 3a.

### Rear Support Member

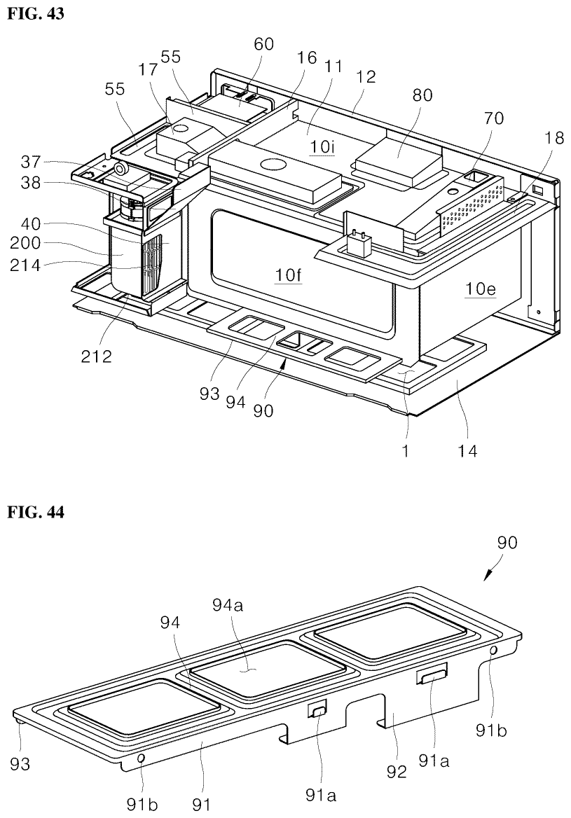

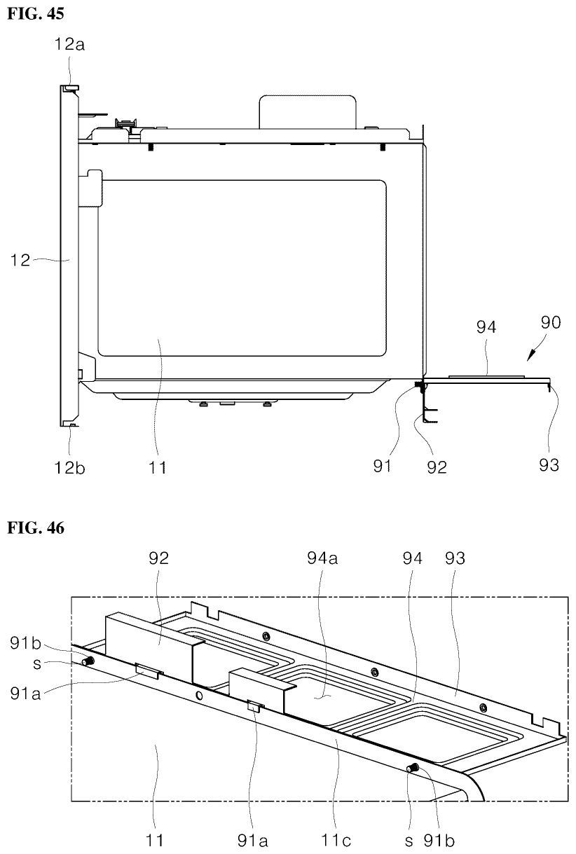

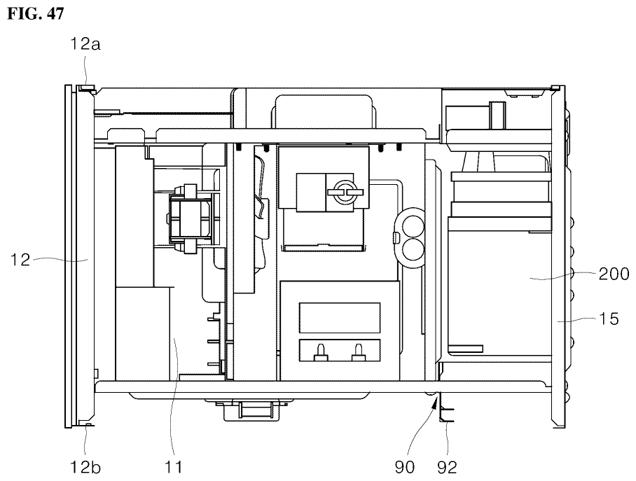

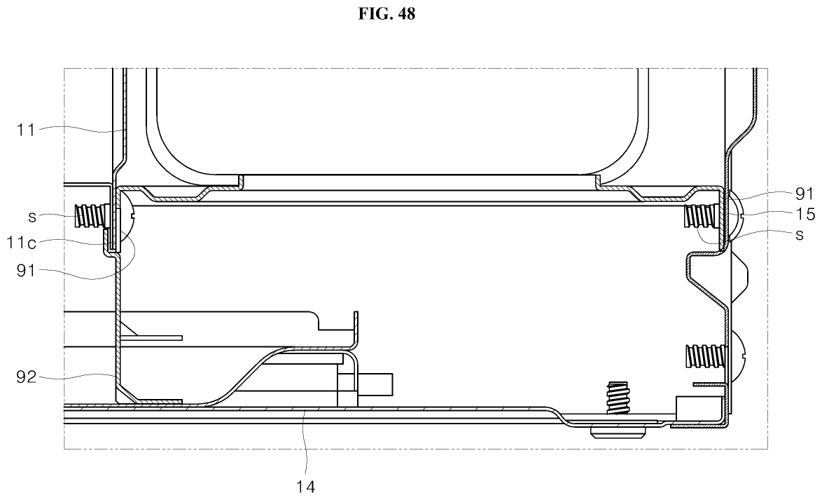

FIG. 43 is a rear perspective view illustrating a state in which a rear fan assembly has been removed from the cooking appliance according to the first embodiment of the present disclosure, FIG. 44 is a rear perspective view illustrating a rear support member separated from the cooking appliance as illustrated in FIG. 43, and FIG. 45 is a side view illustrating a coupling state of a cavity and a rear support member. FIG. 46 is a bottom perspective view illustrating a state in which a coupling portion between a cavity and a rear support member as illustrated in FIG. 45 is enlarged. FIG. 47 is a side view illustrating a state in which a rear plate is coupled to the rear support member as illustrated in FIG. 45, and FIG. 48 is a side cross-sectional view illustrating a coupling structure between the cavity and the rear support member and the rear plate.

Referring to FIGS. 43 to 45, the cooking appliance of the present embodiment may include a rear support member 90. The rear support member 90 may be disposed in rear of the cavity 11.

As described above, the front plate may be disposed in front of the cavity 11. The front plate 12 and the rear support member 90 may be spaced apart from each other in the front-rear direction with the cavity 11 interposed therebetween, and may be coupled to the cavity 11.

In one example, the front plate 12 may be coupled to the front surface of the cavity 11, and the rear support member 90 may be coupled to the rear surface of the cavity 11. In another example, the front plate 12 may be integrally formed with the cavity 11 to constitute the front surface of the cavity 11.

According to the present embodiment, the front plate 12 may be formed such that the lower end 12b of the front plate 12 is disposed at a lower vertical level than that of the bottom surface of the cavity 11. For example, at least a portion of the front plate 12 may be disposed between the cavity 11 and the base plate 14.

Like the front plate 12, the rear support member 90 may be formed such that a lower end of the rear support member 90 is disposed at a vertical level lower than a vertical level of the bottom surface of the cavity 11. For example, at least a portion of the rear support member 90 may be disposed between the cavity 11 and the base plate 14.

To this end, at least a portion of the rear support member 90 may protrude to a position lower than a position of the bottom surface of the cavity 11. The rear support member 90 may be in contact with the bottom surface of the cavity 11 while being disposed at a vertical level lower than a vertical level of the cavity 11 and may support the cavity 11.

The rear support member 90 may include a front coupling portion 91 and a lower support 92. The front coupling portion 91 is constructed to be coupled to the rear surface of the cavity 11. In addition, the lower support 92 may protrude downwards from the front coupling portion 91.

The lower end of the lower support 92 may be disposed at a lower position than a position of the bottom surface of the cavity 11. The lower support 92 may be in contact with the bottom surface of the cavity 11 while being disposed at a position lower than that of the cavity 11 and may support the front coupling portion 91 and the cavity 11 coupled thereto.

Preferably, the lower end of the lower support 92 may be disposed at a position corresponding to the position of the lower end 12b of the front plate 12. For example, a protruding length of the lower support 92 relative to the bottom surface of the cavity 11 may be set to be the same as a protruding length of the front plate 12 relative to the bottom surface of the cavity 11. Accordingly, the rear support member 90 may support the cavity 11 so that the cavity 11 may maintain an approximately level state.

In the front-rear direction, the rear support member 90 may be disposed between the cavity 11 and the rear plate 15. The rear support member 90 may be coupled to the cavity 11 and the rear plate 15.

To this end, the rear support member 90 may further include a rear coupling portion 93 and a connection portion 94. The rear coupling portion 93 is constructed to be coupled to the front surface of the rear plate 15. In addition, the connection portion 94 protrudes rearwards from the front coupling portion 91, and may connect the front coupling portion 91 and the rear coupling portion 93 to each other.

The connection portion 94 may be disposed in the rear space 10f, and may be disposed under the rear fan assembly 100. In the vertical direction, the connection portion 94 may be disposed between the rear fan assembly 100 and the base plate 14. The connection portion 94 is constructed so that air in the rear space 10f can flow in the vertical direction while flowing through the connection portion 94.

To this end, the rear support member 90 may have a vertical through-hole 94a defined therein. The vertical through-hole 94a defines a space between the cavity 11 and the base plate 14, that is, a passage communicating the lower space and the rear fan assembly 100 with each other.

In one example, the connection portion 94 may constitute a horizontal plane that blocks the lower space and the rear fan assembly 100 from each other, and the vertical through-hole 94a may be formed to extend through the connection portion 94 in the vertical direction. The vertical through-hole 94a may constitute a passage required for air introduced into the lower space through the air intake hole 1 to flow through the rear support member 90 and flow toward the rear fan assembly 100.

That is, the connection portion 94 may serve to maintain a spacing between the cavity 11 and the rear plate 15 so that a sufficient space required for air flow in the rear space 10f may be secured.

Referring to FIGS. 44 to 47, the front coupling portion 91 may be coupled to the rear surface of the cavity 11 while contacting the rear surface of the cavity 11 in the front-rear direction.

The coupling between the cavity 11 and the front coupling portion 91 may be performed via at least one of coupling using a fastening member s such as a screw, or the like or fitting-coupling. In one example, at least one of a fitting-coupling portion 91a and a fastening hole 91b may be provided in the front coupling portion 91. In the present embodiment, it is illustrated that both the fitting-coupling portion 91a and the fastening hole 91b are provided in the front coupling portion 91.

The fitting-coupling portion 91a may be detachably coupled to the rear surface of the cavity 11. In one example, a lower end 11c of the rear surface of the cavity 11 may be formed to protrude downwardly beyond the lower surface of the cavity 11. The fitting-coupling portion 91a is constructed so that the lower end 11c of the rear surface of the cavity 11 may be fitting-coupled thereto.

In one example, the fitting-coupling portion 91a may be formed to protrude in a “L” shape rearwards from the front coupling portion 91, and the lower end 11c of the rear surface of the cavity 11 may be fitted into between the front surface of the front coupling portion 91 and the rear surface of the fitting-coupling portion 91a.

When the cooking appliance is assembled, in a state in which the cavity 11 is turned upside down such that the bottom surface of the cavity 11 faces upwardly, and in a state in which the rear support member 90 is turned upside down such that the lower support 92 faces upwardly, the rear support member 90 comes into contact with the rear surface of the cavity 11 such that the lower end 11c of the rear surface of the cavity 11 is fitted into the fitting-coupling portion 91a, such that the fitting-coupling between the cavity 11 and the rear support member 90 may be achieved.

The rear support member 90 may be temporarily fixed to the cavity 11 via the fitting-coupling between the cavity 11 and the rear support member 90 achieved in the above manner. In the state in which the rear support member 90 is temporarily fixed to the cavity 11 in this manner, the front coupling portion 91 may be in contact with the rear surface of the cavity 11 in the front-rear direction.

In this state, the fastening member s such as a screw is fastened to the fastening hole 91b, such that the rear support member 90 may be firmly coupled to the cavity 11.

That is, via the fitting-coupling between the cavity 11 and the fitting-coupling portion 91a, the coupling position of the rear support member 90 relative to the cavity 11 may be guided and the rear support member 90 may be temporarily fixed to the cavity 11, and thus the installation of the rear support member 90 may be performed more easily and quickly.

The rear support member 90 installed on the rear side of the cavity 11 as described above may support the cavity 11 so that the cavity 11 does not fall over backwards while the assembly process of the cooking appliance is in progress.

As described above, the front plate 12 is installed on the front side of the cavity 11, and the lower end 12b of the front plate 12 protrudes to a position lower than that of the bottom surface of the cavity 11. Therefore, when the front plate 12 is first installed onto the cavity 11 and the base plate 14 or the rear plate 15 is not yet installed onto the cavity, the cavity 11 is highly likely to fall over rearwards due to a difference between vertical lengths of the front side and the rear side of the cavity 11.

In consideration of this situation, in the present embodiment, the rear support member 90 may be installed on the rear side of the cavity 11, and the rear side of the cavity 11 may be supported by the rear support member 90. That is, in the present embodiment, the front plate 12 and the rear support member 90 arranged in the front-rear direction with the cavity 11 interposed therebetween may support the cavity 11 while being respectively disposed on both opposing sides in the front-rear direction of the cavity 11.

Accordingly, the cavity 11 may not fall over rearwards and may maintain a stable posture without being tilted toward the front side or the rear side even in a state in which the front plate 12 is first installed onto the cavity 11 and the base plate 14 or the rear plate 15 is not yet installed onto the cavity.

That is, the rear support member 90 according to the present embodiment serves to stably maintain the posture of the cavity 11 so that the cavity 11 does not fall over in the rearward direction during the assembly process of the cooking appliance, thereby contributing to the convenient assembly of the cooking appliance in a more stable environment. Thus, the occurrence of various safety accidents that may occur due to the fall over of the cavity 11 during the assembly process of the cooking appliance may be suppressed.

In addition, the rear support member 90 may be coupled to at least one of the rear plate 15 and the base plate 14, as illustrated in FIGS. 47 and 48. In the present embodiment, it is illustrated that the rear support member 90 is coupled to both the rear plate 15 and the base plate 14.

As described above, the rear coupling portion 93 may be coupled to the rear plate 15. A lower end of the lower support 92 may be coupled to the base plate 14. The rear support member 90 coupled to each of the rear plate 15 and the base plate 14 stably supports the rear plate 15 and the base plate 14 on the cavity 11, thereby effectively improving the structural stability of the cooking appliance.

In addition, the rear support member 90 may provide an effect of increasing the suction flow rate by maintaining the spacing between the cavity 11 and the rear plate 15 so that a sufficient space required for air flow in the rear space 10f may be secured.

### Further Examples of Cooking Appliances

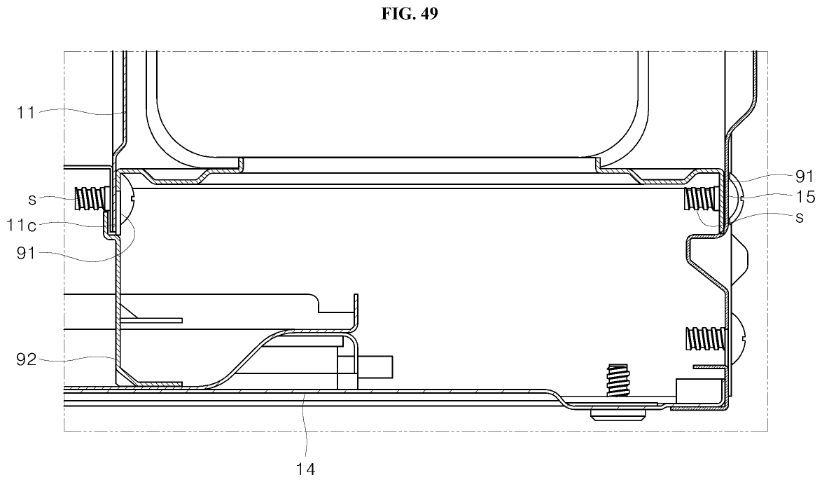

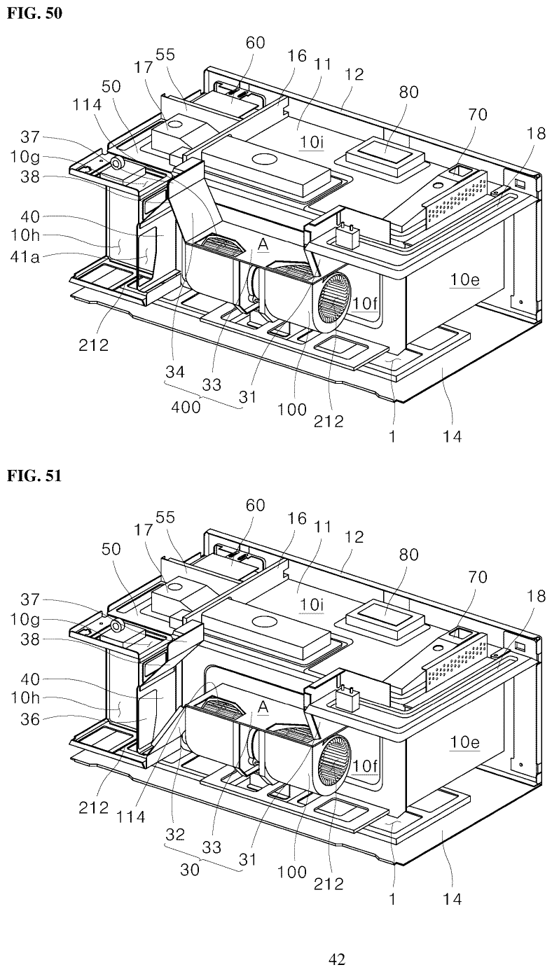

FIG. 49 is a rear perspective view illustrating a state in which a cabinet has been removed from the cooking appliance according to a second embodiment of the present disclosure, FIG. 50 is a rear perspective view illustrating a state in which the cabinet has been removed from the cooking appliance according to a third embodiment of the present disclosure, and FIG. 51 is a rear perspective view illustrating a state in which the cabinet has been removed from the cooking appliance according to a fourth embodiment of the present disclosure.

The main difference between the cooking appliance as illustrated in FIGS. 49 to 51 and the cooking appliance illustrated in the above-described embodiment is about the presence or absence of the corner fan assembly 200 (see FIG. 5). As illustrated in FIGS. 49 to 51, only the rear fan assembly 100 is provided in the cooking apparatus, and the corner fan assembly 200 is not provided therein.

Accordingly, a difference between the blower output of the cooking appliance as illustrated in FIGS. 49 to 51 and that of the cooking appliance illustrated in the above-described embodiment occurs. That is, compared to the cooking appliance including both the corner fan assembly 200 and the rear fan assembly 100, the output of the blower in the cooking appliance as illustrated in FIGS. 49 to 51 is relatively lowered.

The cooking appliances as illustrated in FIGS. 49 to 51 may employ the main body 10 having substantially the same shape as that of the main body of the cooking appliance illustrated in the above-described embodiment. That is, the cooking appliance according to the present embodiment may be provided as various types of cooking appliances which employ only one type of the common main body but have only different outputs of the blower.

The cooking appliance according to the present embodiment may provide an effect of easily and rapidly manufacturing various types of cooking appliances at a low cost. Hereinafter, various embodiments of the cooking appliance for achieving the above purpose are illustrated.

Referring to FIG. 49, the structure of the cooking appliance according to the second embodiment of the present disclosure is substantially the same as that of the cooking appliance illustrated in the above-described embodiment, except for the blower and the flow path defining member 300.

That is, the main difference between the cooking appliance according to the second embodiment of the present disclosure and the cooking appliance illustrated in the above-described embodiment is about the blower and the flow path defining member 300.

The flow path defining member 300 of the present embodiment may include the first flow path plate 31 and the fastening plate 33. For example, the flow path defining member 300 of the present embodiment may be provided in a form in which the second flow path plate 32 is omitted from the flow path defining member 30 (see FIG. 6) illustrated in the above-described embodiment.

In one example, the flow path defining member 300 of the present embodiment may be provided in a form in which the first flow path plate 31 and the fastening plate 33 are integrally formed with each other. In another example, the flow path defining member 300 may be provided in a form in which the first flow path plate 31 and the fastening plate 33 are respectively formed and assembled with each other.

Accordingly, a structure that may block the first suction hole 112 and the first discharge hole 114 from each other is not disposed on the left side of the rear fan assembly 100. In addition, the corner space 10g and 10h, more specifically, the lower corner space 10h is maintained in an empty state.

The cooking appliance of this embodiment may further include a cover 36. The cover 36 is constructed to cover the through-hole 41b (see FIG. 21) formed in the lateral support 41. The cover 36 may be coupled to the lateral support 41 to close the discharge hole 41a. Due to the cover 36, an unnecessary passage between the corner space 10g and 10h and the exhaust flow path A may be closed.

Referring to FIG. 50, a flow path defining member 400 provided in the cooking apparatus according to the third embodiment of the present disclosure may be constructed so as to include the first flow path plate 31, the extension plate 34, and the fastening plate 33.

In one example, the flow path defining member 400 of the present embodiment may be provided in a form in which the first flow path plate 31, the extension plate 34, and the fastening plate 33 are integrally formed with each other. In another example, the flow path defining member 300 may be provided in a form in which the first flow path plate 31, the extension plate 34, and the fastening plate 33 are formed, respectively, and assembled with each other.

In the flow path defining member 400, the first flow path plate 31 may define a right boundary surface of the exhaust flow path A. The extension plate 34 may define a left boundary surface of the exhaust flow path A, and may constitute a wall blocking the first suction hole 112 and the first discharge hole 114 from each other while being disposed on the left side of the rear fan assembly 100.

In one example, referring to FIG. 51, the cooking appliance according to the fourth embodiment of the present disclosure may include a flow path defining member 30 having the same shape as that illustrated in the first embodiment of the present disclosure. In addition, the cooking appliance according to the fourth embodiment of the present disclosure may further include the cover 36 having the same shape as that illustrated in the second embodiment of the present disclosure.

Accordingly, the right boundary surface of the exhaust flow path A may be defined by the first flow path plate 31. In addition, on the left side of the rear fan assembly 100, a lower boundary surface of the exhaust flow path A may be defined by the second flow path plate 32. In addition, the left boundary surface of the exhaust flow path A may be defined by the lateral support 41 and the cover 36.

Although the present disclosure has been described above with reference to the embodiments illustrated in the drawings, this is merely an example, and it will be understood by those of ordinary skill in the art that various modifications and other equivalent embodiments are possible therefrom. Therefore, the true technical protection scope of the present disclosure should be determined by the following claims.

### REFERENCE NUMERALS

1: Air intake hole
2: First exhaust hole
3: Second exhaust hole
3a: Common exhaust hole
4: Third exhaust hole
5: Cold air inlet
10: Main body
10a: Cooking chamber
10b,10c,10d: Electronic/electrical component chamber
10b: Lower electronic/electrical component chamber
10c: Upper electronic/electrical component chamber
10d: Air intake chamber
10e: Side space
10f: Rear space
10g: Upper corner space
10h: Lower corner space
10i: Upper space
10j: Extended upper space
18: Extension plates
30, 35, 300, 400: Flow path defining member
40, 45: Support member
50: Partition plate
60,65: Screening member
70: Exhaust duct
75: Duct bracket
80,85: Lamp cover
90: Rear support member
100: Rear fan assembly
200: Corner fan assembly

1. A cooking appliance comprising:
a main body having a cooking chamber defined therein, and having an air intake hole and an exhaust hole; and
a fan assembly configured to intake air through the air intake hole and discharge the suctioned air to the exhaust hole,
wherein a rear space is defined inside the main body and at a position rearwardly of the cooking chamber, wherein the rear space communicates with the air intake hole and the exhaust hole,
wherein the fan assembly is disposed in the rear space.

2. The cooking appliance of claim 1, wherein the main body includes a cavity having the cooking chamber defined therein, and a rear plate disposed at the rear of the cavity,
wherein the rear space is defined between the cavity and the rear plate.

3. The cooking appliance of claim 1, wherein the main body includes a cavity having the cooking chamber defined therein, and a cabinet having an upper surface disposed above the cavity,
wherein the exhaust hole communicates with an upper space defined between an upper surface of the cavity and an upper surface of the cabinet,
wherein the fan assembly is configured to discharge the suctioned air to the upper space.

4. The cooking appliance of claim 3, wherein the exhaust hole is formed in the upper surface of the cabinet so as to extend through the upper surface of the cabinet.

5. The cooking appliance of claim 1, wherein the fan assembly is disposed in a space communicating with the air intake hole and the exhaust hole,
wherein the exhaust hole is disposed in an area overlapping the fan assembly in a vertical direction.

6. The cooking appliance of claim 1, wherein the main body includes a cavity having the cooking chamber defined therein,
wherein the fan assembly is disposed at a position overlapping the cavity in a front-rear direction.

7. The cooking appliance of claim 1, wherein the main body includes a cavity having the cooking chamber defined therein,
wherein the fan assembly is disposed in a portion of the rear space disposed between an upper surface and a lower surface of the cavity in the vertical direction.

8. The cooking appliance of claim 1, wherein the fan assembly is disposed at a position closer to the air intake hole than to the exhaust hole.

9. The cooking appliance of claim 1, wherein the fan assembly includes a plurality of fan assemblies laterally arranged.

10. The cooking appliance of claim 1, wherein the fan assembly includes at least one fan module,
wherein the fan module includes:
a fan housing having a suction hole and a discharge hole defined therein; and
an impeller accommodated in the fan housing and configured to suction air through the suction hole and discharge air through the discharge hole.

11. The cooking appliance of claim 10, wherein the fan assembly includes:
a rear fan assembly including a plurality of fan modules arranged laterally; and
a corner fan assembly including one fan module,
wherein the rear fan assembly and the corner fan assembly are laterally arranged and are disposed in the rear space.

12. The cooking appliance of claim 11, wherein a side space is defined inside the main body and is positioned on a side of the cooking chamber,
wherein the rear space and the side space communicate with each other through a corner space as an area in which the rear space and the side space partially overlap each other,
wherein at least a portion of the corner fan assembly is disposed in the corner space.

13. The cooking appliance of claim 11, wherein in the corner fan assembly, the impeller rotates about a vertical axis and intakes air in a vertical direction.

14. The cooking appliance of claim 1, wherein a side space is defined inside the main body and is positioned on a side of the cooking chamber,
wherein the rear space and the side space communicate with each other through a corner space as an area in which the rear space and the side space partially overlap each other,
wherein at least a portion of the fan assembly is disposed in the corner space.

15. The cooking appliance of claim 14, wherein the fan assembly includes:
a rear fan assembly disposed in the rear space; and
a corner fan assembly, wherein at least a portion of the corner fan assembly is disposed in the rear space and at least a portion of the corner fan assembly is disposed in the corner space.

16. The cooking appliance of claim 15, wherein an upper space is defined inside the main body and is positioned above the cooking chamber,
wherein an exhaust flow path is defined inside the main body and is constructed to guide flow of air from at least one of the rear fan assembly and the corner fan assembly to the upper space,
wherein the exhaust flow path is disposed in the rear space.

17. The cooking appliance of claim 16, wherein the corner fan assembly includes:
a fan housing having an suction hole and a discharge hole defined therein; and
an impeller accommodated in the fan housing and configured to suction air through the suction hole and discharge air through the discharge hole,
wherein the suction hole faces toward the air intake hole disposed below the fan assembly,
wherein the discharge hole faces laterally and is connected to the exhaust flow path.

18. The cooking appliance of claim 17, wherein the cooking appliance further comprises a flow path plate disposed between the rear fan assembly and the corner fan assembly so as to define a lower boundary surface of the exhaust flow path,
wherein one end in a lateral direction of the flow path plate is disposed below the discharge hole,
wherein at least a portion of the flow path plate extends upward at an incline in a lateral direction from the one end in the lateral direction thereof adjacent to the corner fan assembly toward the rear fan assembly.

19. The cooking appliance of claim 1, wherein the fan assembly is disposed between an upper surface and a bottom surface of the main body,
wherein the air intake hole is defined in the bottom surface of the main body,
wherein the exhaust hole is defined in the upper surface of the main body.

20. The cooking appliance of claim 19, wherein an upper space is defined inside the main body and is positioned above the cooking chamber,
wherein the fan assembly is configured to suction air through the air intake hole and discharge the suctioned air to the rear space,
wherein the rear space connects the air intake hole with the upper space,
wherein the exhaust hole communicates with the upper space.
